(19) United States
(12) Patent Application Publication
(10) Pub. No.: US 2002/0091736 A1
(43) Pub. Date: Jul. 11, 2002

(54) Component models

(75) Inventor: Llewellyn Wall, Arlington, VA (US)

Correspondence Address: FITCH EVEN TABIN AND FLANNERY, 120 SOUTH LA SALLE STREET, SUITE 1600, CHICAGO, IL, 60603-3406, US

(73) Assignee: DECIS E-DIRECT, INC.

(21) Appl. No.: 09/888,221

(22) Filed: Jun. 23, 2001

Related U.S. Application Data
(60) Provisional application No. 60/213,772, filed on Jun. 23, 2000.

(51) Int. Cl. G06F 15/00

(52) U.S. Cl. 707/513

(57) ABSTRACT

A system comprising a plurality of components comprising data and a component assembly engine. The component assembly engine performing the steps: (1) receiving one of the plurality of components, the one of the plurality of components comprising a root component, (2) determining, as a function of the root component, at least one child component of the root component, (3) receiving another of the plurality of components, the other of the plurality of components comprising the at least one child component, and (4) rendering content as a function of at least one of said at least one child component and said root component.

### CROSS REFERENCE TO RELATED APPLICATIONS

This patent document is a non-provisional patent application, and claims priority to U.S. Provisional Patent Application Ser. No. 60/213,772 filed Jun. 23, 2000 under 35 U.S.C. § 119(e), which U.S. Provisional Patent Application is incorporated herein by reference.

### BACKGROUND OF THE INVENTION

1. Field of the Invention

The present invention relates generally to data processing systems. More particularly, it relates to managing, formatting, and distributing content material or documents electronically over a computer network.

2. Background of the Invention

The period at the end of the 20^{th} century and continuing to the present has been called the Age of Information. This is due to the vast importance data and information have become to the daily functioning of our governmental, economic, industrial, and civil infrastructures. It has been the development of the computer in general and of computer networks more specifically that have allowed increased access to storage and sharing of data and information that has fueled the Information Age up to this point.

Currently, the world's largest network is known as the Internet. The Internet is a worldwide interconnection of servers (hardware and software systems designed to “serve” information to or process information from “clients”) and computer networks able to freely intercommunicate. As a response to the Sputnik launch in 1957, the Advanced Research Projects Agency (ARPA) was established within the United States Department of Defense. One of ARPA's early projects was concerned with utilization of the US military's computers. In the late 1960s, in ARPA's Information Processing Techniques Office (IPTO) under J. C. R. Licklider, work began in earnest on the ARPANET, a visionary network of computers which necessitated development of communication protocols and allowed communication over adaptive routes. The ARPANET was initially limited mainly to the military and academic worlds for information exchange because of the computer sophistication that was required. Later, Tim Berners-Lee at the Centre Europeen pour la Recherche Nucleaire (CERN) in Geneva, Switzerland developed the World Wide Web (WWW) which allowed collaborative access to information for researchers.

The WWW is the Internet's system for multimedia information retrieval. In the WWW, clients (hardware and software systems designed to request information from or request processing of information from servers) interact with servers using a communication protocol providing access to multimedia information (e.g., text, graphics, images, sound, video, etc.). Examples of such protocols include: Hypertext Transfer Protocol (HTTP) and Wireless Application Protocol (WAP). In the WWW paradigm, information resides at addresses, each of which is identified by a Uniform Resource Locator (URL). General access to the WWW is currently made via client-side programs such as browsers (examples of which are Netscape Navigator or Microsoft Internet Explorer, both which run on personal computers, or Pixo or Neomar, both of which operate on wireless handheld devices) residing on a client. Access to specific information or files requires the browser be given the URL of the desired information or files. In response, the browser makes a request to the server on which the information or files is located (the identity of the server is contained in the URL) and, in return, the server returns the desired information, e.g., a document or other object requested, to the client. The client's browser then interprets the received information and, for example, displays the same for the user, executes a script, executes a plug-in, or stores a file, e.g. to a storage device at the client.

Information to be accessed over the WWW can be formatted by any of a multitude of ways. One such way is the standard page description language known as Hypertext Markup Language (HTML). HTML provides basic document formatting and allows one file to specify “links” to other files or addresses and the user may follow any link of choice by “clicking” on it with his or her mouse. Other examples of markup languages include, but are not limited to, Extensible HyperText Markup Language (xHTML), Handheld Device Markup Language (HDML), Wireless Markup Language (WML), Extensible Markup Language (XML). Generally, HTML files result in a client's browser displaying a “webpage” that contains information viewable by the user. Often, companies and people have various webpages that are successively linked together. Collectively, each such successively linked group of webpages is referred to as a “website”.

In handling user requests, servers to date have employed several methods. The original method was by static resource. In handling a request for a static resource, a server simply loads the requested resource, such as a HTML file, and returns it to the user. The next method was dynamic resource generation by Common Gateway Interface (CGI). In handling a request involving CGI, the server hands the request to the CGI through which an external program is executed, which in turn processes necessary scripts and dynamically builds the requested resource, e.g. dynamically generated resource, such as dynamically generated HTML. The dynamically generated resource is then given to the server, which forwards it to the user. CGI handling of requests was generally given to be slow and expensive in terms of computing and networking resources. In response, the next method of dynamically generated resource generation was by Web Application Server (WAS). A Web Application Server generally employs advanced caching, resident scripts, advanced monitoring capabilities, and has multithreaded capability all of which allows it to faster and more reliably process incoming requests.

The WWW has become an accepted part of life for an ever-increasing number of people. Access to the WWW is now common for all kinds of people for all kinds of reasons. This represents a vast audience of potential consumers. Entrepreneurs from Fortune 100 companies to startup companies have raced to offer products and services, through the WWW that may be of desire to this growing number of potential customers. This online business extension is referred to as “e-commerce” and such businesses are referred to as online businesses or e-commerce businesses. Online businesses are dependent on “visitors”, i.e. users who visit, or view, their website. These online businesses are very interested in keeping track of not only the number of visitors, but also the identity, location, and attributes of each individual visitor as well as the behavior of each visitor as the visitor browses or “navigates” through their website by selecting links displayed on webpages and thereby being presented with different webpages from their website. These entrepreneurs are also interested in tracking what content is displayed to these visitors within the webpages displayed and the visitor's responses during navigation of the website—particularly when the webpages are dynamically generated. Current trends are towards personalization wherein the webpage delivered to a visitor is customized with an attempt to provide information, products, or features geared specifically to that visitor. Using personalization, online businesses seek to personalize webpages in order to offer products or information which, judging by past behavior, may be of interest or need to the visitor.

Personalization is a technique that businesses or other entities use to increase user satisfaction by tailoring the interaction between the business or other entity and the user. When combined with the ability to gather information on the interaction, personalization becomes a critical tool for businesses and other entities to target special offers to their most lucrative customers and thereby directly affect customer retention levels for the key segment of their customer base.

Personalization includes, but is not limited to, the altering of the content of a webpage by the server based on a model of the user. Many methods have been used in seeking personalization. One technique which should be differentiated from personalization is customization. Customization is altering a webpage to conform to the wishes of a user and requires the user to provide explicit information in the form of answers to direct questions or the like. In response, the website customizes later-served pages according to the user's answers. The “My Yahoo” service of Yahoo.com is one example, where a customized page is provided which contains only those types of information that the user has expressed a desire to see, such as sports news links or specific stock information.

Customization aside, one method of personalization is Collaborative Filtering (CF). This can utilize explicit user feedback such as boxes users can check to indicate likes and dislikes regarding presented products or items. But this method can also function using implicit information (information which is obtained by observing the user's surfing activity and assigning a “like” value to subjects related to explicit questions) by such as tracking the user's online behavior and purchases. Either way, the user's preferences are matched against other users to find an appropriate “affinity group”. Affinity groups are groups of users having similar interests. Personalization then occurs by offering products or information to a user which were previously purchased or accessed by other members of the user's affinity group. One company which uses Collaborative Filtering in their personalization engine is NetPerceptions. One well-known client of NetPerceptions is Amazon.com, which offers the comment “People who bought this book also bought . . . ” in response to viewing a webpage offering a book for sale.

Another method of personalization is Rules-based personalization (RBP). Rules take the form of “if x, then y”. In the preceding example, “x” is the “condition”, and “y” is the “action”. When all of the conditions of a rule are met, then the action (or actions) is executed—this execution is referred to as the “firing” of the rule. Rules-based personalization can be combined with user questionaires to implement personalization, but Rules-based personalization can also be used to personalize a webpage without questionaires. An example of Rules-based personalization is recommending products or information which are related to the products or information already selected by the user, such as staples for a stapler the user has already selected or batteries for a flashlight (this is referred to as “cross-selling”). Informational aids, such as how-to articles or recipes for example, could be presented in response to the selection of particular sets of items.

Typically, RBP requires categorizing users of a web site into a set of predetermined groups designated by a web site operator. Once events occur that change a user's group, personalization events may be triggered. By way of example, if a person buys a toy truck at an online website that uses RBP, they may transition from being associated with a “general” group to being in a “toy buyer's” group. This transition may trigger an event, such as the addition of toy deals to the next webpage that user accesses from the online toy truck website.

Two companies offering personalization engines based on Rules-based personalization are Broadvision and Vignette. Rules-based personalization, however, suffers from the requirement that, generally, many rules must be created to perform effective personalization in the current state of the art, the rules must be updated for each promotion or desired personalization effect, and rules must be updated frequently for sites that sell items if customer preferences or tastes relative to those items change frequently. Keeping up with the purchase and preference trends of sites with many users requires automation so as to reduce what is a prohibitive cost for maintenance of the rules with respect to time and manpower resources.

The present invention advantageously addresses the above and other needs.

### SUMMARY OF THE INVENTION

The present invention advantageously addresses the needs above as well as other needs by providing a system for managing, formatting, and distributing content material or documents electronically over a computer network.

In one embodiment, the invention can be characterized as a system comprising a plurality of components comprising data and a component assembly engine. The component assembly engine performing the following steps: receiving one of the plurality of components, the one of the plurality of components comprising a root component; determining, as a function of the root component, at least one child component of the root component; receiving another of the plurality of components, the other of the plurality of components comprising the at least one child component; and rendering content as a function of at least one of said at least one child component and said root component.

In another embodiment, the invention can be characterized as a method. The method comprising: receiving one of a plurality of components, the one of the plurality of components comprising a root component, each of the plurality of components comprising data; determining, as a function of the root component, at least one child component of the root component; receiving another of the plurality of components, the other of the plurality of components comprising the at least one child component; rendering a portion of content as a function of the at least one child component; and rendering a remainder of content as a function of the root component and the portion of the content.

### BRIEF DESCRIPTION OF THE DRAWINGS

The above and other aspects, features and advantages of the present invention will be more apparent from the following more particular description thereof, presented in conjunction with the following drawings wherein:

FIG. 1 shows two devices connected through a network.

FIG. 2 shows a general block diagram of one embodiment of the present invention interacting with a generic web server.

FIG. 3 shows a block diagram of one embodiment of the present invention showing delivery of an electronic document.

FIG. 4 shows a block diagram of one embodiment of the present invention showing handling of a exchange request.

FIG. 5 shows a block diagram of one embodiment of the present invention showing the backend databases.

FIG. 6 shows a block diagram of the component assembly engine 210 (CAE).

FIG. 7 shows an exemplary webpage.

FIG. 8 shows the component makeup of the exemplary webpage of FIG. 7.

FIG. 9 shows the hierarchical tree visualization of the component makeup of FIG. 8.

FIG. 10 shows an order in which the components of FIG. 9 are loaded and processed.

FIG. 11 shows shadow component resolution contrasting the techniques of replacement and supplementation.

FIG. 12 shows a block diagram of the effects of shadow component resolution.

FIG. 13 shows a flowchart of an exemplary method of processing a shadow component.

FIG. 14 shows internal data modification of a shadow component during processing.

FIG. 15 shows a method of multithreaded loading and processing of the components of FIG. 9.

FIG. 16 shows the main routine of an exemplary method for component loading and processing using recursion.

FIG. 17 shows routine ProcessActivatedNode of an exemplary method for component loading and processing using recursion.

FIG. 18 shows part 1/3 of routine RenderComponent of an exemplary method for component loading and processing using recursion.

FIG. 19 shows part 2/3 of routine RenderComponent of an exemplary method for component loading and processing using recursion.

FIG. 20 shows part 3/3 of routine RenderComponent of an exemplary method for component loading and processing using recursion.

FIG. 21 shows an example of a processed queue.

FIG. 22 shows an example of a feedback buffer.

FIG. 23 shows an exemplary component and the sections it can have.

FIG. 24 shows an example of a name element.

FIG. 25 shows an example of a family element.

FIG. 26 shows an example of a struct element.

FIG. 27 shows an example of a properties element.

FIG. 28 shows an example of a data element.

FIG. 29 shows an example of a interface element.

FIG. 30 shows an example of a process code element.

FIG. 31 shows an example of a activation code element.

FIG. 32 shows an example of a rules element.

FIG. 33 shows an example of a variables element.

FIG. 34 shows an example of a distributed component tree.

FIG. 35 shows an example of loading and processing orders of distributed components.

FIG. 36 shows an example of component sections internally and externally referencing other sections.

FIGS. 37-40 show 4 stages of surfing a website during browsing.

FIG. 41 shows the contents of a user shopping cart.

FIG. 42 shows an example of the form of the contents of the clickstream database without properties.

FIG. 43 shows an example of the form of the contents of the clickstream database with properties.

FIG. 44 shows an exemplary webpage requesting user feedback.

FIG. 45 shows an example of the contents of the clickstream database after a user interacts with a webpage requesting user feedback.

FIG. 46 shows an exemplary implementation of a personalization profile represented by a personal semantic network

FIG. 47 shows an exemplary webpage without customization.

FIG. 48 shows an exemplary webpage customized through personalization .

FIG. 49 shows the semantic network of FIG. 40 after several site visitations.

FIG. 50 shows a way of sharing personalization information between servers by daemon server.

FIG. 51 shows a centralized way of sharing personalized information between servers.

FIG. 52 shows an exemplary webpage.

FIG. 53 shows the webpage of FIG. 46 after reordering of elements.

FIG. 54 shows the webpage of FIG. 46 after selective filtering of elements.

FIG. 55 shows the webpage of FIG. 46 after element removal.

FIG. 56 shows a block diagram of one embodiment of the present invention showing the interaction of the daemon server.

FIG. 57 shows the webpage of FIG. 33 after extra-session customization resulting from the use of the daemon server.

FIG. 58 shows a block diagram of the actions of the Artificial Intelligence Engine.

FIG. 59 shows an example of the actions of dynamic caching.

FIG. 60 shows a listing of an exemplary component named ComponentSprint.

FIG. 61 shows a listing of an exemplary component named ComponentRU.

FIG. 62 shows a listing of an exemplary component named ComponentPR.

FIG. 63 shows a listing of an exemplary component named ComponentGIF.

FIG. 64 shows a listing of an exemplary component named ComponentFileListXML.

Corresponding reference characters indicate corresponding components throughout the several views of the drawings.

### DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

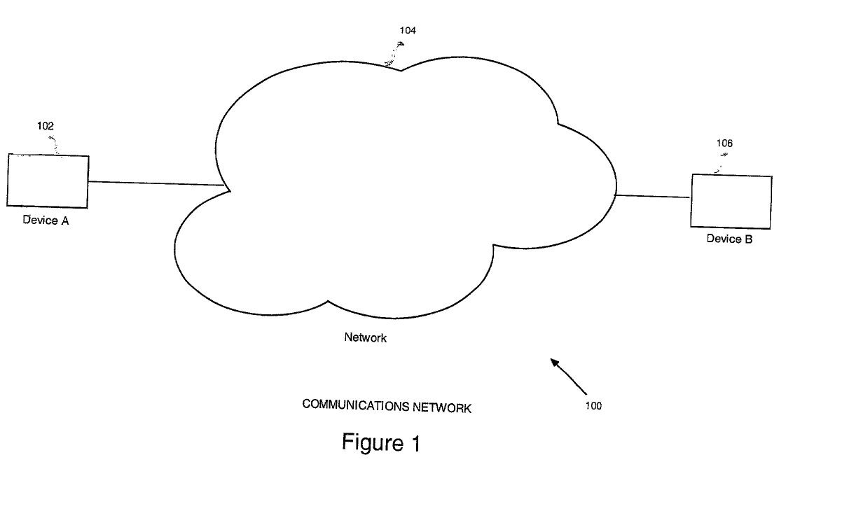

Referring to FIG. 1, shown is a basic communications network.

Shown are a first device 102, a second device 106, and a network 104.

The first device 102 is coupled to the network 104 via a first connection and the second device 106 is coupled to the network 104 via a second connection. The first and second connections may each be of any nature permitting data exchange including wired connections (such as, but not limited to, twisted copper pairs, coaxial cable, fiber optic cable, etc.) and wireless connections (such as, but not limited to, infrared, radio frequency, laser, and microwave).

By way of example, in the event the first device 102 needs to receive information that the second device 106 possesses, the first device 102 initiates communications to the second device 106 by sending a first message over the first connection to the network 104. The first message contains, for example, information understandable by the network 104, identifying the second device 106 (e.g. by address and contained in a part of the first message called a header) and information, understandable by the second device 106, which is, for example, an actual request for the desired information. Upon receiving the first message, the network 104 analyzes the first message to determine a destination, for example, the second device 106, and routes the first message accordingly. This routing can be by any known method such as, but not limited to, circuit switching, such as is done in telephonic networks, or can be packet switched as in TCP/IP type networks. When the network 104 has routed the first message to the second device 106, the network 104 then passes the first message to the second device 106 over the second connection to the network 104. The second device 106 processes the first message, reads the information request, and forms a second message, containing the requested information. The second device 106 then sends the second message to the network 104 for delivery to the first device 102. The delivery of the second message to the first device 102 proceeds in a manner similar to that in which the first message is delivered to the second device 106, except in reverse, with the network 104 receiving the second message from the second device 106 via the second connection and routing the second message to the first device 102 via the first connection.

Two devices are shown in FIG. 1, by way of example, but more devices may, in practice, be coupled to the network 104. In accordance with one embodiment, the first device 102 may be any device that can originate communication requests including, but not limited to, a general purpose personal computer, an HTTP client (such as a network appliance, a kiosk, a POS terminal, or the like), a WAP client (such as a digital cellular telephone), or a personal digital assistant (PDA). The second device 106 may be any device that can receive and respond to a request for desired information such as, but not limited to, a general purpose personal computer, a HTTP server, or a web application server. The network 104 may be any network 104 such as, but not limited to, a telecommunication network 104, an intranet (normally a computer-based network 104 within a business, school, campus, housing complex, community, or other entity), or the Internet. The nature of the communications on the network 104 may be of any form such as synchronous or asynchronous communication, fixed route or packet switched, and may be of any applicable protocol (such as, but not limited to, TCP/IP, WAP, etc.). In one embodiment, communications are asynchronous, packet switched, and use TCP/IP protocol.

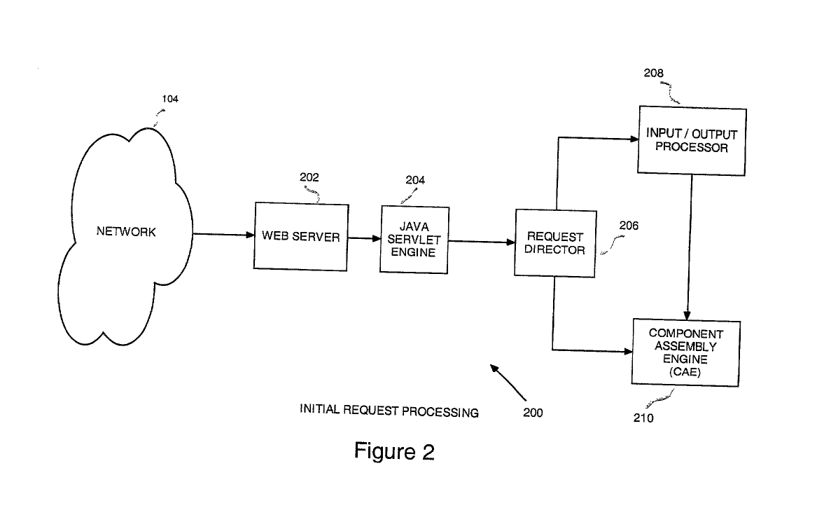

Referring to FIG. 2, shown is a general block diagram of an embodiment of the present invention interacting with a generic web server.

Shown is a network 104, a web server 202, a java servlet engine 204, a request director 206, a component assembly engine (CAE) 210, and an input/output processor (I/O processor) 208.

The network 104 is coupled to the web server 202, which is coupled to the java servlet engine 204. The java servlet engine 204 is coupled to both the component assembly engine 210 and the I/O processor 208. The I/O processor 208 is coupled to the component assembly engine 210.

By way of example, the following describes a request for information by a device (not shown) from the component assembly engine 210. In operation, the device sends the request to the network 104. The request may be a message containing a request for information, such as that discussed previously herein in reference to FIG. 1. The network 104 directs the message to the web server 202.

In accordance with the present embodiment, the web server 202 is a software program running on a hardware computing device (not shown) that is coupled to the network 104. The web server 202 then directs the request to the java servlet engine 204, which is also running on a hardware computing device physically coupled to the network 104. The java servlet engine 204 routes the message to the request director 206, which is also running on a hardware computing device. The hardware computing device in which the java servlet engine is running may be the same hardware computing device running the java servlet engine 204, or alternatively the hardware computing device running the request director 206 may be separate from, but in communication with (i.e. communicatively coupled to), the hardware computing device running the java servlet engine 204. The request director 206 analyzes the message to determine at least two things: (1) whether the requesting entity, i.e. the device, is recognized, and (2) the nature of the request.

The requesting entity is the entity that originated the request, in this case, the device. The requesting entity is recognized if the request director 206 is able to determine that the requesting entity has previously made a request for information from the component assembly engine 210. The request director 206 can use any available method to determine if a requesting entity previously made a request. By way of example, the request director 206 determines whether the requesting entity previously made a request through the use of cookies. Cookies are small electronic documents placed on the requesting entity by the request director 206 in response to a request by the requesting entity. The cookie, in a preferred embodiment, contains at least a unique identifier for the requesting entity (e.g. in the name of the “cookie file” stored on the device) and a timestamp of the requesting entity's last contact with the system. If the request director 206 does not recognize the requesting entity, because, for example, a cookie containing an identifier of the requesting entity is not present on the device, the request director 206 creates a new profile and stores it in a semantic network/metadata database 504, and places a cookie having the identifier corresponding to the new profile onto the device (so that the device is recognized when the device subsequently submits a request to the request director 206). It is to be noted that the use of cookies is a preferred embodiment and other embodiments are possible.

Additionally, the request director 206 may refuse a request from a recognized entity if it is determined from the corresponding profile that the entity does not have appropriate “rights” to access the requested resource or to perform a task.

A nature of the request is determined by the type of activity the device requests from of the component assembly engine 210. Common natures of requests include information upload, information download, and resource interaction.

Information upload and information download requests generally insert or retrieve information directly in from databases associated with the system of the preferred embodiment. Information upload and information download requests are generally made by affiliate programs (explained below) or from external sources such as kiosks or point-of-sale (POS) terminals which are, for example, located in brick and mortar stores.

Affiliate programs are instantiations of the present embodiment that are owned by different businesses that have information exchange agreements. These different businesses generally have entered into information exchange agreements which provide for the exchange of information contained in one instantiation of the present embodiment with other instantiations of the present embodiment. Information exchange agreements generally specify the type of information to be exchanged, the method by which the exchange is to take place, and the times and frequency that the exchanges are to take place.

Resource interaction requests, also referred to as clickthroughs, generally represent requests from devices (such as personal computer devices and HTTP client devices) for consumable information (i.e. viewable resources) or electronic interaction. A viewable resource is any information that is provided to requesting entities that can be displayed or otherwise “viewed” (or utilized) by the device (or requesting entity). In this context, the word “viewed” includes all form of human perception, including visual perception, hearing, tasting, smelling, feeling, etc. Electronic interaction is activity by the requesting entity in response to previously provided viewable resource. By way of example, an Internet webpage information that may be requested and viewed by the requesting entity, and is thus a viewable resource. Selecting a link within such webpage (such as by clicking on the link, highlighting the link, pressing a key associated with the link, otherwise selecting the link or the like) is electronic interaction, and, at the same time, a request for a further viewable resource. Clicking refers to any method for indicating a choice or selecting an object when interacting with an interactive electronic resource. By way of example, clicking includes, but is not limited to, pressing a key on a keyboard, touching a “button” on a touch sensitive screen, pressing a button on a mouse, or pressing a button on a telephone, terminal, or other appliance. Other examples of a viewable resource include electronic documents of any format, audio and/or video, tactile feedback, electronically encoded smells, and the like. Electronic interaction includes, but is not limited to, selecting links on webpages, responding to electronic forms requiring option selection, box checking, or alphanumeric entry.

After determining the identity of the requesting entity and the nature of the request, the request director 206 then routes the request as a function of the determined nature of the request.

Generally, all information upload requests, information download requests, and resource interaction requests are routed by the request director 206 to the I/O processor 208. One exception to the routing of requests by the request director 206 to the I/O processor 208 are resource interaction requests that do not need to be logged. Resource interaction requests may not need to be logged during system testing or maintenance, depending on what part of the system is being tested or checked. Resource interaction requests also are not to be logged when they come from a fully anonymous source. Fully anonymous sources are generally requesting entities that explicitly wish to remain anonymous, such as people who wish to maintain privacy and do not want their behavior to be tracked or traced. Such people may, for example, refuse to accept cookies onto their devices. All resource interaction requests that are not to be logged are routed directly from the request director 206 to the component assembly engine 210.

Embodiments of the present invention are particularly useful for businesses. As used herein, the term business refers to any entity that has products or services for sale. Businesses, in order to practice the system of the present invention, must have a network 104-based presence in the form of information availability or the ability to complete sales transactions. The term online, as used herein, refers to activity that takes place on or over a network 104. By way of example, an HTML-coded website on the Internet is an online website because it is accessed over the Internet, which is a network 104. As used herein, the term affiliate refers to two or more businesses that are in a form of partnership by which the businesses exchange information regarding the demographics, purchase behavior, browsing activity, likes, dislikes, or preferences of customers. As used herein, the term information exchange agreement refers to the agreement on which such business partnerships are based. The term “server-based system”, as used herein, refers to an embodiment of the present invention which is operating on a network 104 server computing device. Servers are generally computing devices coupled to a network 104 which store information and services and respond to user requests by providing any requested information or services.

In addition to other devices, e.g. personal computers, HTTP clients, and the like, point-of-sale (POS) terminals and kiosks are two forms of devices that receive user activity which is important to log. Point-of-sale terminals, as defined herein, are computing devices that serve as checkout points in business stores where a customer pays for merchandise. Kiosks, as defined herein, are generally customer accessible electronic devices that allow the customer to have the ability to access information and services such as: browse information relating to store products, place and track orders, check account information, etc. Kiosks allow users the same kind of interaction capabilities as other personal computer and HTTP client devices, and thus the logging of resource interaction requests from kiosks can have the same benefits as logging resource interaction requests from personal computers and HTTP client devices. If the kiosk is linked interactively with a server, i.e. the kiosk is able to send resource interaction requests to the server, then the kiosk generated resource interaction requests are routed to the request director 206 as described previously herein. Otherwise, resource interaction requests received by the kiosk must be independently logged and uploaded in an information upload request for later processing. This information upload request is likely to represent a substantial number of logged resource interaction events and therefore may need to be handled by a daemon server during times of low communication or processing activity, as discussed in detail later herein. As used herein, the term daemon server is a software program which carries out tasks. Generally, a daemon server is used to carry out a task which is too big or expensive to do right away (i.e. in “realtime”), so the daemon server may operate over long periods of time or during times of greater processing ability (e.g. during “off hours”).

Information generated by programs of affiliate programs is similar to information generated by kiosks that are not linked interactively with servers in that information generated by affiliate programs will likely need to be incorporated through the use of the daemon server in an information upload request. Affiliate programs represent systems of the present embodiment that are implemented by independent businesses that happen to have information exchange agreements that call for businesses to share information regarding, for example, users, user browsing behavior, and customer purchasing activity so that the businesses gain by having a greater depth and/or breadth of information available on which to base marketing campaigns, product research, promotional campaigns, etc.

Kiosks, POS terminals, and programs and websites of affiliate businesses may all also generate information download requests. Programs and websites of affiliate businesses may need a user's profile in order to carry out real time personalization, or they may just periodically issue download requests as per the information exchange agreement. Real time personalization refers to the proactive alteration, in realtime, of online resources which a user has requested by changing the requested resources in a way which is predicted to prove more useful to the user than the unaltered resource would have been. By way of example, a website offering music for sale may have random “specials” displayed on the default website, but if the website owner knows a user is only interested in classical music, these specials can be replaced with offerings of classical music because the user is predicted to only be interested in classical music. This is desirable to the website owner because if the user is presented with more things the user is interested in, it follows that the user is more likely to make a purchase. Kiosks and POS terminals may also periodically download information from the server-based system for the same reason that kiosks and POS terminals upload information which is that the server-based system, kiosks, and POS terminals remain updated with respect to each other. Kiosks and POS terminals also download information from the server-based system when necessary for real time personalization and/or download requests.

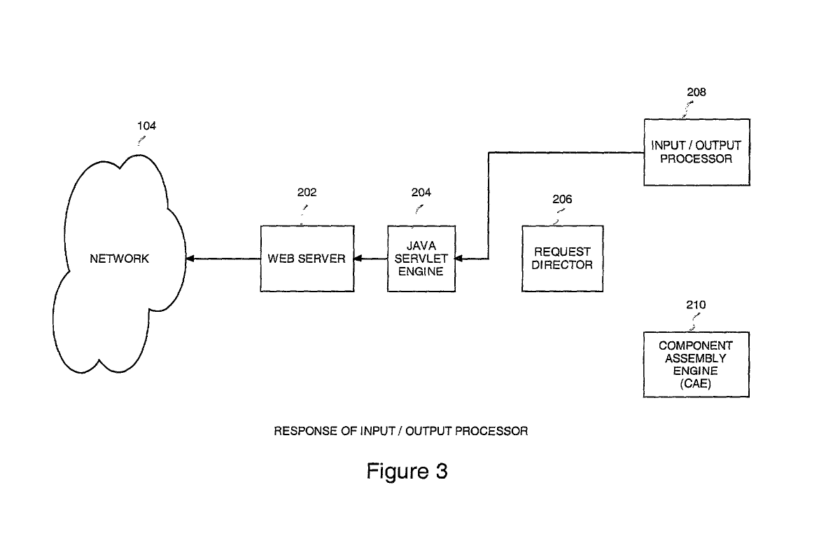

Referring to FIG. 3, shown is a block diagram of an exemplary embodiment showing delivery of information in response to an information download request.

Shown is a network 104, a web server 202, a java servlet engine 204, a request director 206, a component assembly engine 210, and an input/output processor 208.

The I/O processor 208 is coupled to the java servlet engine 204, which is coupled to the web server 202. The web server 202 is coupled to the network 104.

In practice, information download requests, getting routed to the I/O processor 208 and handled there, result in the gathering of requested information for download to the requesting entity. The I/O processor 208 responds by sending the requested information directly to the java servlet engine 204, where it is sent to the web server 202, which routes the requested information to the network 104. The network 104 then routes requested information to the requesting entity. It is to be noted that use of java servlet engine 204 is a preferred embodiment and other embodiments are possible.

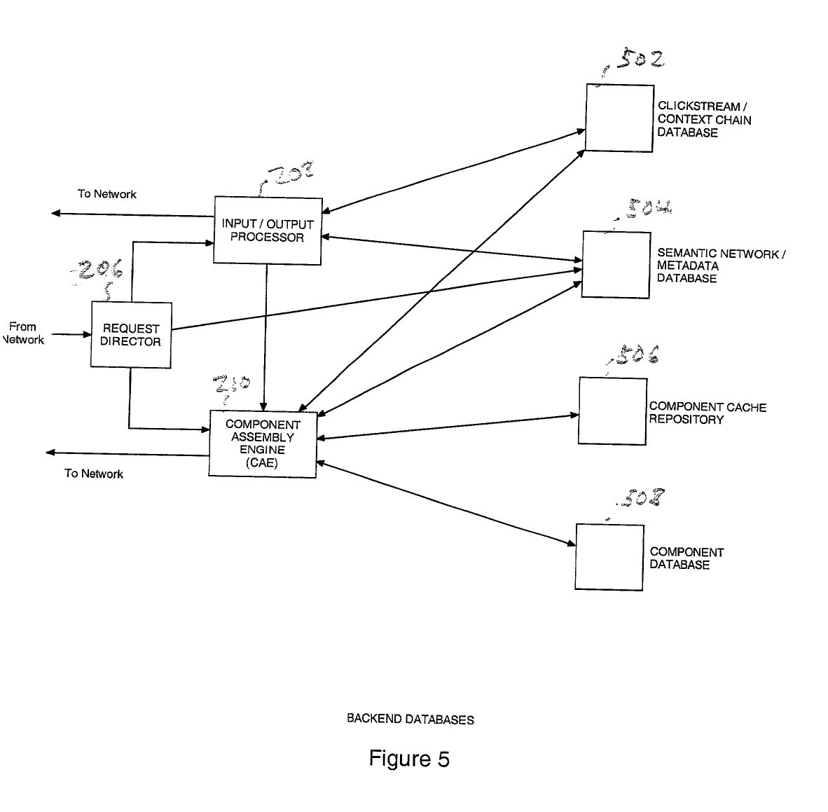

The term downloading as used herein as a general term covers downloading semantic network data (generally semantic network profiles or group semantic networks—both of which are discussed in detail later just hereafter), downloading of clickstream data (clickstream data is data saved in order to track a user's online activity and generally includes summary information about a viewable resource provided to a user and the user's action in response—clickstream data is discussed in further detail later herein in reference to FIG. 5), downloading data from external databases (which include any kind of database or data store external to the system of the present embodiment that contains information an entity using an instantiation of one embodiment of the present invention would need access to—an example is a billing database used by a business), and downloading viewable (or consumable) resources (an example of which is the serving of a webpage in response to a user's request). Only the last form of downloading, that of a viewable resource, is performed by the component assembly engine 210.

The information that is requested in information download requests generally covers one or more semantic network profiles for one or more users or devices. The semantic network profiles are stored in a semantic network/metadata database 504. A semantic network profile refers to a model of a user's likes, dislikes, and preferences which is modeled in a semantic network. Semantic networks are known and have a topology comprising nodes and links. As used herein, nodes represent products, services, or concepts and the links between the nodes represent relationships which can have defined natures and weights. By way of example, a semantic network profile modeling a toy-loving child may have a node for teddy bear and a node for cuddly with a link going from the teddy bear node to the cuddly node having a nature of “characteristic” and a weight of “1.0”. The semantic network/metadata database 504 is the storage location for semantic network profiles. Semantic network profiles and the semantic network/metadata database 504 are discussed in detail later herein in reference to FIG. 5. The I/O processor 208 also handles any download requests for data from external databases connected to the system.

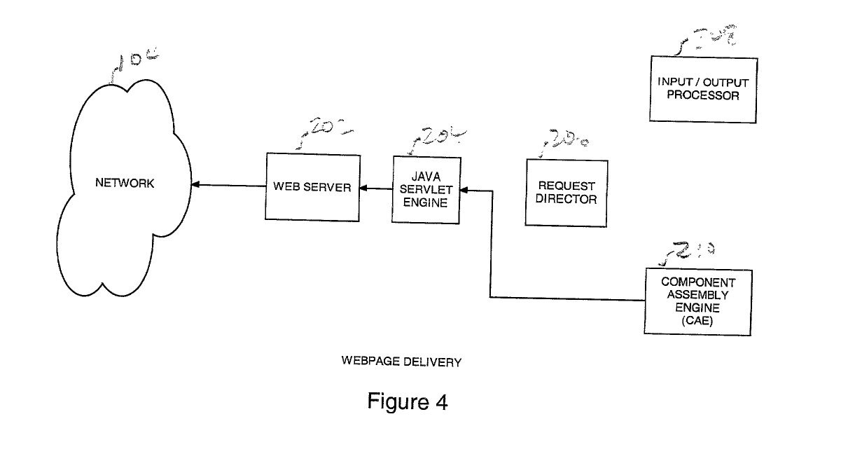

Regarding FIG. 4, shown is a block diagram of an embodiment showing delivery of a viewable resource in response to a resource interaction request.

Shown is a network 104, a web server 202, a java servlet engine 204, a request director 206, a component assembly engine 210, and an input/output processor 208.

The component assembly engine 210 is coupled to the java servlet engine 204, which is coupled to the web server 202. The web server 202 is coupled to the network 104.

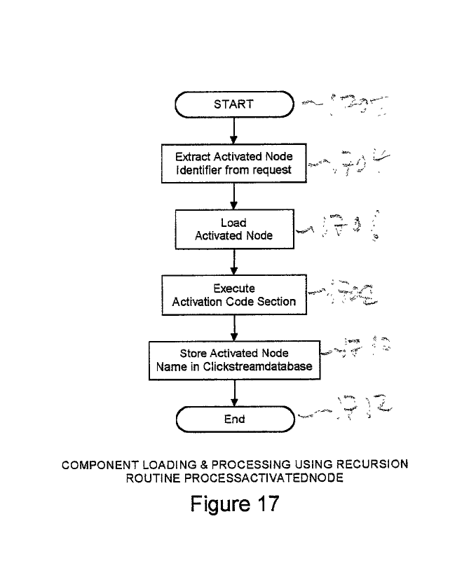

In practice, resource interaction requests for a viewable resource (a viewable resource is a form of consumable information such as, but not limited to, a webpage—consumable resources include audio files, video files, tactile feedback, etc. Consumable files also include the delivery of data which is not directly provided to the user but which is fed into other programs on the user's device) are eventually routed to the component assembly engine 210 as discussed previously herein in reference to FIG. 2. The component assembly engine 210 processes the request, which generally results in the construction of the viewable resource. An exemplary method of the construction of a viewable resource is discussed in detail later herein in reference to FIGS. 17-20. The component assembly engine 210, upon finishing construction of the viewable resource, such as an electronic document, responds by sending the viewable resource directly to the java servlet engine 204. The java servlet engine 204 sends the viewable resource to the web server 202. The web server 202 sends the viewable resource to the network 104. The network 104 then routes the viewable resource to the requesting entity or device.

Referring to FIG. 5, shown is a block diagram of an embodiment showing backend databases.

Shown is a request director 206, an I/O processor 208, a component assembly engine 210, a clickstream/context chain database 502, a semantic network/metadata database 504, a component cache repository 506, and a component database 508.

The request director 206 is coupled (shown by an arrow pointing to the request director 206) to the network (not shown). The component assembly engine 210 and the I/O processor 208 are each coupled (shown by arrows pointing to the network) to the network (not shown). The request director 206 is coupled to both the I/O processor 208 and the component assembly engine 210 (shown by arrows pointing away from the request director 206). The request director 206 is also coupled to the semantic network/metadata database 504 (shown by an arrow pointing away from the request director 206). The I/O processor 208 is coupled to both the clickstream/context chain database 502 and semantic network/metadata database 504 (shown by bidirectional arrows). The component assembly engine 210 is coupled to each of the clickstream/context chain database 502, the semantic network/metadata database 504, the component cache repository 506, and the component database 508 (shown by bidirectional arrows).

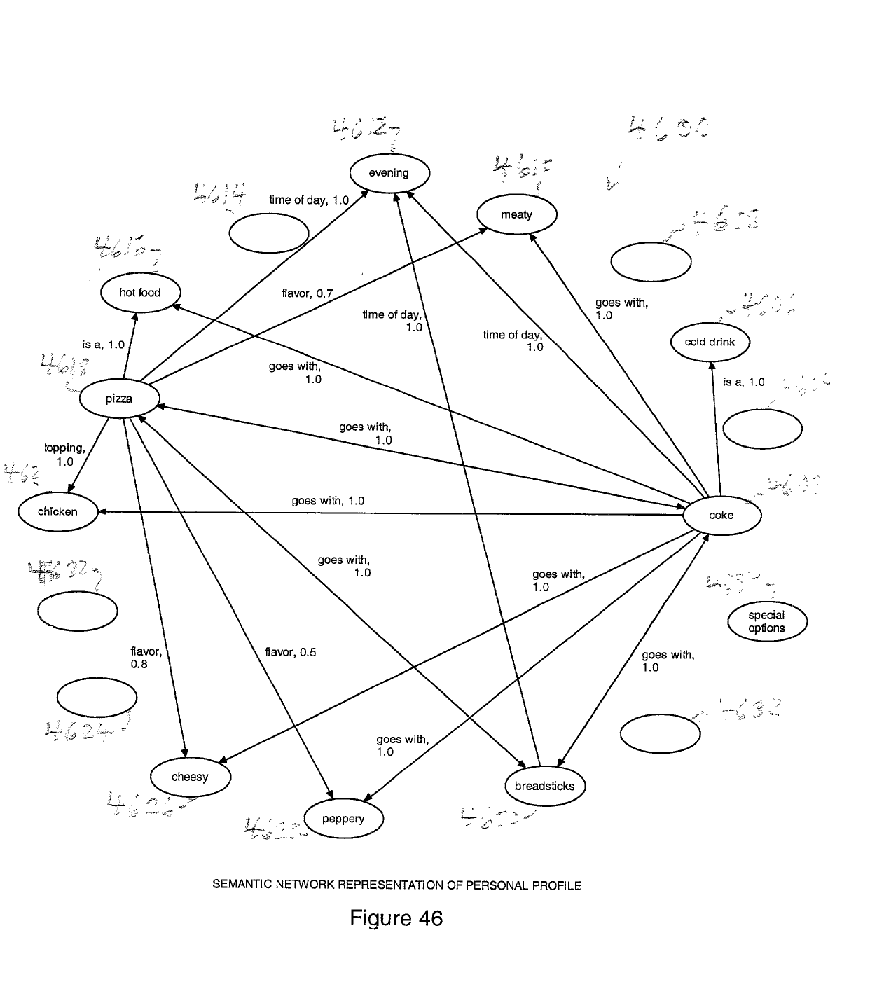

In operation, requests coming from the network arrive at the request director 206 for analysis and routing. If the request director 206 does not recognize the requesting entity, the request director 206 will create a new user semantic network profile in the semantic network/metadata database 504. A semantic network profile of a user is a representation of the likes, dislikes, past behavior, and preferences of the user. The semantic network profile of a user is a semantic network populated with data just from that user. Semantic networks are known. Semantic network profiles and semantic networks are discussed in detail later herein in reference to FIG. 46.

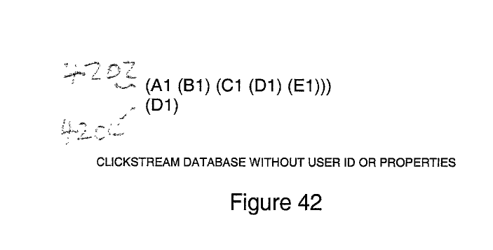

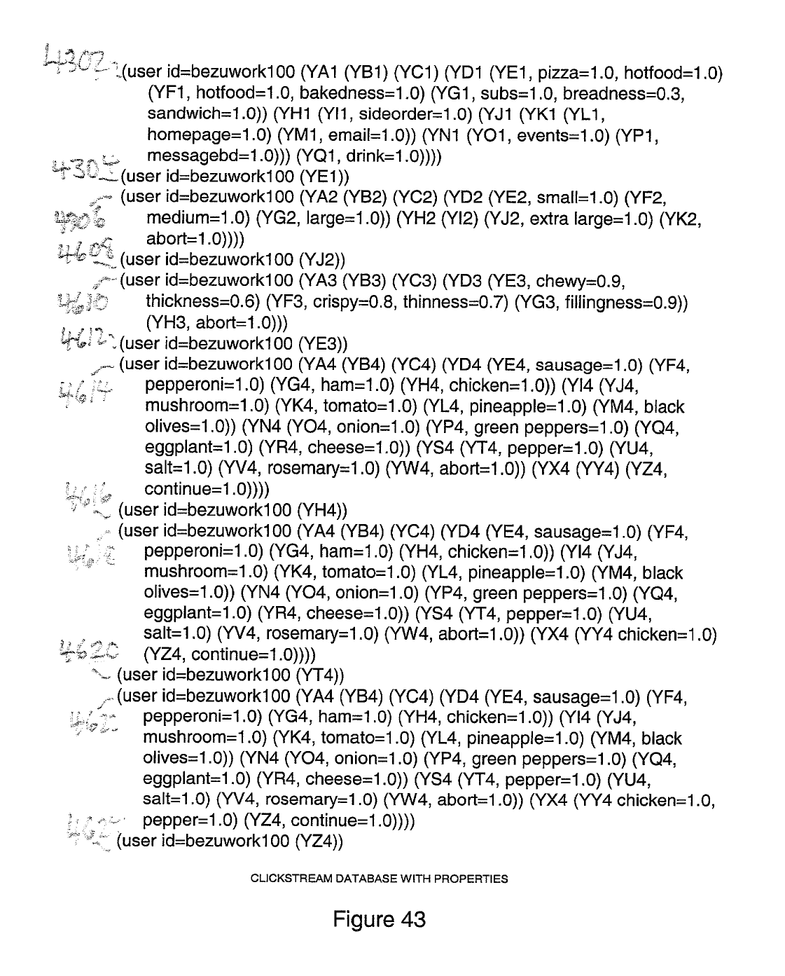

The request director 206 routes most requests to the I/O processor 208. For information upload requests containing data on user activity, the I/O processor 208 stores the information to the clickstream/context chain database 502. The clickstream/context chain database 502 generally holds information which allows a user's interaction with viewable resources to be tracked. Clickstream/context stream databases are discussed in detail later herein in reference to FIGS. 42-43. Information stored in the clickstream/context chain database 502 during an information upload request results generally from a user browsing on a kiosk, making a purchase at a point-of-sale (POS) terminal, or interacting with an affiliate program. In effect, the user's browsing behavior (on the kiosk), purchasing behavior (at the POS terminal), or interaction (with the affiliate program) produces a local set of clickstream data which can simply be uploaded to the online clickstream/context chain database 502.

Information upload requests can also have data for direct storage into the semantic network/metadata database 504, which may be for updating specific user semantic network profiles (SNP) or for updating general or group semantic networks. General or group semantic networks are discussed in detail later herein in reference to FIG. 46. From uploaded clickstream data, if the user is not recognized, a new semantic network profile can be created for the user and the data incorporated therein. This is done by the request director 206.

For information download requests, the I/O processor 208 will typically read the semantic network/metadata database 504 to retrieve an identified user's semantic network profile for delivery to either a remote terminal such as a kiosk or point-of-sale (POS) terminal, or for delivery to an affiliated program (typically associated with an affiliated business or company under a demographic or preference data exchange agreement).

Resource interaction requests usually need to be logged. Some resource interaction requests may not need to be logged, such as during testing/maintenance, or during fully anonymous access, as was described previously herein. Logging of resource interaction requests occurs by the I/O processor 208 first registering the event in the clickstream/context chain database 502. The I/O processor 208 then routes the request to the component assembly engine 210. The component assembly engine 210 then acts on the request, which generally results in building and sending a viewable resource to the requesting entity. An exemplary method of the construction of a viewable resource is discussed in detail later herein in reference to FIGS. 17-20. Generally, the terms viewable resource, webpage, or page are used herein but it is understood that the present embodiment can be used to construct any form of electronically rendered content As part of the process of building a viewable resource in response to requests, the component assembly engine 210 stores context information in the clickstream/context chain database 502. Context information is information that defines the properties of a viewable resource as a necessary aid in tracking user interaction behavior.

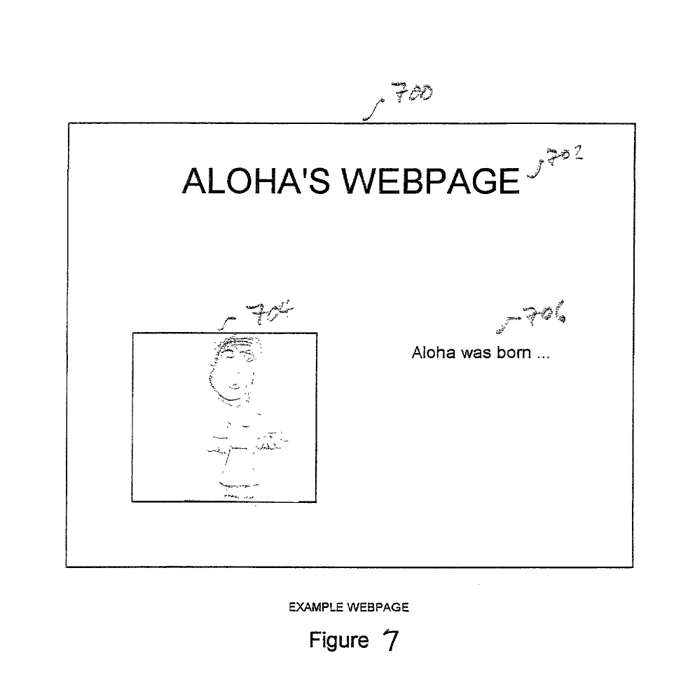

This context information allows the system to keep track of what the user views. The component assembly engine 210 may also read the clickstream/context chain database 502 information during customization or personalization of viewable resources. In order to perform effective personalization, it is important for personalization decisions to be based on the past “dialog” between the web surfer and the information presented on the site. The clickstream/context chain database 502 stores the dialog that represents the captured interaction behavior for an individual user. The component assembly engine 210, while building the viewable resource requested, constructs an abbreviated summary of the viewable resource in the form of an s-expression. S-expressions are known and herein are used as an abbreviated way to present summary information of components. S-expressions are discussed in more detail later herein in reference to FIG. 43 The s-expression incorporates the assigned properties associated with each component. Assigned properties are part of the context information and are discussed in detail later herein in reference to FIG. 27. Components are the basic building blocks of a viewable resources and are discussed later herein in reference to FIGS. 7-9. The final s-expression for the viewable resource is stored by the component assembly engine 210 in the clickstream/context chain database 502.

The component assembly engine 210 may access the semantic network/metadata database 504 to retrieve information needed for viewable resource construction, personalization, consumer marketing, or direct marketing purposes. This information can be of various types such as profile data, product/category data, content metadata, etc. This information might include user profile data (contained in semantic network profiles), specific product information, or site configuration information. The component assembly engine 210 may also change data in the semantic network/metadata database 504. A change in a user's semantic network profile regarding a product or category as a result of the viewing of some webpage content is an example.

The component assembly engine 210 receives components from the component cache repository 506. The component cache repository 506 serves as a cache storage for components. The component cache repository 506 resides in the server's memory, rather than in slower media (such as a harddrive), so that quicker access to the components needed to construct a page is assured.

The component cache repository 506 holds a finite number of components. Therefore, the component cache repository 506 decides which components to hold and which are replaced when the component cache repository 506 is fill. Many algorithms for determining which information to retain in cache and which to store back to slower memory are well-known in the art. The component cache repository 506 can be implemented with whichever algorithm is considered best for the system on which it resides, but a preferred embodiment is keeping those components which rank highest with respect to the number of accesses within a most-recent time period. Alternatively, a least recently-used algorithm may be used. Thus as the ranking of components changes over time, the components stored in the component cache repository 506 change in response to the changes in ranking.

The component database 508 is the system's permanent storage for all components within the system.

It is noted that software practitioners are able to write code that executes in the component assembly engine 210 to generate components on the fly, but in a preferred embodiment, this is a restricted feature.

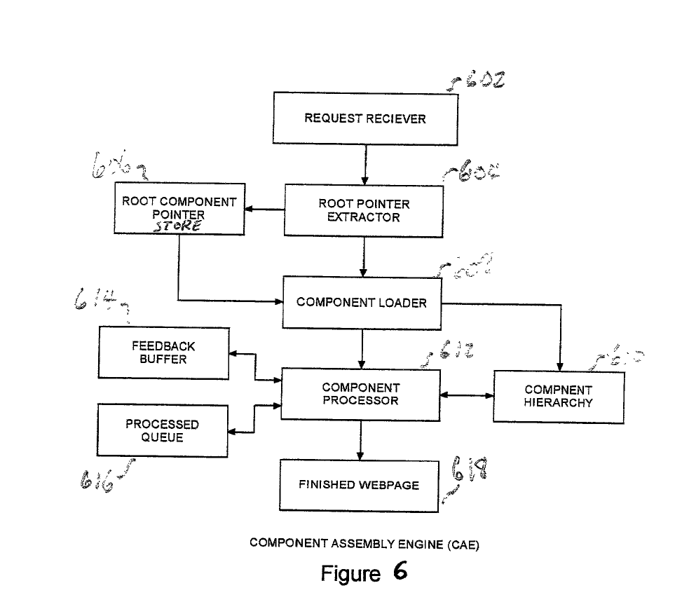

Referring to FIG. 6, shown is a block diagram of a preferred embodiment of the component assembly engine 210.

Shown is a request receiver 602, a root pointer extractor 604, a root component pointer store 606, a component loader 608, a component hierarchy 610, a component processor 612, a processed queue 616, a feedback buffer 614, and a finished webpage 618.

The request receiver 602 is coupled to the Root Pointer Extractor 604, which is coupled to both the Root Component Pointer Store 606 and the Component Loader 608. The Root Component Store 606 is coupled to the Component Loader 608, which is coupled to both the Component Hierarchy 610 and the Component Processor 612. The Component Hierarchy 610 is coupled to the Component Processor 612, which is coupled to the Finished Webpage 618 and bidirectionally coupled to both the Processed Queue 616 and the Feedback Buffer 614.

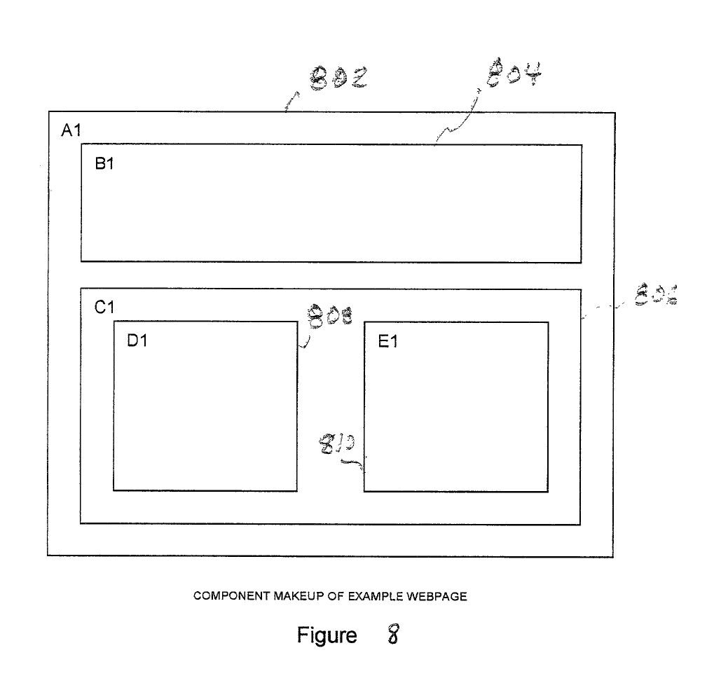

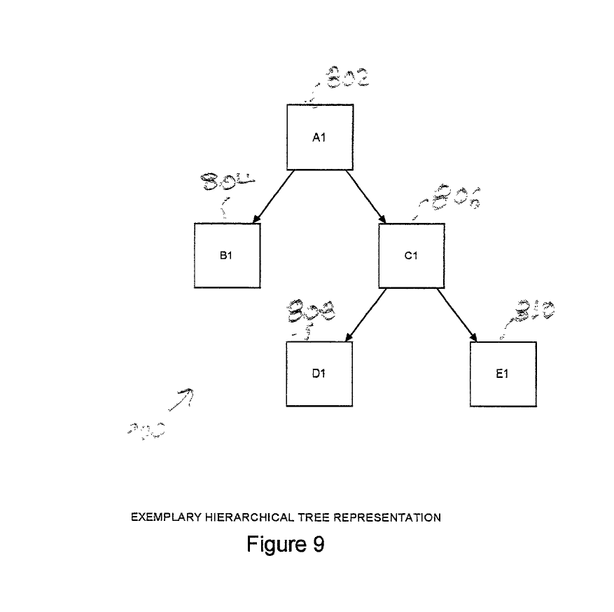

In operation, the component assembly engine 210 receives requests in the request receiver 602, which passes the request to the root pointer extractor 604, which extracts a pointer to a root component. The root component i s t he top component in a hierarchical tree of components and is discussed in detail later herein in reference to FIGS. 8-9. The pointer to the root component is simply a reference or address by which the component assembly engine 210 can locate the root component. The root pointer extractor 604 stores the root pointer in the root component pointer store 606 and passes control to the component loader 608. The component loader 608 gets the root component pointer from the root component pointer store 606 and loads all of the components required to satisfy the request received. Control then passes to the component processor 208, which processes the loaded components and enters data in the processed queue 616 to indicate which components have already been executed. The component processor 208 also, while processing the loaded components, generates a feedback buffer 614 for each component processed. The feedback buffer 614 is a buffer that holds the output of the processing of a component. Using HTML webpages as an example, the feedback buffer 614 for a component would contain all the resultant output of the processing of the component which contributes to the viewable resource. The feedback buffer 614 for each component additionally incorporates the data of the feedback buffers 614 of all of the children of that component. This is possible as the components are processed in reverse order from their loading, and thus the feedback buffer 614 of each child component is available when the parent component is processed. When finished processing all of the components, the component processor 208 produces the finished webpage 618, which is actually the feedback buffer 614 of the root component.

Referring to FIG. 7, shown is an exemplary webpage 700.

Shown is a heading 702 which reads “Aloha's webpage”, an image 704, and a text area 706 containing text “Aloha was born . . . ”.

Traditionally, such a page could be coded using a markup language such as HyperText Markup Language (HTML) specifying the heading 702 within a heading tag such as “<h1>Aloha's webpage</h1>”. The image 704 would likewise be specified with an image tag and so forth. When a user instructs his or her browser to access the webpage of FIG. 6 (perhaps by entering the URL directly or by following a link on another webpage), the browser receives the HTML file from the server and interprets the code in order to render the webpage for the user's consumption. Coding of webpages may be either static or dynamic as discussed previously herein in the Background of the Invention. With a static webpage, the HTML code is completely or mainly stored in the form that the browser receives it. Dynamic webpages are dynamically created by the server or a delegated processing device as discussed previously herein in the Background of the Invention.

Referring to FIG. 8, shown is the component makeup of the exemplary webpage of FIG. 7.

Shown are a component A1 802, a component B1 804, a component C1 806, a component D1 808, and a component E1 810.

The component A1 802 is coupled to both the component B1 804 and the component C1 806 which is coupled to both the component D1 808 and the component E1 810.

By way of example, the component A1 802 is the root component of the webpage 700 of FIG. 7 and encompasses everything visible in FIG. 7. In this example, however, the component A1 802 does not itself provide any of the visible matter of FIG. 7. The component A1 802 has two child components (also called “subcomponents”), the component B1 804 and the component C1 806. The component B1 804 contains visible matter in the form of the heading 702 “Aloha's webpage”. The component C1 806 has two child components, the component D1 808 and the component E1 810. The component D1 808 contains the image 704 and the component E1 810 contains the text area 706 reading “Aloha was born . . . ”. Alternative nesting possibilities are always possible and it is up to the software practitioner to choose the best method for the design requirements at hand.

Components can be classified by the effects they have. Producer components create or produce output that is used by other components or that eventually forms part of the resource provided to the requestor. Consumer components use or consume output of other components. Transformer components alter or transform the output of other components.

Referring to FIG. 9, shown is the hierarchical tree visualization of the component makeup of FIG. 8.

Shown is a component A1 802, a component B1 804, a component C1 806, a component D1 808, and a component E1 810.

The component A1 802 has links to both the component B1 804 and the component C1 806. The component C1 806 has links to both the components D1 808 and E1 810.

Operationally, the component hierarchy of FIG. 9 is a visually more uncluttered way to view the component nesting shown in FIG. 8.

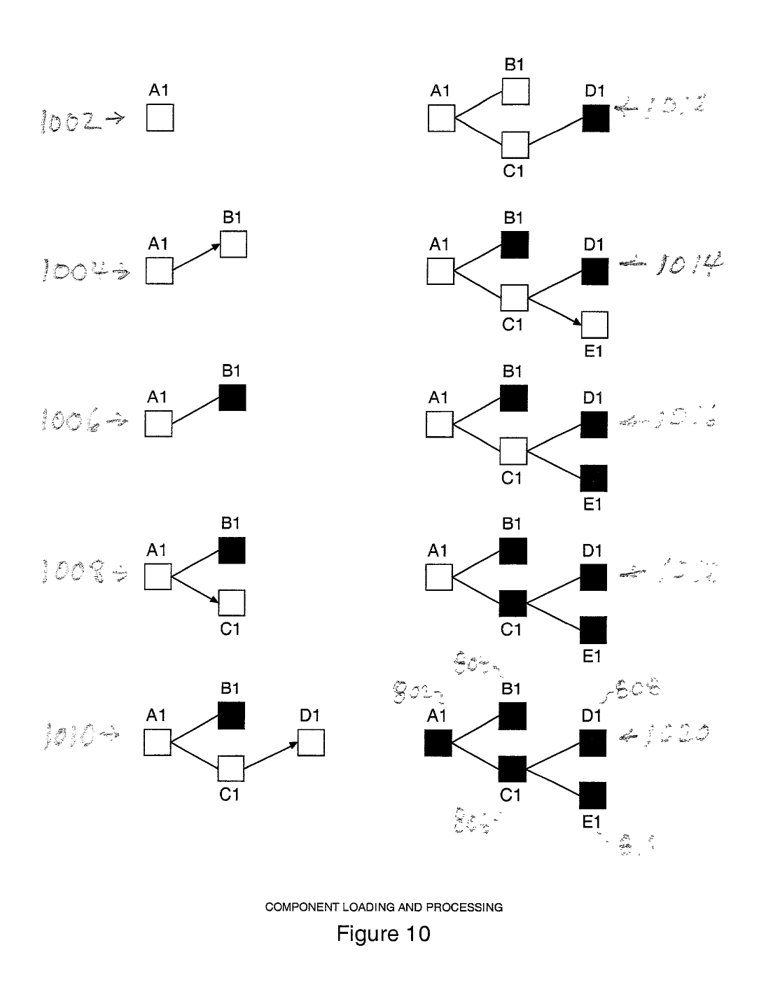

Referring to FIG. 10, shown is an order in which the components of FIG. 8 and FIG. 9 are loaded and processed by the component assembly engine 210.

Shown are a subfigure 1002, a subfigure 1004, a subfigure 1006, a subfigure 1008, a subfigure 1010, a subfigure 1012, a subfigure 1014, a subfigure 1016, a subfigure 1018, and a subfigure 1020. Subfigure 1002 shows a component A1 802. Subfigure 1004 shows components A1 802 and B1 804. Subfigure 1004 shows components A1 802 and B1 804. Subfigure 1008 shows components A1 802, B1 804, and C1 806. Subfigure 1010 shows components A1 802, B1 804, C1 806, and D1 808. Subfigure 1012 shows components A1 802, B1 804, C1 806, and D1 808.

Subfigure 1014 shows components A1 802, B1 804, C1 806, D1 808, and E1 810. Subfigure 1016 shows components A1 802, B1 804, C1 806, D1 808, and E1 810. Sub FIG. 1018 shows components A1 802, B1 804, C1 806, D1 808, and E1 810. Subfigure 1020 shows components A1 802, B1 804, C1 806, D1 808, and E1 810.

Some components are shown shaded-in in some subfigures. Component B1 is shown shaded-in in subfigures 1006 through 1020. Component D1 808 is shown shaded-in in subfigures 1012 through 1020. Component E1 810 is shown shaded-in in subfigures 1016 through 1020. Component C1 806 is shown shaded-in in subfigures 1018 and 1020. Component A1 802 is shown shaded-in in subfigure 1020.

Structurally, in subfigure 1002 is the component A1 802. In subfigures 1004 and 1006, the component A1 802 coupled to the component B1 804. In subfigure 1008 the component A1 802 is coupled to the components B1 804 and C1 806. In subfigures 1010 and 1012, the component A1 802 is coupled to the components B1 804 and C1 806, which is coupled to the component D1 808. In subfigures 1014 through 1020, the component A1 802 is coupled to both the components B1 804 and C1 806 and component C1 806 is coupled to the components D1 808 and E1 810.

By way of example, described herein is a single-threaded method of loading and processing the components of the component hierarchy 900 shown in FIG. 9. As shown in FIG. 10, components represented by an empty box are components which have been loaded but not processed. Components which are represented by shaded in boxes are components which have been both loaded and processed.

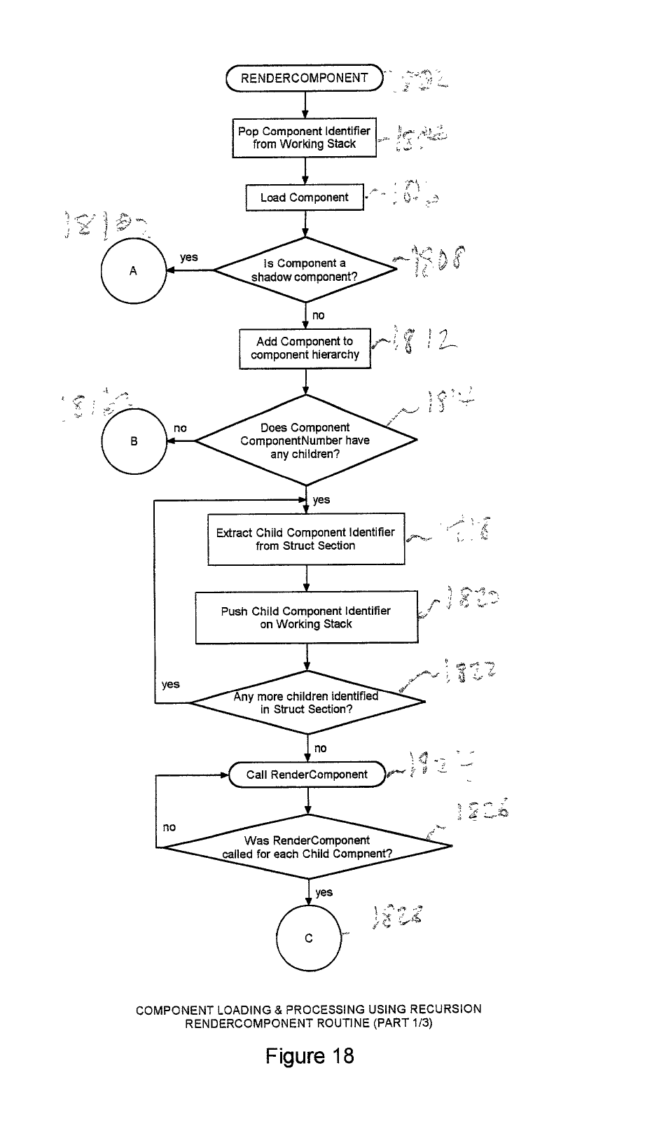

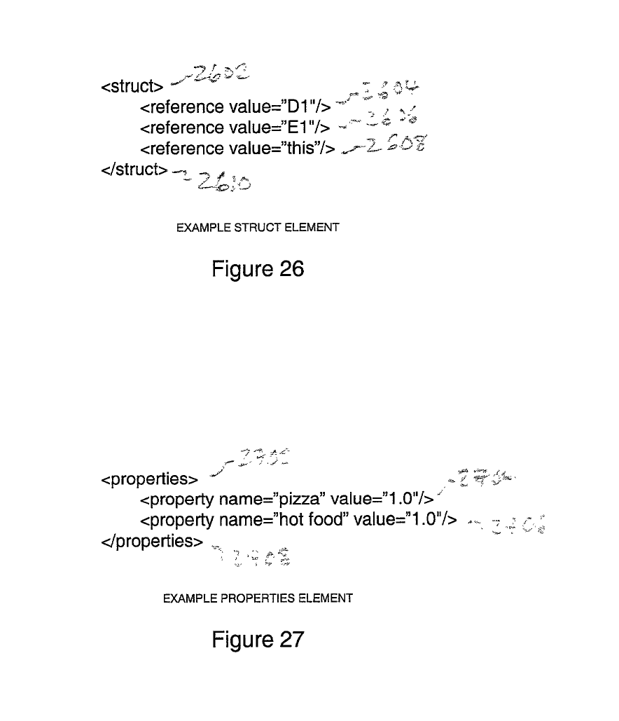

In operation, component loading follows the component hierarchical tree as visualized in FIG. 9 in a depth-first manner. Thus, in the topmost subfigure, the component assembly engine 210 has loaded component A1 802. Once component A1 802 has been loaded, the component assembly engine 210 looks into a struct element of component A1 802 for child component entries and reads the first entry and then loads the indicated child component, which is component B1 804. The struct element (or section) of a component is a section that contains the entries for all child components of a component. The struct section is discussed in more detail later herein in reference to FIG. 26. The next subfigure shows that the components A1 802 and B1 804 have been loaded. Following the depth first paradigm, the component assembly engine 210 looks into the struct element of component B1 804 to see whether any child component entries are present and determines that there are not. A component without any child components is called a leaf node. After determining that there are no child components to load, the component assembly engine then processes the component B1 804 by executing the component (execution is discussed in detail later in reference to FIGS. 18-20). Thus, component B1 804 is shown shaded-in in subfigure 1006. After execution of the component B1 804, the component assembly engine 210 backs up to A1 802 and checks the struct element of A1 802 for any more child component entries. The component assembly engine 210 reads an entry specifying component C1 806 as another child component and loads the component C1 806. Thus subfigure 1008 shows the components A1 802, B1 804, and C1 806 as loaded. By similar machinations, the component assembly engine 210 first loads and processes component D1 808 and then component E1 810 in that order as shown in subfigures 1010 (component D1 808 is loaded), 1012 (component D1 808 is processed), 1014 (component E1 810 is loaded), and 1016 (component E1 810 is processed). After loading and processing the components D1 808 and E1 810, the component assembly engine 210 proceeds back to the component C1 806 and determines that after the child components D1 808 and E1 810, the component C1 806 has no further child components. Thus, the component assembly engine then processes component C1 806 as shown in subfigure 1018. The component assembly engine then proceeds back to the component A1 802 and determines that after components B1 804 and C1 806, the component A1 802 has no further child components. Thus, the component assembly engine 210 determines that all of the descendants for the root component A1 802 have been loaded and processed. Thus the component assembly engine 210 has finished the loading phase for component A1 802 itself and processes component A1 802, shown in subfigure 1020.

The description of the previous paragraph did not treat a situation where one or more of the components is a “shadow component”. Shadow components serve two purposes. Shadow components may be “placeholder components”. As a placeholder component, a shadow component, during the loading phase, effects a replacement of itself with specific other components. Shadow components may also be components for which the child components are determined by the component assembly engine 210 during the loading phase. Shadow components allow for dynamic personalization of the resource being built. Shadow components are discussed in greater detail later herein in reference to FIGS. 11-14. If any of the components had been shadow components, the component assembly engine 210 would have had to carry out code and rule execution prior to continuation of component loading. This is because the purpose of a shadow component is that it is a kind of placeholder component, putting off resolution of which child components are to be loaded until the shadow component is loaded during the building of a resource. This allows for dynamic customization and personalization of resources in response to any available factors. For example, depending on the identity of the requestor, the webpage can be filled with different content as a result of personalization. Webpages could also be formed with different content depending on the day or time of day, or even in a random manner. Any data available to the component assembly engine 210 can be used by shadow components as criteria on which to determine which components are selected as child components. The effects and power of loading phase resolution of shadow components is discussed in greater detail later herein in reference to FIG. 11.

Referring to FIG. 11, shown is a comparison between shadow component replacement and shadow component supplementation.

Shown are three subfigures. The topmost subfigure shows components A2 1108, B2 1110, C2 1112, and D2 1114. The left bottom subfigure shows components A2 1108, B2 1110, C2 1112, E2 1116, and F2 1118. The right bottom subfigure shows components A2 1108, B1 1110, C2 1112, D2 1114, G2 1120, and H2 1122.

In the topmost subfigure, component A2 1108 is linked to components B2 1110 and C2 1112 which is linked to component D2 1114. In the left bottom subfigure, the component A2 1108 is linked to the components B1 1110 and C2 1112. Component C2 1112 is linked to the components E2 1116 and F2 1118. In the right bottom subfigure, the component A2 1108 is linked to the components B1 1110 and C2 1112, which is linked to the component D2 1114, which is linked to the components G2 1120 and H2 1122.

In operation, shadow components, during the loading phase, must be resolved to determine what child components they are to have or be replaced with. In a preferred embodiment, the component assembly engine 210 loads components by use of a working stack. The working stack is a last-in, first-out queue that is used to keep track of which components have been loaded but not fully processed. The request director 206 initializes the working stack in system memory which is accessible to the component assembly engine 210. In a preferred embodiment, the component assembly engine 210 uses recursion during the loading and processing phases. When the component assembly engine 210 receives a request from either the I/O processor 208 or directly from the request director 206 (usually during fully anonymous access as discussed previously herein in reference to FIG. 2), the component assembly engine 210 enters the loading phase and looks in the corresponding working stack at the last entry placed in the working stack which is the root component. The component assembly engine 210 then looks in the struct section of the root component and spawns a child process instantiation of the loading & processing routine for each child component of the root component. The loading & processing recursive routine is a software routine that handles the loading and processing of one component. The loading & processing recursive routine is recursive, meaning that it can be called by itself, necessary in order to process the hierarchy of components. The loading & processing routine is discussed in detail in reference to FIGS. 17-20. Each instantiation of the loading & processing routine thus initially receives one component to load and process, and recursively instantiates another instantiation of the loading & processing routine for each child component contained in the struct section of the component which was loaded. The process of recursively spawning new child processes for subsequent child components continues until components are reached which have no children. Components that have no children are called leaf components. Once a leaf component is reached, the loading phase for that component branch is finished and the processing phase begins. A component branch is a single-width traversal of the component hierarchy tree which can be as short as 1 link (from parent component to child component) or as long as spanning the whole tree by beginning with the root component and ends with a leaf component. Once the loading & processing routine finishes instantiating loading & processing routines for each of the child components for the component that has been loaded, the loading & processing routine continues on to the processing phase. During the processing phase, the rules and the process code contained in the rules element and process code elements, respectively, are executed. A feedback buffer and a properties buffer are generated, passed back to the parent process, and the child process terminates.

Shadow component processing during the loading phase can result in supplementation or replacement. In replacement, the shadow component does not exist in the final component hierarchy and in supplementation, it does.

Supplementation occurs when the shadow rules and shadow code do not cause the deletion of the shadow component from the working stack, but instead self-modify the struct element of the shadow component to place entries there for children components. After this, the component assembly engine treats the shadow component as if it was a normal component, determining the child components and spawning a child process of the loading & processing routine for each of the children components determined. The only difference from treating it like a normal component is when the child components are all loaded and processed, the component assembly engine does not re-execute the rules element or code element contents. This is shown in the right bottom subfigure where the shadow component D2 1114 is linked to the two children components G2 1120 and H2 1122.

Replacement occurs when shadow components are coded such that when executing (during the loading phase), the shadow rules or shadow code, instead of internally modifying the struct section of the shadow component, modify the struct section of the parent component of the shadow component by deleting the child reference to the shadow component and inserting therefore any number of references to other components. Shadow components which engage in replacement are also called placeholder components as discussed previously herein in reference to FIG. 10. This is shown in the left bottom subfigure of FIG. 11 where the child components B2 1116 and F2 1118 have replaced shadow component D2 1114. Replacement is not to be used in situations where a parent component and the child shadow component reside on different systems as the requirements of a child shadow component modifying the struct section of a parent component on another system is difficult and involves greater overhead.

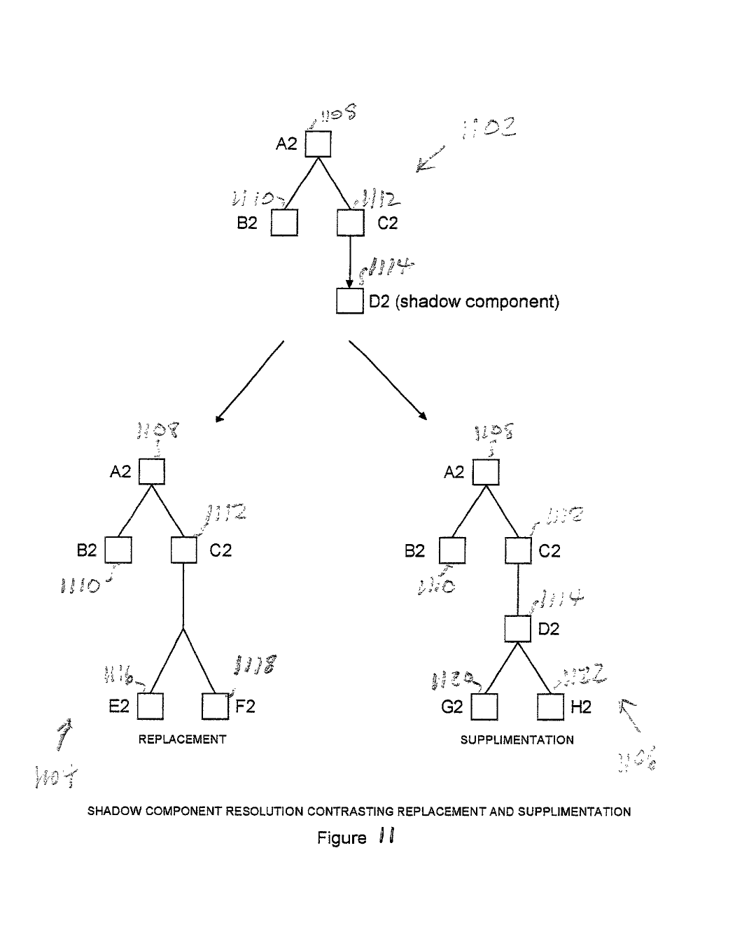

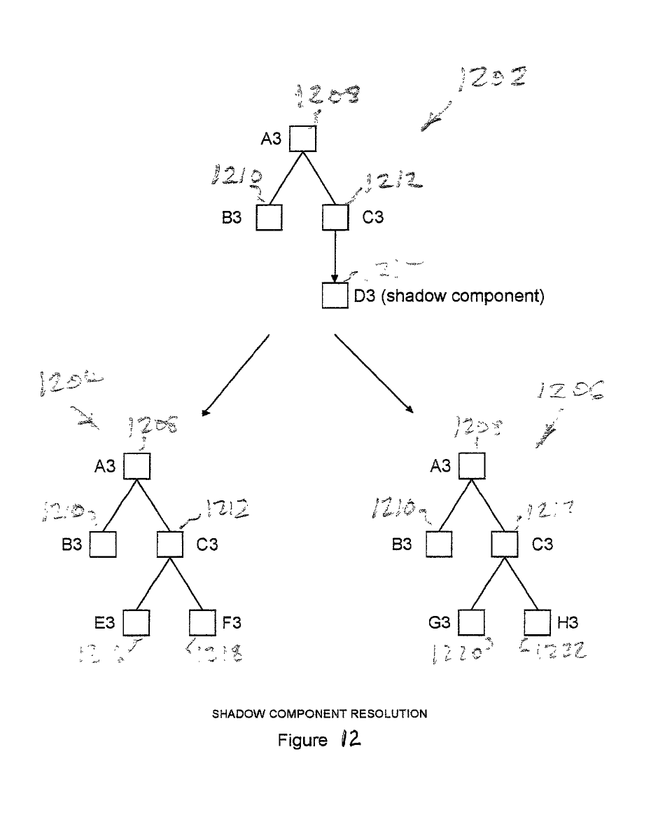

Referring to FIG. 12, shown is a block diagram of the effects of shadow component resolution.

Shown are three simple component hierarchies. The topmost hierarchy comprises components A3 1208, B3 1210, C3 1212, and D3 1214. The left bottommost hierarchy comprises components A3 1208, B3 1210, C3 1212, E3 1216, and F3 1218. The right bottommost hierarchy comprises components A3 1208, B3 1210, C3 1212, G3 1220, and H3 1222.

Structurally, in the topmost hierarchy, component A3 1208 connects to both components B3 1210 and C3 1212, which connects to component D3 1214. In the left bottommost hierarchy, component A3 1208 connects to both components B3 1210 and C3 1212, which connects to components E3 1216 and F3 1218. In the right bottommost hierarchy, component A3 1208 connects to both components B3 1210 and C3 1212, which connects to components G3 and H3.

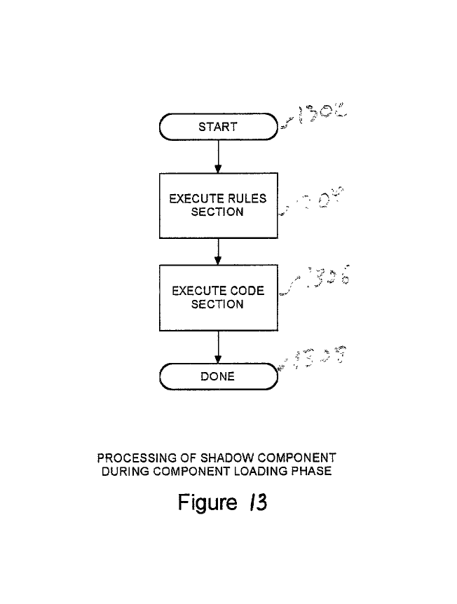

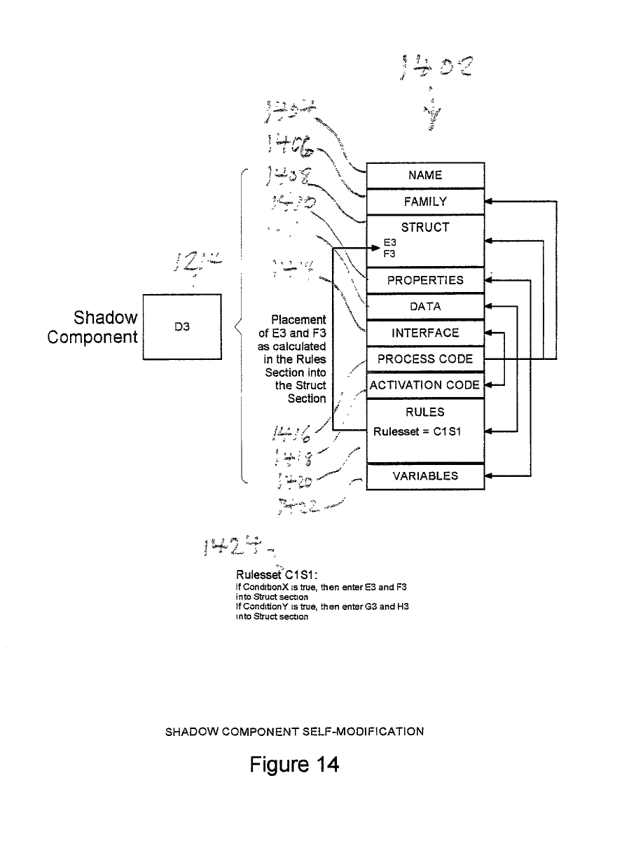

FIG. 12 shows the effect of different resolutions of a shadow component. In this figure, component D3 1214 is a shadow component. This means that the children of D3 1214, if there are any, are not known until a request comes in to the component assembly engine 210 and the component assembly engine 210 gets to the component D3 1214 during the loading phase of processing the request. During the loading phase, when the component assembly engine 210 has loaded component D3 1214, it checks the name section of component D3 1214 and determines D3 1214 to be a shadow component. The name section (also referred to as element) of a component is a part of the component that contains the name of the component and an entry indicating the component is a shadow component if the component is a shadow component. The component assembly engine 210 then executes any shadow rules in the rules element and any shadow code in the Process Code element of the component D3 1214 What children result from this execution depends on the shadow rules and shadow code executed. Specifically, execution of the shadow rules and shadow code actually causes the component D3 1214 to self-modify the Struct section of component D3 1214 by placing entries therein containing the identities of the children components. An exemplary method of component self-modification is discussed later herein in reference to FIG. 14. After self-modification, the component assembly engine 210 continues the loading phase on the component D3 1214 as if component D3 1214 was a normal component. Thus, as described previously herein, an instantiation of the loading & processing routine is created for the children of component D3 1214.

In this example, shown are two different component hierarchies generated as a result of differing resolutions of shadow component D3 1214. In the left bottommost subfigure, shown is a component hierarchy in which the component D3 1214 is shown as having been resolved into the components E3 1216 and F3 1218 and in the right bottommost subfigure, shown is a component hierarchy in which the component D3 1214 is shown as having been resolved into the components G3 1220 and H3 222.

This alternative resolution results when the executed shadow code and shadow rules produce different output in the form of different child component entries in the Struct section of the shadow component.

This alternative resolution is very flexible and important to the personalization and customization abilities of one embodiment of the present invention. The shadow rules and shadow code can carry out personalization by using as input any information available to the component assembly engine 210, for example, but not limited to, the requestor's identity and the requestor's past behavior as stored in the semantic network profile for the requestor. The shadow rules and shadow code can also access group semantic networks (GSNs) to obtain information not specific to the requestor. Group semantic networks are similar to semantic network profiles. As a semantic network profile is a representation of the accumulated data on a user's online activity which is used to model his or her likes, dislikes, and preferences, so is the group semantic network a semantic network representation of the likes, dislikes, and preferences of some group of users. A group semantic network can be of use when a specific user's semantic network profile does not contain information required for the personalization.

As example, perhaps a requestor has interacted online at the web site of a business and a semantic network profile has been developed for the requestor but the requestor has never purchased or looked at music online. If the requestor now goes to a music site also using one embodiment, it may be that for some personalization efforts the information from the non-music sites are of little aid in determining how to personalize the music web site for the requestor and so shadow rules and shadow code, determining that the requestor has no data for music preferences, access a group semantic network which has information from multiple users. By accessing this group semantic network, information regarding the music-related preferences of other users can be used in lieu of the requestor having provided an indication by past activity himself or herself on which to base the personalization efforts. The group semantic network used for personalization of a webpage requested by an individual can be the group semantic network for an “affinity group” of the user. Affinity groups are groups of users that have been matched based on some criteria. As example, the semantic network profiles of multiple users who have interacted with a music site can be searched to match up users with similar tastes. This requires that the user have had enough prior activity logged on the system that an affinity group can be matched to the user. As example, an affinity group could be formed consisting of users who each purchased at least one album from either of the groups Lycia or Estraya. Alternatively, an affinity group could be formed of all users who have shown interest in Ragtime or Swing Jazz. If no affinity groups are found for a user, a truly general group semantic network can be used. A general group semantic network is simply a group semantic network that is not specialized for any affinity. The behavior of all of the users to a particular website is used to form the general group semantic network for that business. Normally, the less affinity a group semantic network has to the specific user, the less likely it is that the personalization efforts based on the use of that group semantic network is successful for the user.

Referring to FIG. 13, shown is a flowchart of a simplified method of processing a shadow component.

Shown is a start indicator 1302, a rules execution step 1304, a process code execution step 1306, and a done indicator 1308.

Structurally, the start indicator 1302 continues to the rules execution step 1304, which continues to the process code execution step 1306, which continues to the done indicator 1308.

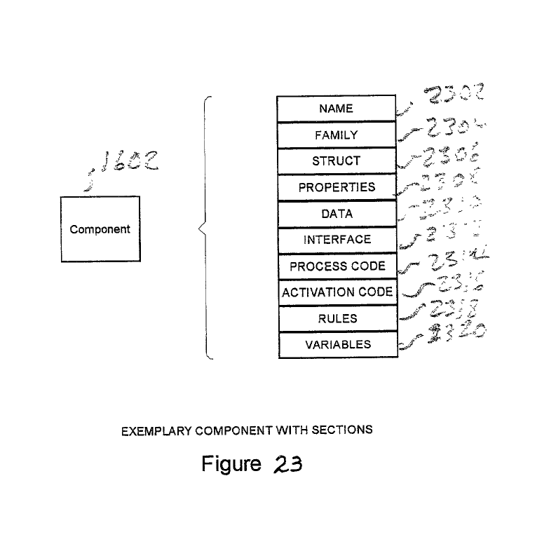

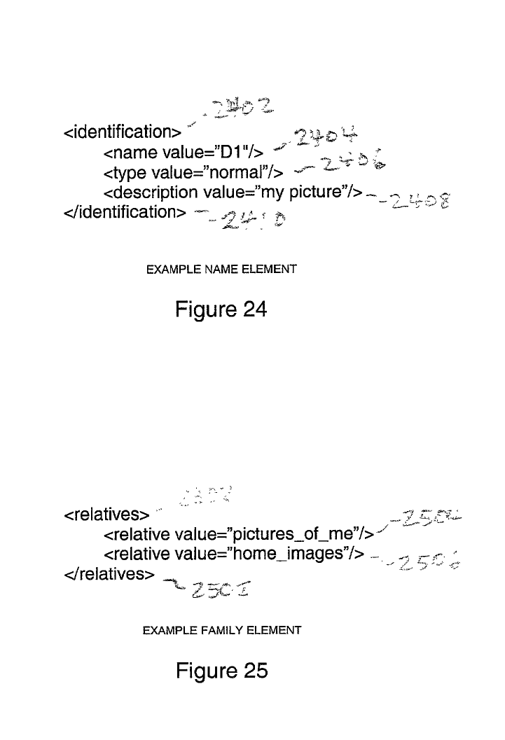

In operation, the component assembly engine 210, during the component loading phase, but before looking into the struct element of a component for children, must first determine whether the component is a shadow component. It does this by reading the component type from the name element of the component after loading. The name section (or element) is discussed in detail later herein in reference to FIG. 24. The elemental makeup of components is discussed in detail later herein in reference to FIG. 23. The name element of a component has at least one entry, the name of the component. The name element may have a second entry, which is an entry indicative that the component is a shadow component. The name element may have third and fourth entries representing a text description and an ASCII encoded binary icon image respectively. The component assembly engine 210, after loading a component, looks into the name element of the component to determine if it is a shadow component. If it is, the component assembly engine 210 partially processes the component by a method such as that of FIG. 13. As shown FIG. 13, the component assembly engine 210 first executes any shadow rules in the rules element of the component at rules execution step 1304, and then executes any shadow code in the process code element of the component at process code execution step 1306. If a component is a shadow component, it will have at least either shadow rules or shadow code and the execution of shadow rules and shadow code results in entries being made in the struct element of the component. A diagram showing this self-modification is given in FIG. 14 which is discussed later herein. After completion of the processing of the shadow rules and shadow code, control returns back to the loading algorithm. In this scenario, the shadow component is now treated identically to a non-shadow component and any children are loaded. Alternatively, a shadow component may replace itself so that when control returns to the loading algorithm, the shadow component has already been replaced by other components. Both of these techniques are shown in detail in FIG. 11 discussed previously herein.

Referring to FIG. 14, shown is internal data modification of a shadow component during processing.

Shown is a shadow component D3 1214, a name element 1404, a family element 1406, a struct element 1408, a properties element 1410, a data element 1412, a interface element 1414, a process code element 1416, a activation code element 1418, a rules element 1420, a variables element 1422, and a rulesset C1S1 1424.

The component D3 1214 is comprised of the elements or sections shown: the name element 1404, the family element 1406, the struct element 1408, the properties element 1410, he data element 1412, the interface element 1414, the process code element 1416, the activation code element 1418, the rules element 1420, and the variables element 1422. An arrow is shown from the rules element 1420 to the struct element 1408. Arrows are shown from the process code element 1416 to each f the following elements: the family element 1406, the struct element 1408, the properties element 1410, the data element 1412, the interface element 1414, the process code element 1416, the activation code element 1418, the rules element, 1420 and the variables element 1422.

An arrow from the rules element 1420 to the struct element 1408 represents the action resulting from shadow rules execution (of rules in the rules element 1420) has on the contents of the struct element 1408.

In operation, shown is the effect that the execution of rules contained in the rules element 1420 has on the contents of the struct element 1408. Specifically, shown is the placement of child component entries into the struct section 1408—namely child component entries D1 808 and E1 810. It is noted that, generally, rules are not actually encoded into the rules element 1420 of a component but are stored in a rules database 1424 and pointers or other identifiers to the appropriate rules or rules sets are placed in the rules element 1420. Thus, in the rules section 1420, is the entry indicating that rulesset C1S1 1424 is to be used.

In operation after the loading of a shadow component, the process code and/or rules elements 1416 and 1420 of the shadow component are executed. With respect to the shadow component, this can have two effects—the shadow component can be replaced, or resolved, with one or more child components, or the shadow component can self-modify through the effects of the execution of the rules or process code sections. This self-modification is shown in FIG. 14 where the effect of executing shadow rules pointed to by the rules section 1420 results in child component entries in the struct section 1408. In this example, two shadow rules are present which read: “If X1 is true, then enter D1 and B1 into struct section” and “If X2 is true, then enter F1 and G1 into struct section”. Rules generally have two parts, the condition and the action. These rules have the conditions X1 and X2 respectively. A condition is what determines if a rule is to be executed. If a condition is true, then the action part of the rule is executed and if the condition is false, then the rule is not executed.

Conditions such as X1 and X2 can involve any information or data available on or to the server on which the component assembly engine 210 resides. This allows shadow rules and shadow code to be very powerful for the purposes of personalization or customization of websites. Information such as requestor identity, past behavior of the requester, demographics of the requester, any promotional programs of the website owner, etc. are very useful criteria able to be tested in the condition sections of shadow rules or code. In the present example, the first rule “If X1 is true, then enter D1 808 and E1 810 into struct section” has the condition “X1” which evaluates to true, so the rule's action of “then enter D1 808 and E1 810 into struct section” is executed. Thus, identifiers for components D1 808 and E1 810 are placed in the struct section 1408 of the shown component. In this example, it may be that the components D1 808 and E1 810 selected for placement in the struct element 1408 might contain coupons for ongoing sales, they might be news articles relating to specific topics of interest to the requestor, etc.

Although only the process code element 1416 is shown able to modify the other elements, it is to be noted that both shadow code in the process code element 1416 and shadow rules in the rules element 1420 each may internally modify any or all of the sections of a component: Family element 1406, struct element 1408, properties element 1410, data element 1412, interface element 1414, process code element 1416, activation code element 1418, rules element 1420, and variables element 1422. Shadow components may also be non-displaying components that serve some other purpose such as to trigger the delivery of an email message with a coupon in it to a given customer.

Arrows from the process code element 1416 to the family element 1406, the struct element 1408, the properties element 1410, the data element 1412, the interface element 1414, the process code element 1416, the activation code element 1418, the rules element 1420, and the variables element 1422 represent the possibility that the execution of shadow code can modify the contents of any of these elements. The shadow code, when executed, acts similar to shadow rules, and is able to enter component identifiers into all the above named elements.

The elemental parts of a standard component are discussed in detail later herein in reference to FIG. 23.

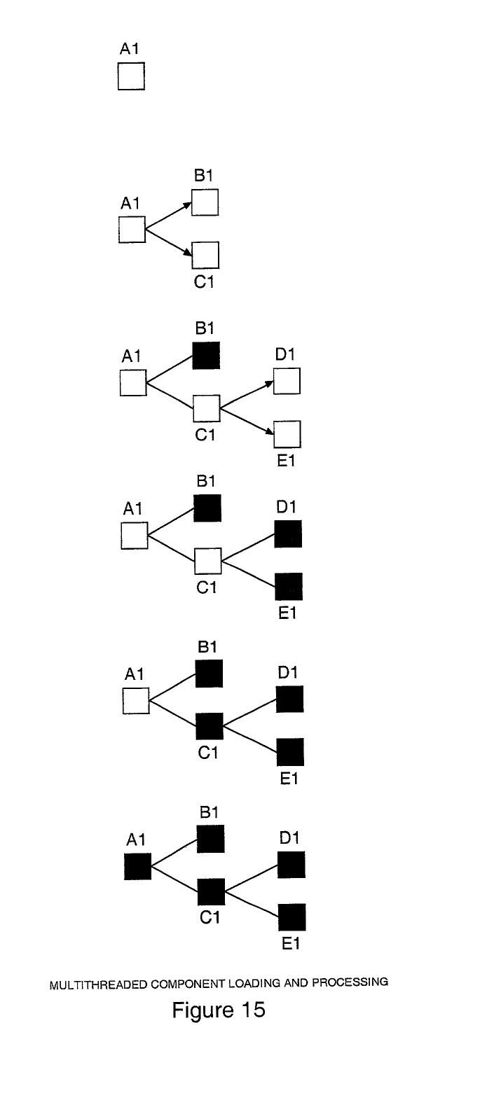

Regarding FIG. 15, shown is a method of multitasking the loading and processing of the components of FIG. 9.

Multitasking the process of loading and processing of components simply means that two or more instantiations of the process of loading and processing components can be simultaneously run. By way of example, component A1 is first loaded. As component A1 has two children, both are loaded in parallel. As the process of loading and processing can continue on each of the child components B1 and C1 independently in parallel, shown is component B1 having been processed while the children of component C1 were being loaded. Because component A1 cannot be processed until the loading and processing of all of component A1's children is finished, the processing of component A1 must wait until component C1 has been processed (since component B1 has finished processing).

Component C1, likewise, must wait for component C1's children, components D1 and E1, are loaded and processed.

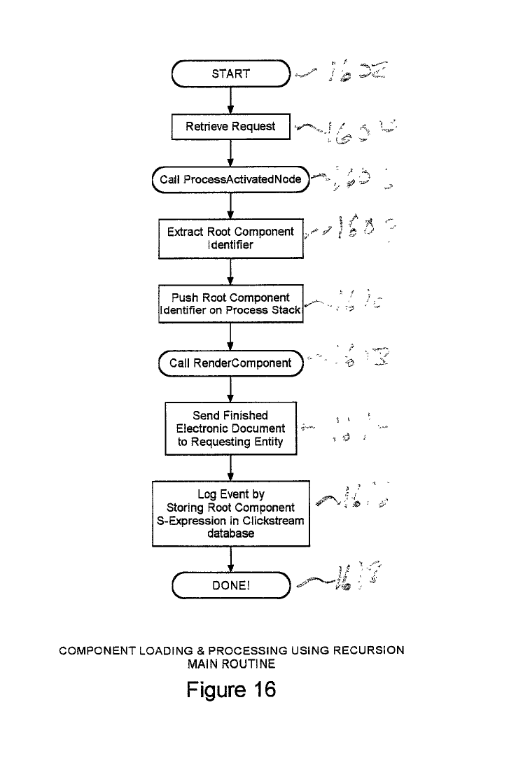

Regarding FIG. 16, shown is an exemplary method of loading and processing components.

Shown is a start indicator 1602, a retrieve request step 1604, a call ProcessActivatedNode step 1606, an extract root component identifier step 1608, a push root component identifier step 1610, a call RenderComponent step 1612, a send results to requester step 1614, a log results send step 1616, and a done indicator 1618.

The Start Indicator 1602 is coupled to the retrieve request step 1604 which is coupled to the call ProcessActivatedNode step 1606 which is coupled to the extract root component identifier step 1608 which is coupled to the push root component identifier step 1610 which is coupled to the call RenderComponent step 1612 which is coupled to the send results to requestor step 1614 which is coupled to the log results send step 1616 which is coupled to the done indicator 1618.

Shown is an exemplary algorithm of loading and processing components. The algorithm shown begins at the start indicator and retrieves a request in the retrieve request step 1604. Next, the activated node is extracted and processed in the call ProcessActivatedNode step 1606 which is described in detail in reference to FIG. 17. The activated node is actually the root component. When a user selects a viewable resource, what is actually selected is a reference to the root component. The activated node is the component that was clicked on by the user in response to the previous display of a component assembled page, the activation code section of this component is executed before the next page related to the click is constructed by the component assembly engine. Next, the identifier for the root component is extracted from the request in the extract root component identifier step 1608. Next, the root component identifier is pushed on the working stack in push root component identifier step 1610. Next, the subroutine or procedure that actually loads and processes one component, RenderComponent, is called in call RenderComponent step 1612. RenderComponent is an exemplary algorithm of the loading & processing routine discussed previously herein in reference to FIG. 10. Next, the finished electronic document is sent to the requesting entity in the send results to requestor step 1614 and this event is then logged in the clickstream database in the log results send step 1616. The routine is thus finished, and this is indicated by the Done indicator 1618.

Procedure RenderComponent is an exemplary embodiment of the loading & processing routine discussed previously herein in reference to FIG. 10. Procedure RenderComponent loads and processes one component. The component that RenderComponent loads and processes is referred to herein as the current component. After loading the current component, RenderComponent analyzes the current component to determine what children components the current component has, and procedure RenderComponent is recursively called for each of these child components. Procedure RenderComponent gathers and produces several outputs. These include output or feedback from the processing of the component and an s-expression expressing the properties of the current component and it's children.

Procedure ProcessActivatedNode is discussed later herein with respect to FIG. 17, and procedure RenderComponent is discussed later herein with respect to FIGS. 18-20.

Regarding FIG. 17, shown is the exemplary routine ProcessActivatedNode that is part of the exemplary method for loading and processing components.

Shown is a start indicator 1702, an extract step 1704, a load step 1706, an execute step 1708, a store step 1710, and an end indicator 1712.

The start indicator continues to the extract step 1704, which continues to the load step 1706. The load step 1706, which continues to the execute step 1708, which continues to the store step 1710. The store step 1710 continues to the end indicator 1712.

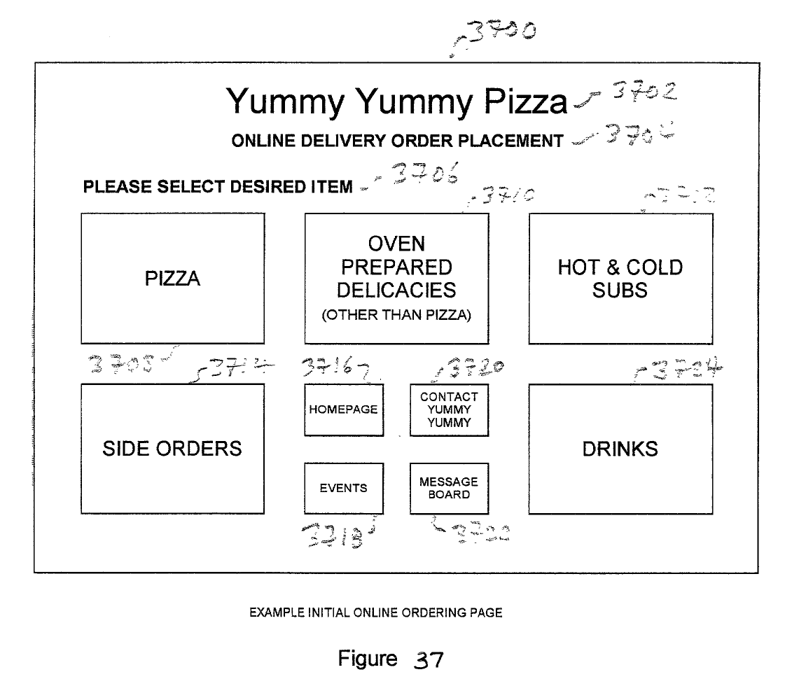

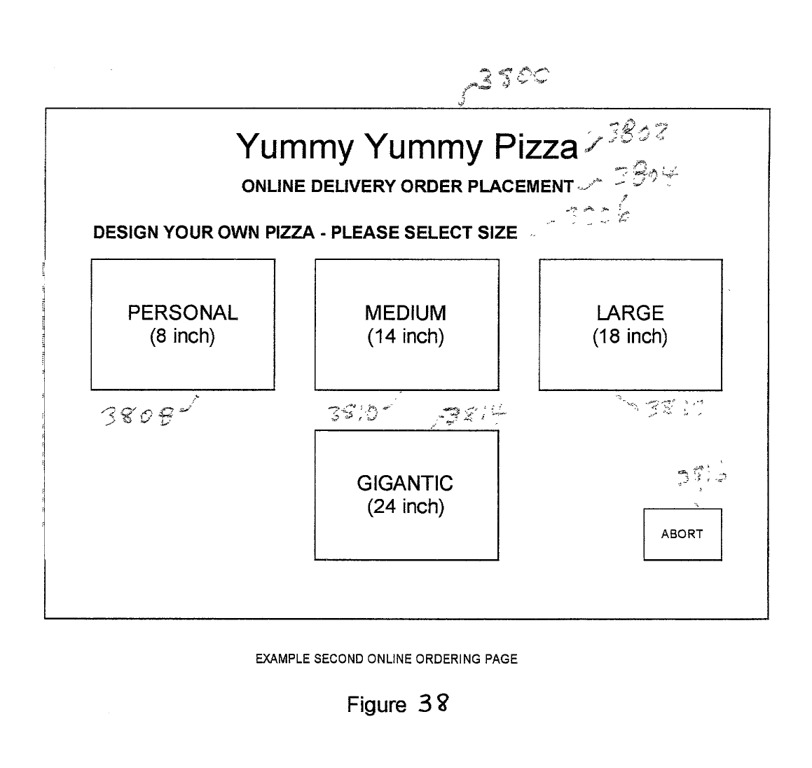

In operation, the algorithm continues from the start indicator to the extract step 1704 where an identifier to an activated node is extracted from the request. An activated node is a component that has been selected (normally by the user clicking on the component) by a user in response to a resource that was presented to the user. An example of this is a user clicking on the pizza button of the webpage shown in FIG. 37. As the pizza button is contained in a component, the clicking of the pizza button results in the component that contains the pizza button being the activated node. Next, at the load step 1706, the activated node identified is loaded. Next, at the execute step 1708, the activation code section of the activated node is executed. Next, at the store step 1710, the name of the activated node is stored in the clickstream database. Next is the end indicator 1712 representing that the algorithm is finished.

Regarding FIG. 18, shown is part 1/3 of an exemplary procedure RenderComponent which is part of the exemplary method for loading and recursively calling RenderComponent for “child” components.

Shown is a start indicator 1802, a pop identifier step 1804, a load component step 1806, a shadow component decision step 1808, a continue A indicator 1810, an Add step 1812, an any children decision step 1814, a continue B indicator 1816, an extract child component identifier step 1818, a push child component identifier step 1820, an any more children decision step 1822, a call RenderComponent step 1824, an any more children decision step 1826, and a continue C indicator 1828.

The start indicator 1802 continues to the pop identifier step 1804, which continues to the load component step 1806. The load component step 1806 continues to the shadow component decision step 1808, which continues, when the loaded component is a shadow component, to the continue A indicator 1810, and, when the loaded component is a normal component, to the add step 1812. The add step 1812 continues to the any children decision step 1814, which continues, when the loaded component does not have any children, to the continue B indicator 1816 and, when the loaded component has children, to the extract child component identifier step 1818. The extract child component identifier step 1818 continues to the push child component identifier step 1820, which continues to the any more children decision step 1822 which continues, when there are unread child entries in the struct section of the loaded component, back to the extract child component identifier step 1818 and, when there are no more unread child entries in the struct section of the loaded component, to the call RenderComponent step 1824. The call RenderComponent step 1824 continues to the any more children decision step 1826, which continues, when RenderComponent was not called for all child components that were previously read, back to the call RenderComponent step 1824 and, when RenderComponent was called for all child components that were previously read, to the continue C indicator 1828.

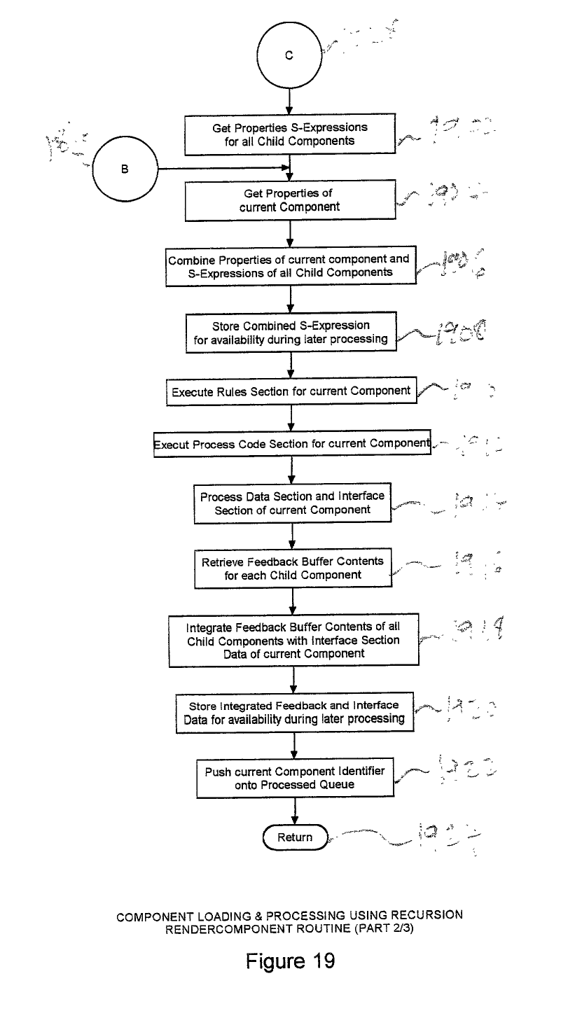

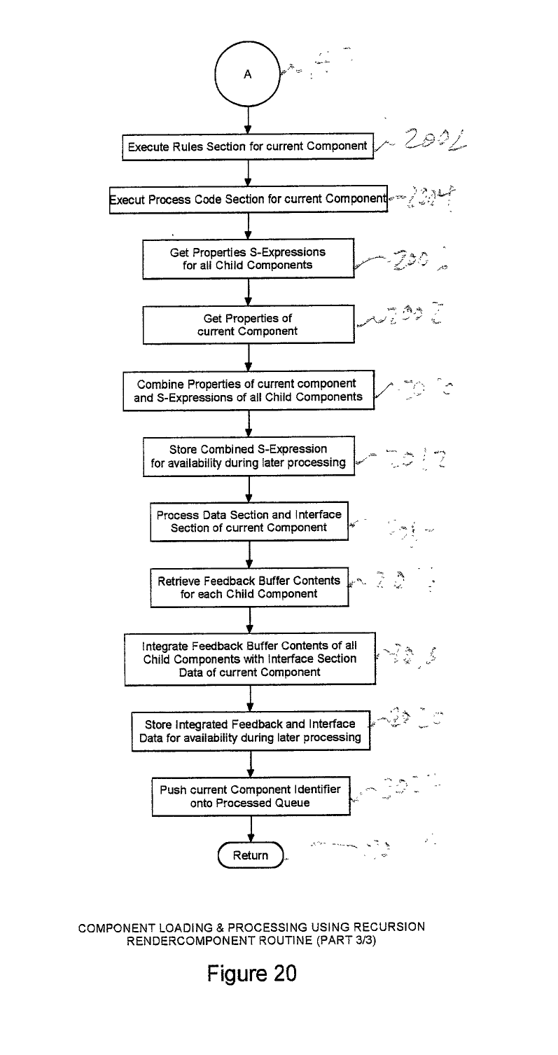

Operationally, this figure shows part 1/3 of a flowchart for the exemplary routine RenderComponent. This routine describes an exemplary method for loading and processing one component of a component hierarchy. RenderComponent begins as shown by the start indicator 1802 and begins by popping a component identifier off of the working stack. The working stack, as discussed previously herein, is a last-in first-out stack, which allows RenderComponent to keep track of which components have not been loaded. The popping of the component identifier occurs at the pop identifier step 1804. It is noted that to differentiate the popped component from it's children, the popped component is referred to as the “current component” during this discussion of RenderComponent. Next, the current component is loaded at the load component step 1806. Next, at the shadow component decision step 1808, it is determined whether the current component is a normal component or a shadow component by analysis of the name element of the current component. A normal component is a component which is not a shadow component. If the current component is determined to be a shadow component, control follows the continue A indicator 1810 which continues joins part 3/3 of routine RenderComponent as shown in FIG. 20. If the current component is a normal component, it is added to the component hierarchy that is being built at the add step 1812. Next, at the any children decision step 1814, the current component is analyzed to determine if it has any children, and if not, control continues thorough continue B indicator 1816 and joins with part 2/3 of RenderComponent as shown in FIG. 19. If the current component has at least one child, then at the extract child component identifier step 1818, a child component identifier is read from the struct section of the current component and it is placed on the working stack at the push child component identifier step 1820. At the any more children decision step 1822, RenderComponent determines whether any further entries for children components exist in the struct section of the current component, and if so, control continues back to the extract child component Identifier step 1818. Otherwise, RenderComponent is recursively called for each child component found in steps 1818-1822, shown here by the loop which includes the call RenderComponent step and the any more children decision step 1826 which returns back to the call RenderComponent step 1824 in the negative, and to the continue C indicator 1828 in the positive. The continue C indicator 1828 links to part 2/3 of RenderComponent as shown in FIG. 19.

Regarding FIG. 19, shown is part 2/3 of the exemplary routine RenderComponent which is part of the exemplary method for loading and processing components.

Shown are a continue C indicator 1828, a continue B indicator 1816, a get child s-expressions step 1902, a get properties step 1904, a combine s-expressions step 1906, a store combined s-expressions step 1908, an Execute Rules Section step 1910, an execute process code step 1912, a process data section and interface section step 1914, a get child feedback output step 1916, a combine feedback output step 1918, a store feedback output step 1920, a push current component on processed queue step 1922, and a return indicator 1924.

The continue C indicator 1828 continues to the get child s-expressions step 1902, which continues to the get properties step 1904, which continues to the combine s-expressions step 1906, which continues to the store combined s-expressions step 1908, which continues to the execute rules section step 1910, which continues to the execute process code step 1912, which continues to the process data section and interface section step 1914, which continues to the get child feedback output step 1916, which continues to the combine feedback output step 1918, which continues to the store feedback output step 1920, which continues to the push current component on processed queue step 1922, which continues to the return indicator 1924. The continue B indicator 1816 continues to the get properties step 1904.

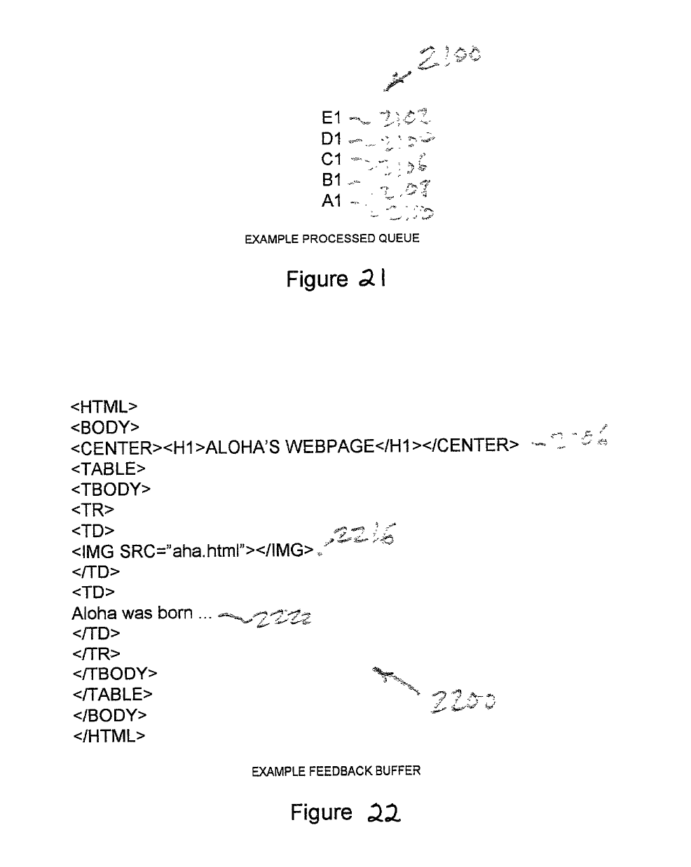

Operationally, control continues from the corresponding continue C indicator 1828 of part 1/3 of RenderComponent as shown in FIG. 18 to the continue C indicator 1828 of FIG. 19. Next, the respective s-expressions, which were built for each of the child components (produced during recursive instantiations of RenderComponent for each of the child components) are gathered (read) from storage at the get child s-expressions step 1902. In the get properties step 1904 the current component's properties are read from the properties element. In the combine s-expressions step 1906, the gathered s-expressions for all the children components and the properties of the current component are formed into a composite s-expression. This composite s-expression is stored for reference and use in later processing in the store combined s-expressions step 1908. Next the rules and process code are executed in the execute rules section step 1910 and the execute process code step 1912, respectively. Next, in the process data section and the interface section step 1914, the data and interface sections are processed to determine the contribution of the current component to the resource, which is being rendered. Next, in the get child feedback output step 1916, the feedback buffer outputs of all the child components of current component are read and these are combined with the results of the process data section and interface section step 1914 in the combine feedback output step 1918 to produce the contribution of the current component and current component's children to the resource being rendered. Next, in the store feedback output step 1920, the output of the combine feedback output step is stored for use in later processing. Next, the identity of the current component is pushed onto the processed queue stack in push current component on processed queue step 1922. The processed queue is a queue which stores a list of the components which have been fully processed and is discussed later herein in reference to FIG. 21. Next, the current instantiation of RenderComponent terminates, which is indicated by the return indicator 1924.

The continue B indicator 1816 shows another entry point for control coming from another part of RenderComponent—in this case control comes from the corresponding continue B indicator 1816 in part 1/3 of RenderComponent shown in FIG. 18.

Regarding FIG. 20, shown is part 3/3 of exemplary routine RenderComponent which is part of an exemplary method for loading and processing components.

Shown are a continue A indicator 1810, an Execute Rules Section step 2002, an execute process Code step 2004, a get child s-expressions step 2006, a get properties step 2008, a combine s-expressions step 2010, a store combined s-expressions step 2012, a Process Data Section and Interface Section step 2014, a get child feedback output step 2016, a Combine Feedback Output step 2018, a Store Feedback Output step 2020, a Push Current Component On Processed Queue step 2022, and a return indicator 2024.

The continue A indicator 1810 continues to the execute rules section step 2002, which continues to the execute process code step 2004, which continues to the get child s-expressions step 2006, which continues to the get properties step 2008, which continues to the combine s-expressions step 2010, which continues to the store combined s-expressions step 2012, which continues to the process data section and interface section step 2014, which continues to the get child feedback output step 2016, which continues to the combine feedback output step 2018, which continues to the store feedback output step 2020, which continues to the push current component on processed queue step 2022, which continues to the return indicator 2024.

Operationally, the routine of FIG. 20 is the corresponding routine for shadow components as compared to the routine of FIG. 19, which is for normal components. The only difference is that the steps of executing the rules contained in the rules element and the process code contained in the process code element are the first two steps for processing shadow components.

Referring to FIG. 21, shown is an example of a processed queue.

Shown is an example of the contents of a processed queue, which lists the entries E1 2102, D1 2104, C1 2106, B1 2108, and A1 2110 each on a separate line.

The processed queue represents one of the outputs of the component assembly engine 210 during the processing phase. As each component is processed, the component's name is entered in the processed queue. The processed queue is necessary to provide the component assembly engine 210 with a place to check which components have been processed. The shown processed queue is an example of what is produced by the component assembly engine 210 during the processing shown in FIG. 15. Before the loading & processing routines which process the component hierarchy as shown in FIG. 15 finish, the loading & processing routines enter the name of the components into the processing queue. Thus, the entries in the processed queue are the reverse of the loading order of the components and therefore, the processed queue begins with E1 810 and ends with A1 802. After a given component's children have been processed (if the component has any) and the component has been executed, the component's name is placed in the “processed queue”. This structure is not generally used except when debugging component trees, because when a component crashes the tree, it is easy to see which one it was if the processed queue at each step is printed in a debugging log.

Referring to FIG. 22, shown is an example of a feedback buffer 614.

Shown is what amounts to simple HTML output contained in the feedback buffer 614 after the entire component tree of FIGS. 8 and 9 was processed by the order as shown in FIG. 15. Basically, this HTML code provides a header tag entry (in line 2206) which when executed produces a header reading “Aloha's Webpage” and a table tag entry which when executed produces a table having two side-by-side areas with the picture image “aha.html” on the left and the text area with contents “Aloha was born . . . ” on the right.

In operation, the component E1 810's output was the text “Aloha was born . . . ”, the component D1 808's output was the image statement including “aha.html”, the component C1 806's output formatted the outputs of Components E1 810 and D1 808 into a table so that they would display side-by-side, the component B1's output was the heading statement of “Aloha's webpage”, and the component A1 802's output combined the outputs of the components B1 804 and C1 806 such that the output of the component C1 806 displays below that of the output of the component B1 804.

Referring to FIG. 23, shown is an exemplary component and the sections it can have.

Note that the terms element and section are used interchangeably herein to describe the parts of a component.

Shown is a component 1602, a name element 1604, a family element 1606, a struct element 1608, a properties element 1610, a data element 1612, an interface element 1614, a process code element 1616, an activation code element 1618, a rules element 1620, a variables element 1622, and a rules database 1624.

Only the name element 1604 must have an entry, and all other elements may have empty contents. The minimum set of elements which must have content for a component to have and produce visible output is the set consisting of the name element 1604 and the interface element 1614. It is noted that the present invention permits for more types of elements and is not limited in scope to those elements disclosed. For example, it has been found helpful during debugging to include in the component structure an icon element controlling icon display.

Referring to FIG. 24, shown is an example of a name element.

Shown are 5 lines, 2402, 2404, 2406, 2408, 2410, of code reading:

<identification>

<name value=“D1”/>
<type value=“normal”/>
<description value=“my picture”/>

</identification>

Also referred to as the “identification element”, the name element of a component stores the name of the component. The name of a component is used by the component assembly engine 210 and stored in both the working stack and the processed queue during the loading and processing of component hierarchies. Shown the example of this figure is the name element for component D1 808 of the webpage shown in FIG. 7, which is the component which contains the girl's image. The tag represented by “<identification>” and “<identification>” define the start and end of the name element. The 2^{nd} to 4^{th} lines define the component D1 808's name as “D1”, value as “normal”, and description as “my picture”. A component's name is the name by which the component is identified. A component's type may either be “normal” for non-shadow components, or “preexecute” for shadow components (also referred to as “preexecute components” or “preex components”). A component's description is for the benefit of humans and thus should be a human language coded comment, which explains or describes the component.

Referring to FIG. 25, shown is an example of a family element.

Shown are 4 lines of code, 2502, 2504, 2506, 2508, reading:

<relatives>

<relative value=“pictures_of_me”/>
<relative value=“home_images”/>

</relatives>

Also called “relatives element” or “concept family element”, the family element stores family affiliations of a component. Family affiliations are entries, which define a group of components. Components are grouped into a family affiliation when they have something in common. An example of a family affiliation is a group of images, which show favorite toys of a child. The family affiliation of a component is useful during personalization because the family affiliation can be used to define a group of objects from which a subset is selected for incorporation into a viewable resource being constructed.

Shown is an example of a family element for component D1 808 of the webpage shown in FIG. 7, which is the component, which contains the image of the girl named Aloha. The tag defining the start and end of the family element consists of the “<relatives>” and “</relatives>”, lines 2502 and 2508, respectively. The 2^{nd} line 2504 reading “<relative value=” pictures_of_me”>” defines a family (also called concept family or relatives) of component D1 808 as “pictures_of_me”. This means that all components defined having the family “pictures_of_me” are grouped because these components have something in common, in this case, likely all will contain pictures of Aloha. Components can be members of more than one concept family, thus in this example, the 3^{rd} line 2506 reading “<relative value=”home_images”/>” identifies component D1 808 as also a member of the concept family “home_images”.

Referring to FIG. 26, shown is an example of a struct element.

Shown are 5 lines of code, 2602, 2604, 2606, 2608, 2610, reading:

<struct>

<reference value=“D1”/>
<reference value=“E1”/>
<reference value=“this”/>

</struct>

The struct section 2308 of a component 2302 contains the information which identifies all of the child components the component 2302 has. This example shows the struct section 2308 of the component C1 806 of FIGS. 8-9. The entries of lines 2604 and 2606 specify the child components D1 and E1, respectively. In addition, in this example, line 2608 which reads “<reference value=”this”/>” is a line which identifies that content information (i.e. information which is output by the component—likely viewable content) will be produced from the component C1 806 itself. The order of the entries in the struct section 2309 are determinative of the order in which the outputs indicated by the entries are combined. Thus, by way of example, if the component C1 806 generated output that was to go between the outputs of component D1 and component E1, then a line similar to 2608 is inserted between the lines 2604 and 2606.

The Struct section also includes a server name where the component is to be found and processed It is an optional addition to the element for supporting distributed component processing, and if it is not found on any given line in the struct section, it is assumed that the component will be found and processed on the “current machine”.

Referring to FIG. 27, shown is an example of a properties element.

Shown are 4 lines of code, 2702, 2704, 2706, 2708, reading:

<properties>

<property name=“pizza” value=”1.0”/>
<property name=“hot food” value=“1.0”/>

</properties>

The properties element of a component stores the properties of the component. The properties of a component relate generally to the purpose of the component. As example, in FIG. 37 is shown a pizza button. This pizza button is contained within a component and has the properties “pizza, 1.0”, “hotfood, 0.8”. These properties are entered in the properties section of the component as shown in lines 2704 and 2706. Properties are useful to keep track of because if a user clicks on the pizza button of FIG. 37, it is known that the user was presented something having the properties of pizza, 1.0 and hot food, 1.0 and that in response the user selected this component thus indicating the user has some interest in pizza (value 1.0) and hot food (value 1.0).

Generally speaking, however, the properties are more granular than this: cheese, tomato sauce, thin-crust. Granularity is important to doing effective analysis of behavior.

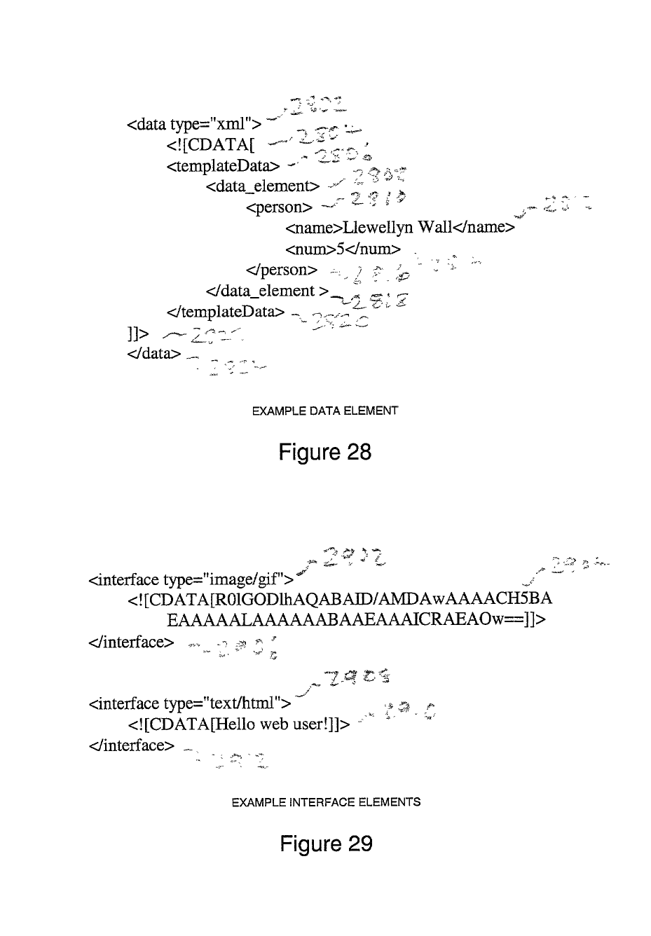

Referring to FIG. 28, shown is an example of a data element.

Shown are 12 lines of code, 2802, 2804, 2806, 2808, 2810, 2812, 2814, 2816, 2818, 2820, 2822, 2824, reading:

2822, 2824, reading:

<data type=“xml”>

<![CDATA[
<templateData>

<data_element>

<person>
<name>Llewellyn Wall</name>
<num>5</num>
</person>

</data_element>

</templateData>
]]>

</data>

The data section is generally used to store data that is to be processed in some fashion before being presented to the user. In some cases, this data may never be presented to the user, but only used to facilitate some background process.

The data is commonly stored in XML format, but can take other forms as well. Encoded binary data can be stored, as mentioned above, and this section can also contain a “pointer” to the data section of another component.

Examples of data could be, but are not limited to: a table of information stored in XML format, a block of text, a binary image, a binary data file such as a excel spreadsheet file, a comma or tab delimited database file.

Often data and interface (from the interface section) come together to form some output. XML data from the data section and XML information from the interface section can be merged to form some resulting output.

The content of a data element can include any data format such as text or binary information.

Referring to FIG. 29, shown are two examples of a interface element.

Shown are two examples of interface element definitions, the first definition consisting of 3 lines of code, 2902, 2904, 2906. It is noted that what is herein printed as two lines between the “<interface . . . ” and “</interface>” tags is one line of code. The three lines of code read:

<interface type=“image/gif”>

<![CDATA[R01GOD1hAQABAID/AMDAwAAAACH5BA

EAAAAALAAAAAABAAEAAAICRAEAOw==]]>

</interface>

and the second definition consisting of 3 lines of code, 2908, 2910, 2912, reading:

<interface type=“text/html”>

<![CDATA[Hello web user!]]>

</interface>

The interface section is used to store some information or data that is to be presented to the user. This information may be text (ASCII) or binary based. Examples could be but are not limited to: text based information like HTML, XML, WAP, and scalable vector graphics (SVG) animations, as well as binary information in the form of FLASH files, image files, sound files, movies, and other forms of media.

Interface ultimately gets concatenated with interface from and children that a component has, in the order found in the “struct” of the given component. If the component's struct contains the following:

<struct>

<reference value=“this”/>
<reference value=“componentA”/>
<reference value=“componentB”/>

</struct>

then the component assembly engine 210 will take the interface for the current component and then append the interface from its child “componentA” and then append the interface from its child “componentB” the order of the “references” will change the order of appends.

An example of an interface section with an image embedded is shown in the top definition of FIG. 29. An example of an interface section with a text string to be printed to the user is shown in the bottom definition in FIG. 29.

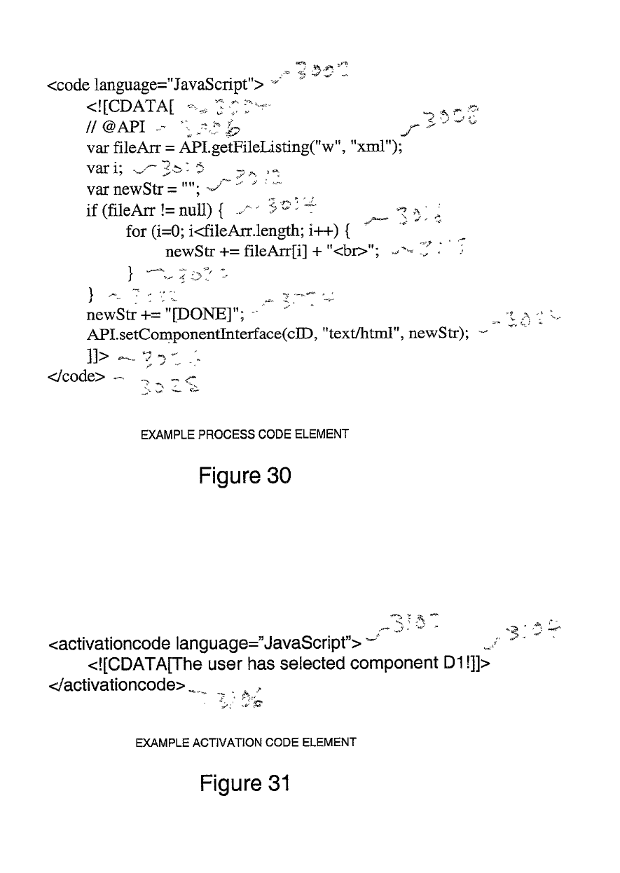

Referring to FIG. 30, shown is an example of a process code element.

Shown are 15 lines of code, 1502, 1504, 1506, 1508, 1510, 1512, 1514, 1516, 1518, 1520, 1522, 1524, 1526, 1528, 1530, reading:

<code language=“JavaScript”>

<![CDATA[
// @API
var fileArr = API.getFileListing(“w”, “xml”);
var i;
var newStr =“”
if (fileArr !=null) {

for (i=0; i<fileArr.length; i++) {

newStr += fileArr[i] + “<br>”;

}

}
newStr += “[DONE]”;
API.setComponentInterface(cID, “text/html”, newStr);
]]>

</code>

The code section is used to store program code that is to be executed when the component is processed. This section will typically contain but is not limited to interpreted scripting code, such as JavaScript, and could also contain binary code such as Java or compiled Visual Basic code.

The component assembly engine 210 calls this code during the component execution phase when the component is being processed for display. As mentioned before, this code can result in information being placed in one or more of the other sections of a component.

Code here can also perform a variety of different functions: storing data in a database or retrieving it, sending email, calculating and processing data for a personalization task, generating a random response, or determining in the case of “shadow” or “pre-execute” components what the children of the given component are to be, on the fly.

Referring to FIG. 31, shown is an example of a activation code section.

Shown are 3 lines of code, 3102, 3104, 3106, reading:

<activationcode language=“JavaScript”>

<![CDATA[The user has selected component D1!]]>

<activationcode>

Similar to the process code section, the activation code section can store ASCII and binary code. The activation code section is not called during the execution phase of a component tree however. Activation code is called in response to a user “clicking” or otherwise selecting information that was presented to the user. As an example if a page resulting from a number of components is presented to the user, when the user clicks on a link of that page that resides in the interface element of a given component, the activation code of that given component is executed in a step that precedes the processing of the next component tree for that user.

By way of an example, the activation code shown in this figure is in the activation code element of component D1 808, and when a user selects or clicks on component D1 808, then the message “The user has selected component D1!” is printed.

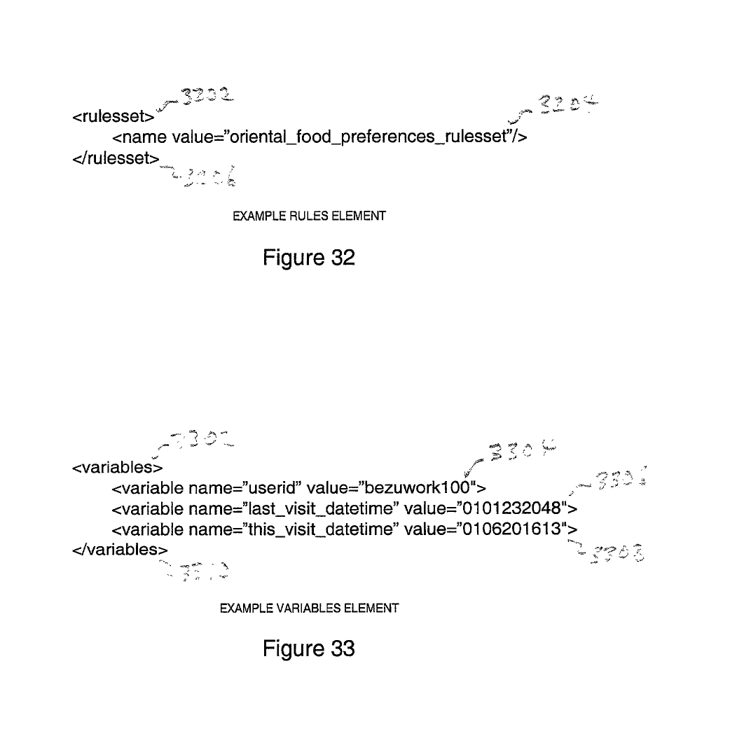

Referring to FIG. 32, shown is an example of a rules element.

Shown are 3 lines of code, 3202, 3204, 3206, reading:

<rulesset>

<name value=“oriental_food_preferences_rulesset”/>

</rulesset>

In line 3204, the reference to “oriental_food_preferences_rulesset” tells the component assembly engine 210 to use the oriental_food_preferences_rulesset for rules execution.

Referring to FIG. 33, shown is an example of a variables element.

Shown are 5 lines of code reading:

<variables>

<variable name=“userid” value=“bezuwork100”>
<variable name=“last_visit_datetime” value=“0101232048”>
<variable name=“this_visit_datetime” value=“0106201613”>

</variables>

This element contains global variables. Components can set variables in this section and other components in the component hierarchy has access to this variable space

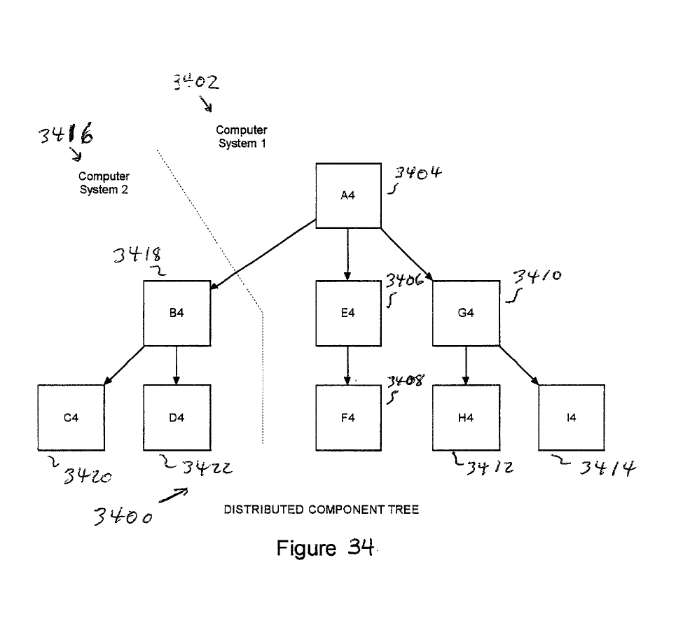

Referring to FIG. 34, shown is an example of a distributed component tree 3400.

Shown are components A4 3404, B4 3418, C4 3420, D4 3422, E4 3406, F4 3408, G4 3410, H4 3412, I4 3414, a computer system 1 3402, and a computer system 2 3416.

The component A4 3404 is coupled to the components B4 3418, E4 3406, and G4 3410. The component B4 3418 is coupled to the components C4 3420 and E4 3406. The component E4 is coupled to the component F4. The component G4 3410 is coupled to the components H4 3412 and I4 3414. The components B4 3418, C4 3420, and E4 3406 are shown residing on the computer system 2 3416 while the other components are shown residing on the computer system 1 3402.

Operationally, the components A4 3404, E4 3406, F4, 3408 G4 3410, H4 3412, I4 3414 reside on computer system 1 3402 and the components B4 3418, C4 3420, and E4 3406 reside on computer system 2 3416. Thus, the child reference to the component B4 3418, which is in the struct element of the component A4 3404, is a remote network-based reference. As discussed previously herein, the struct section entries contain an optional addition to the element for supporting distributed component processing which is an Uniform Resource Identifier (URI), also referred to as a “remote network-based reference” that contains the web location of the server that will process the given component. A remote network-based reference is a reference from a component on one computer hardware device to a component on a second computer hardware device where both computer hardware devices are connected to the same network. Because the children of the component B4 3418 reside on the same system as the component B4 3418 does, the references to them contained within the component B4 3418 are relative since they reference addresses within the same computer system.

Operationally, during the loading phase, the component assembly engine 210 on computer system 1 3402, when it reaches the child component reference to B4 3418, must send a communication over the network to the component assembly engine 210 on the computer system 2 and hand off the processing of the component B4 3418 and the descendants of component B4 3418. The component assembly engine 210 on the computer system 2 3416 thus spawns a loading & processing routine instantiation for the component B4 3418 which loads and processes the component B4 3418 based subhierarchy. A subhierarchy is a component hierarchy tree which is a subset of a larger tree, here component B4 3418 and component B4 3418's descendants form one possible subhierarchy of the larger tree which has component A4 3404 as the root component. After fully processing the subhierarchy, which has component B4 3418 as root component, the component assembly engine 210 on the computer system 2 3416 sends the results back to the component assembly engine 210 residing on the computer system 1 3402.

As returned from computer system 2 3416, the “results” may consist of the component feedback, component properties, and other data, including but not limited to the top-level component in the sub-hierarchy (in this case, component B4 3418).

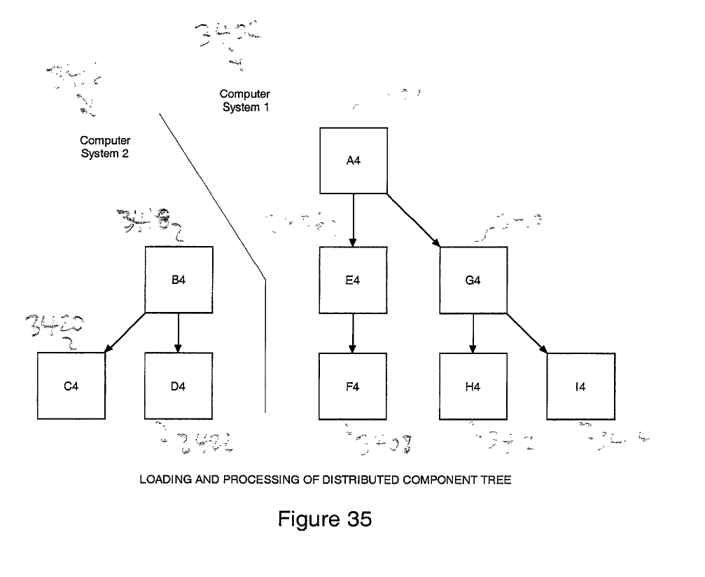

Referring to FIG. 35, shown is an example of loading and processing orders of the distributed component hierarchy 3400 of FIG. 34. Shown are components A4 3404, B4 3418, C4 3420, D4 3422, E4 3406, F4 3408, G4 3410, H4 3412, I4 3414, a computer system 1 3402, and a computer system 2 3416.

The component A4 3404 is coupled to the components E4 3406, and G4 3410. The component E4 3406 is coupled to the component F4 3408. The component G4 3410 is coupled to the components H4 3412 and I4 3414. The component B4 3418 is coupled to the components C4 3420 and D4 3422. The components B4 3418, C4 3420, and D4 3422 are shown residing on the computer system 2 3416 while the other components are shown residing on the computer system 1 3402.

The component assembly engine 210, during the loading phase, begins with the root component A4 3404. When analyzing the component A4 3404 to determine the children components of the component A4 3404, the component assembly engine 210 in a preferred embodiment, will spawn a new thread for each descendant component instantiation of the loading & processing routine. Thus, when remote reference to child component B4 3418 is read, the component assembly engine 210 will send an appropriate message to the computer system 2 (hereafter server 2) 3416 and a component assembly engine 210 resident on server 2 3416 will carry out the loading and processing phases for component B4 3418 and the descendants of component B4 3418 resident on server 2 3416. Thus, the component B4 3418, with respect to server 2 3416, is treated as a root component (sometimes referred to as a “local root component”). Thus, all of the loading and processing of component B4 3418 and descendants is first completed and then the resultant contents of the feedback buffer and properties buffer for component B4 3418 are sent to computer system 1 3402. Thereafter, the feedback buffer contents and properties of component B4 3418 is available for completion of the processing of the rest of the component hierarchy tree resident on computer system 1 3402.

In multi-threaded processing of component hierarchies, a thread is spawned only for leaf nodes. Otherwise the machine could quickly become jammed with resource consuming threads. This scheme could only be used for pages with very few components. This approach generally would be not taken with multithreaded models with component trees with over a thousand nodes, as it is not feasible in those circumstances. If a list (or likely stack) of currently uncovered leaf nodes is maintained, any number of designated threads can be assigned to work on them. By way of example, a 4 processor machine will allow any given instance of the component assembly engine on the machine to use 4 threads (which in typical implementation would be distributed over the 4 processors) to multiprocess any number of children uncovered.

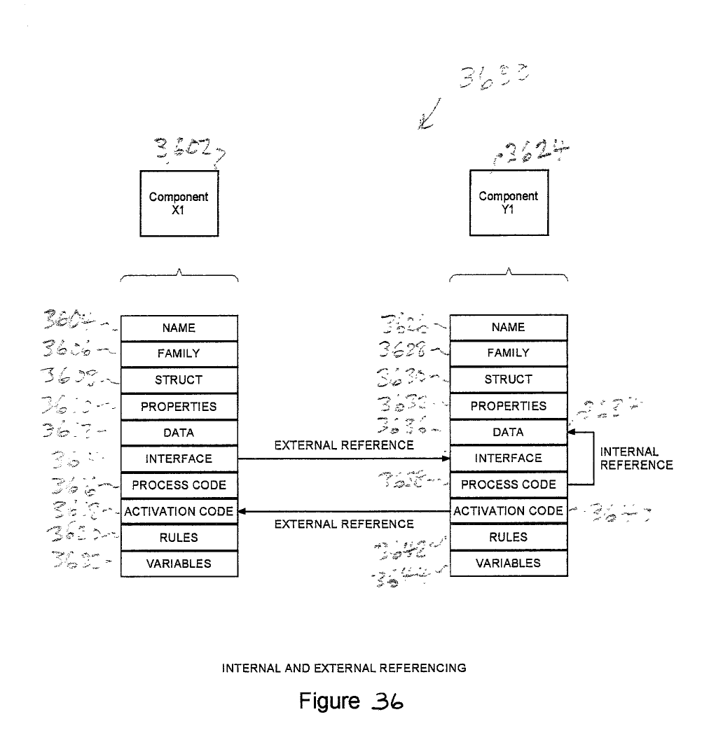

Referring to FIG. 36, shown is an example of component sections internally and externally referencing other sections.

Shown is a component X1 3602, elements of component X1 3602, namely: a name element 3604, a family element 3606, a struct element 3608, a properties element 3610, a data element 3612, an interface element 3614, a process code element 3616, an activation code element 3618, a rules element 3620, and a variables element 3622, a component Y1 3624, and elements of component Y1 3624, namely: a name element 3626, a family element 3628, a struct element 3630, a properties element 3632, a data element 3634, an interface element 3636, a process code element 3638, an activation code element 3640, a rules element 3642, and a variables element 3644.

The interface element of component X1 3602 is shown with an arrow pointing to the interface element 3636 of the component Y1 3624, the process code element 3638 of the component Y1 3624 is shown with an arrow pointing to the data element of the component Y1 3624, and the activation code element 3640 of the component Y1 3624 is shown with an arrow pointing to the activation code element 3618 of component X1 3602.

Operationally, any element is able to contain content, but alternatively, as shown here, elements may contain pointers or references to other elements, which instruct the component assembly engine 210 to follow the reference and utilize the code or data of the referenced element during the execution or processing of the referencer element. A referencer element is an element which contains a pointer referencing another element. In this example, when processing the component X1 3602, the component assembly engine 210, when it needs to process the interface element 3614 of the component X1 3602 will use the interface data of the component Y1 3624. This is an external reference as the element referenced is contained in another component. Similarly, the component assembly engine 210 will use the activation code of the component X1 3602 when required during the processing of the activation code element 3640 of the component Y1 3624 due to the external reference from the activation code element 3640 of the component Y1 3624 to the activation code contained in the activation code element 3618 of the component X1 3602. A reference is called a cross reference when it references a different type of element. External references may be cross-references.

There is no such thing as an internal reference. Component code or rules can change the data in any section of the same component, but this is not a “reference” or a pointer. A pointer must point to an external document, and looks like this:

<data type“xml”>

<extpointer name=“componentC” section=“data”/>

</data>

This is an example of a data section that points to another component, componentC, and uses componentC's data section to fill its own. Note: this happens at component load time. Also note that componentC does not have to be anywhere in the current component tree for this to work. Also note that extpointer nodes have an optional parameter, “in memory” which has a true or false value and denotes whether the section is read from the pristine copy from the component cache (or database) or whether it reads from a copy already read and possibly self-modified in memory. Components also cannot borrow the name section from another component.

It is noted that the above referencing was discussed in the arena of the processing phase, but it is also available for shadow components during the processing that takes place within the context of the loading phase, i.e. the rules element or the process code element of shadow components may contain internal or external references within the shadow rules or shadow code.

Referring to FIGS. 37, shown is an exemplary initial webpage during an online pizza ordering session.

Shown is a webpage 3700 having a header 3702 reading “Yummy Yummy Pizza”, a subheading 3704 reading “Online Delivery Order Placement”, an instructional text 3706 reading “Please select . . . ”, a Pizza button 3708, an oven prepared delicacies button 3710, a hot & cold subs button 3712, a side orders button 3714, a homepage button 3716, an events button 3720, a contact Yummy Yummy button 3718, a message board button 3722, and a drinks button 3724.

The webpage 3700 has the header 3702 reading “Yummy Yummy Pizza”. Underneath that is the subheading 3704 reading “Online Delivery Order Placement”. Under that is an instructional text 3706 reading “Please select . . . ”. Next lower is a horizontal row of three buttons: the pizza button 3708, the oven prepared delicacies button 3710, and the hot & cold subs button 3712. In the next lower horizontal row is: on the left is the side orders button 3714, in the upper left corner of the middle section is the homepage button 3716, in the lower left corner of the middle section is the events button 3720, in the upper right corner of the middle section is the contact Yummy Yummy button 3718, in the lower left corner of the middle section is the Message board button 3722, and on the right is the drinks button 3724.

Operationally, in this example, a customer interested in online placement of a food order at Yummy Yummy Pizza is presented with the webpage of FIG. 37. In response, the customer would click on the button, which indicates what he or she wishes to order. In the present example, the customer clicked on the pizza button, and was then presented with the webpage of FIG. 38.

In a preferred embodiment, each button is contained within a separate component. In this way, properties represented by the buttons, which are of interest to the business could be incorporated in the component representation by placing the properties in the properties element of the component. Thus, as an example, the component which contains the pizza button might have the following properties in it's properties element: pizza, value “is a”, 1.0; hotfood, value “is a”, 1.0. Thus, the system knows that the button formed by that component is a pizza and is a hot food.

Referring to FIGS. 38, shown is an exemplary second webpage during an online pizza ordering session.

Shown is a webpage 3800, a header 3802 reading “Yummy Yummy Pizza”, a subheading 3804 reading “Online Delivery Order Placement”, an instructional text 3806 reading “Design your own pizza . . . ”, a personal button 3808, a medium button 3810, a large button 3812, a gigantic button 3814, and an abort button 3816.

The webpage 3800 has the header 3802 reading “Yummy Yummy Pizza”. Underneath that is the subheading 3804 reading “Online Delivery Order Placement”. Underneath that is the instructional text 3806 reading “Design your own pizza . . . ”. Under that is a horizontal row of three buttons which are: on the left, the personal button 3808, the medium button 3810, and on the right, the large button 3812. Underneath that is a horizontal row having in the middle the gigantic button 3814, and on the right the abort button 3816.

Operationally, after selecting the pizza button when presented with the webpage of FIG. 37, the customer is presented with the webpage of FIG. 34 which requests a pizza size selection. In the present example, the customer selects gigantic by clicking on the gigantic button.

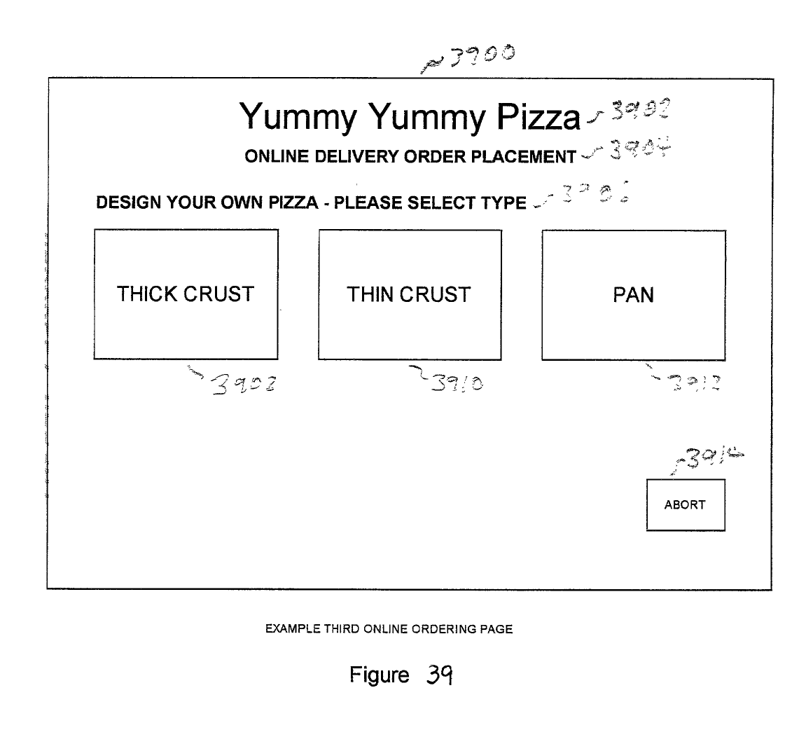

Referring to FIGS. 39, shown is an exemplary third webpage during an online pizza ordering session.

Shown is a webpage 3900, a header 3902 reading “Yummy Yummy Pizza”, a subheading 3904 reading “Online Delivery Order Placement”, an instructional text 3906 reading “Design your own pizza . . . ”, a thick crust button 3908, a thin crust button 3910, a pan button 3912, and an abort button 3914.

The webpage 3900 contains the header 3902 reading “Yummy Yummy Pizza”. Underneath that is the subheading 3904 reading “Online Delivery Order Placement”. Underneath that is the instructional text 3906 reading “Design your own pizza . . . ”. Underneath that is a horizontal row of three buttons having, on the left, the thick crust button 3908, in the middle, the thin crust button 3910, and on the right the pan button 3912. Underneath that row, on the right is the abort button 3914.

Operationally, after selecting the gigantic button 3814 when presented with the webpage 3800 of FIG. 38, the customer is presented with the webpage 3900 of FIG. 39 which requests a pizza crust type selection. In the present example, the customer selects thick by clicking on the thick button 3908.

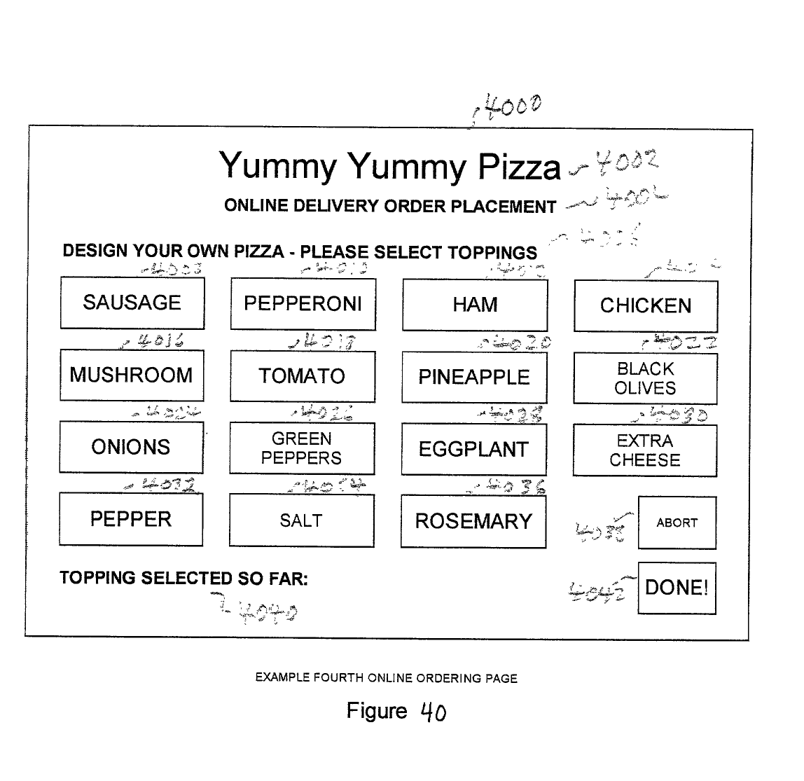

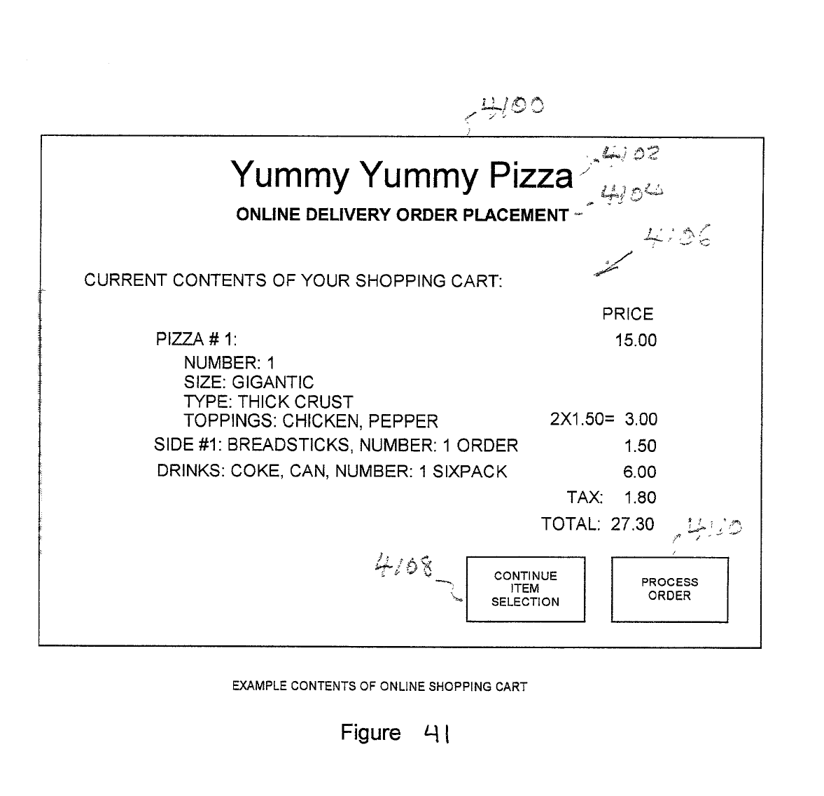

Referring to FIGS. 40, shown is an exemplary fourth webpage during an online pizza ordering session.

Shown is a webpage 4000, a header 4002 reading “Yummy Yummy Pizza”, a subheading 4004 reading “Online Delivery Order Placement”, an instructional text 4006 reading “Design your own pizza . . . ”, a sausage button 4008, a pepperoni button 4010, a ham button 4012, a chicken button 4014, a mushroom button 4016, a tomato button 4018, a pineapple button 4020, a black olives button 4022, an onions button 4024, a green peppers button 4026, an eggplant button 4028, an extra cheese button 4030, a pepper button 4032, a salt button 4034, a rosemary button 4036, an abort button 4038, a done! button 4038, and a feedback area 4040 reading “Toppings selected so far:”.

The webpage 4000 contains the header 4002 reading “Yummy Yummy Pizza”, under which is the subheading 4004 reading “Online Delivery Order Placement”. Underneath that is the instructional text 4006 reading “Design your own pizza . . . ”. Under that is a horizontal row of 4 buttons which are, from left to right, the sausage button 4008, the pepperoni button 4010, the ham button 4012, and the chicken button 4014. Under that is another horizontal row of 4 buttons which are, from left to right, the mushroom button 4016, the tomato button 4018, the pineapple button 4020, and the black olives button 4022. Under that is a third horizontal row of 4 buttons which are, from left to right, the onions button 4024, the green peppers button 4026, the eggplant button 4028, and the extra cheese button 4030. Under that is a fourth horizontal row of 4 buttons which are, from left to right, the pepper button 4032, the salt button 4034, the rosemary button 4036, and the abort button 4038. Below that is a horizontal row with, on the right, the Done! button 4038, and, on the left, the feedback area 4040 reading “Toppings selected so far:”.

Operationally, when constructed according to a preferred embodiment, each button of FIG. 40 is contained within a separate component, and thus is given properties commensurate with the topping represented. Thus, the properties element of the component for the sausage button may contain the following properties: sausage, value “is a”, 1.0; meatiness, value “flavor”, 1.0.

After selecting the gigantic button when presented with the webpage of FIG. 39, the customer is presented with the webpage of FIG. 40, which requests a topping selection. In the present example, the customer selects chicken by clicking on the chicken button. The customer is then presented with a webpage substantially similar to that of FIG. 40, except that in the feedback area the prior selection of chicken is listed. In response to this, the customer then selects pepper as a topping and is again presented with the same webpage with the Feedback area listing both chicken and pepper as toppings. In response to this, the customer finishes by clicking on the Done! button 4038.

Referring to FIG. 41, shown is the contents of a user shopping cart.

Shown is a webpage 4100, a header 4102 “Yummy Yummy Pizza”, a subheading 4104 reading “Online Delivery Order Placement”, a text area 4106 beginning “Current contents of your shopping cart: . . . ”, a continue item selection button 4108, and a process order button 4110.

Operationally, this webpage shows the results of the customers activity on the Yummy Yummy Pizza website during the online pizza ordering session shown in FIGS. 36-40. Specifically, by his or her actions, the customer has chosen one gigantic, thick crust pizza with chicken and pepper as toppings, one order of breadsticks, and 1 sixpack of Coke.

Timestamp should also be mentioned here and in the diagram as I mentioned on the phone. A timestamp looks like this:

01/03/2001 23:04:00.000

or

milliseconds since Jan. 1, 1970, 00:00:00 GMT

Referring to FIG. 42, shown is an example of the form of the contents of the clickstream database without properties.

Shown are an entry 4202 reading “(A1 (B1) (C1 (D1) (E1)))” and an entry 4204 reading “(D1)”.

Shown, in order to explain s-expressions in more detail, are the contents of a clickstream database without user id, timestamp, or properties. As example, the first entry reading “(A1 (B1) (C1 (D1) (E1))” is the s-expression form of the component hierarchy of FIGS. 8-9. A component is represented by the component's name within parentheses, such as “(A1)”. If a component has children components, the s-expressions for the children are inserted after the component name of the parent but before the closing parenthesis. Thus, the parent component C1 806 (with beginning s-expression “(C1)”), which has children components D1 808 (with s-expression “(D1)”) and E1 810 (with s-expression “(E1)”), really has the s-expression “(C1 (D1) (E1))”. The second entry shown in FIG. 42 is the entry for the user's response “(D1)”, which indicates that when presented with the webpage of FIG. 7, the user clicked on component D1 808.

Referring to FIG. 43, shown is an example of the form of the contents of the clickstream database with properties.

Shown are 12 entries 4302, 4304, 4306, 4308, 4312, 4314, 4316, 4318, 4320, 4322, 4324, 4326, in a clickstream database.

Structurally, each entry begins on a new line and later entries are listed below the previous entry.

In operation, the clickstream database records entries for webpages served to users and also what components users click on in response. The I/O processor 208 does this logging. As requests come in from various users on the network, the I/O processor 208 will create new entries in the clickstream/context chain database 502 for each requestor. As constructed for this example, the webpage of FIG. 37 was built with 16 components, i.e. the components YA1 through ZQ1. The component YA1 is the container for the whole page, the component YB1 contains the header and subheader, the component YC1 contains the instructional entry, the component YD1 is a container component containing the first row of buttons, the component YE1 contains the pizza button, and so forth. In this example, the component YE1 contains entries for the following properties in it's properties element: pizza, value is a, 1.0; hotfood, value is a, 1.0. Ideally, all of the components with a clickable nature would have some properties associated with them as this is one of the advantages of the present invention—the recording and tracking of user behavior which is made more valuable when the user's behavior is referenced to the nature and properties of what is being clicked on. The 1st entry 4302 in the clickstream database which reads “(user id=bezuwork100 (YA1 (YB1) (YC1) (YD1 (YE1 810, pizza=1.0, hotfood=1.0) (YF1, hotfood=1.0, bakedness=1.0) (YG1, subs=1.0, breadness=0.3, sandwich=1.0)) (YH1 (YI1, sideorder=1.0) (YJ1 (YK1 (YL1, homepage=1.0) (YM1, email=1.0)) (YN1 (YO1, events=1.0) (YP1, messagebd=1.0))) (YQ1, drink=1.0))))” thus represents a user whose id is “bezuwork100” and who received a webpage having the s-expression which follows the user id. This s-expression is one possible s-expression for the webpage of FIG. 37. The 2^{nd} entry 4304 in this example, reading “(user id=bezuwork100 (YE1))”, represents the user bezuwork100's response to the webpage shown in FIG. 37.

In this example, the customer clicked on the pizza button, thus the 3rd entry 4306 in the clickstream database, representing the s-expression for the webpage of FIG. 38, reads “(YA2 (YB2 ) (YC2 ) (YD2 (YE2, small=1.0) (YF2, medium=1.0) (YG2, large=1.0)) (YH2 (YI2) (YJ2, extra large=1.0) (YK2, abort=1.0)))”. The 4^{th} entry 4308, reading “(YJ2)”, represents the customer's response.

The 5th entry 4310 reading “(user id=bezuwork100 (YA3 (YB3) (YC3) (YD3 (YE3, chewy=0.9, thickness=0.6) (YF3, crispy=0.8, thinness=0.7) (YG3, fillingness=0.9)) (YH3, abort=1.0)))” and the 6^{th} entry 4312 reading “(user id=bezuwork100 (YE3))” represent the serving of the webpage 3900 of FIG. 39 and the customer's response (selection of thick crust), respectively.

The 7th and 8th entries, 4314 and 4316, represent the serving of the webpage 4000 of FIG. 40 and the customer's response (selection of chicken as a topping), respectively. Similarly, the 9th and 10th and 11th and 12th entries, 4318, 4320, 4322, and 4324, respectively, are in response to the serving of webpages substantially similar to that of FIG. 40 and the customer's selection of pepper as a topping and then the Done button, respectively.

It is to be noted that FIG. 43 for simplicity of discussion omitted timestamps, but in a preferred embodiment, timestamps would form a part of the content stored in the clickstream database.

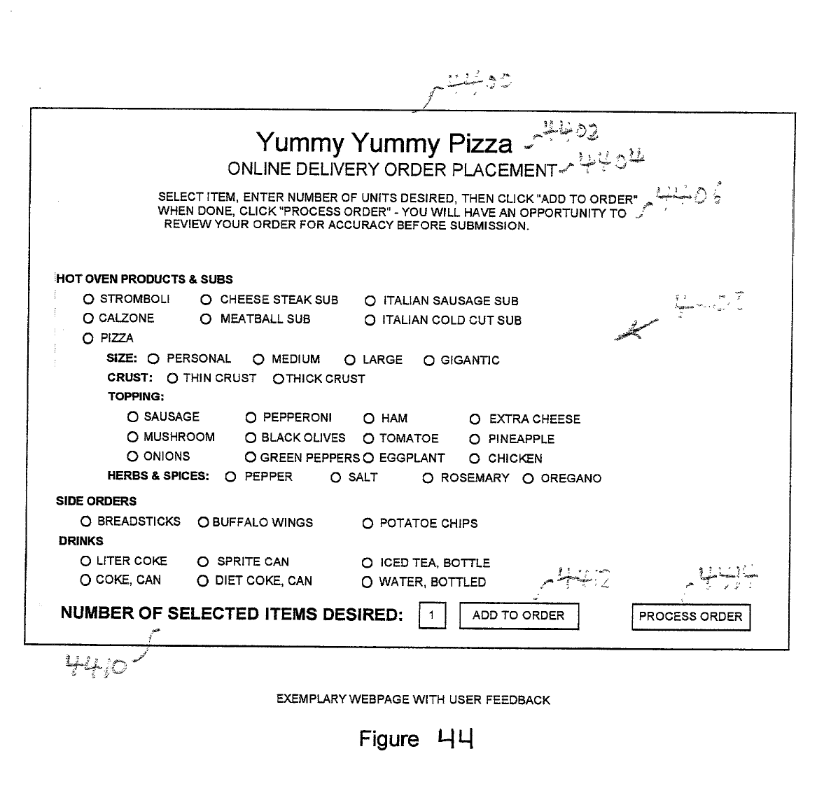

Referring to FIG. 44, shown is an exemplary webpage requesting user feedback.

Shown is an exemplary webpage 4400 having a header 4402 having business name reading “Yummy Yummy Pizza”, a webpage purpose header 4404 reading “Online Delivery Order Placement”, an instruction area 4406 which begins “Select item, . . . ”, an item selection area 4408 beginning with “Hot Oven Products & Subs . . . ”, a number of selected items area 4410 with number entry, an add to order button 4412, and a process order button 4414.

Operationally, this webpage is an alternative way to implement the Yummy Yummy Pizza online ordering website and contrasts with FIGS. 37-40. On this style of page, the user is presented with a form and is required to fill in at least some part of it in order to proceed in placing an online order. In this example, the customer is asked to make a selection and then click on the Add To Order button after which the customer is again presented with the webpage in order to make another selection. This webpage also has an area for text entry in the box just after the phrase “Number of selected items desired:”. When done, the customer clicks on the process order button and is then presented with the shopping cart page of FIG. 41.

With form pages such as this, the present invention is implemented differently than as previously described. Specifically, with forms such as radio button forms (where the user can only select one of a preset group of items—shown in FIG. 44 as the selections beside the phrase “size:”—i.e. a pizza can only be one size—e.g. only one selection of the group personal, medium, large, and gigantic is possible), or free selection forms (where the user may select or “check” as many items as desired—here shown by example as the topping selection area after the phrase “topping:”)—the component makeup of the webpage may not be able to have properties associated in the same way as described before. If radio button forms or pulldown menu forms are contained within only one component, then the component cannot have alternative properties associated with it for each of the different selection capabilities presented to the user.

Even if they are in separate components, the selection of these radio buttons does not necessarily trigger another round of communication between the web page and the server. In this case, the server may only know that the “add to order” button was selected because the rest of the selections happen only on the client side. The invention can not really be used on pages of this type. What would be captured in the clickstream database is exactly what was presented on the page (properties of a whole lot of food items).

If one were to attempt to implement form pages, special code would be written to convert form variables passed on the query string (or otherwise) to properties which would then be saved in the individual's clickstream database. This code would most likely be placed in the activation code section of the “add to order” component] We should consider eliminating this example. There are other problems with the diagram, it is unlikely that E1 would be clickable because its internals do not seem to represent hyperlinks or submit buttons, and I am unsure of what makes up E2. We would also need to remove the properties from the response lines, and move them to separate, additional webpage lines. In other words, the system would have to simulate having shown the items selected on a separate page, although one was not generated.

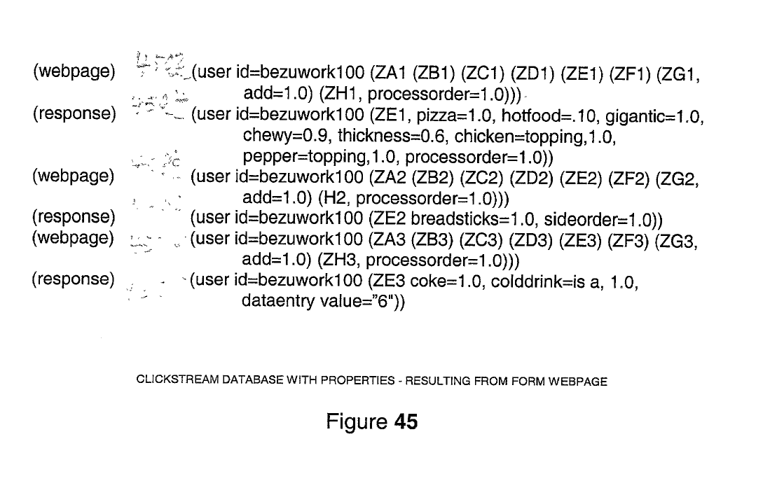

The effect this has on the clickstream database is shown in FIG. 45.

Regarding FIG. 45, shown is an example of the contents of the clickstream database after interaction with a webpage, which contained user feedback.

Shown are example contents for a clickstream database 4500 containing 6 entries 4502, 4504, 4506, 4508, 4510, 4512.

Each entry begins on a new line. In this figure, at left are listed the comments “(webpage)” or “(response)”. These items are not a part of the clickstream database's contents but are presented as an aid to description.

The first line 4502 marked by the comment “(webpage)” is the s-expression for the webpage of FIG. 44. Note that this s-expression represents a very sparse creation of the webpage of FIG. 44 and a multitude of other constructions are possible. In this rendition, component ZE1 represents the component, which contains the entire user response form of FIG. 44—i.e. the entire pizza ordering form. No properties are shown for component ZE1 as the user is able to click on any number of entities within component ZE1 that he or she wants, and it is impossible to know beforehand which ones the customer will select. Components ZG1 and ZH1 do have properties, however, because their properties are predeterminate—just like the components of FIGS. 33-36 were. Entry 2 4504 shows the customer's response. By this response, the customer has selected the gigantic, thick crust pizza with chicken and pepper toppings as was done in the example shown in FIGS. 37-40. Because this was done by a user form rather than by successive drill down surfing, the system must retain this information by sending this data with the user's response. Thus, entry 2 4504 includes the properties specific to the selected subentities within component ZE1. Thus, entry 2 in the clickstream database of FIG. 45 incorporates the same data that of entries 2, 4, 6, 8, and 10 in the clickstream database of FIG. 43. Similarly, entries 3 and 4 of FIG. 45 show the representation of the webpage content of FIG. 44 and the customer's selection of breadsticks. Entries 5 and 6 of FIG. 45 show the presentation of the webpage content of FIG. 44 yet again and the user selection of a sixpack of Coke. Referring to FIG. 46, shown is an exemplary implementation of a personalization profile represented by a personal semantic network note that this is only one possible representation. Another useful representation is one that has nodes with their own “attributes”, as well as nodes that represent categories and sub-categories.

Shown are a semantic network 4600, a coke node 4602, a cold drink node 4606, a meaty node 4610, an evening node 4612, a hot food node 4616, a pizza node 4618, a chicken node 4620, a cheesy node 4626, a peppery node 4628, a breadsticks node 4630, a special options node 4634, and 6 empty nodes 4604, 4608, 4614, 4622, 4624, 4632.

Structurally, the pizza node 4618 is coupled to the following nodes by an arrow pointing away from the pizza node: the hot food node 4616 (with value “is a”, 1.0), the chicken node 4620 (with value “topping”, 1.0), the cheesy node 4626 (with value “flavor”, 0.8), the peppery node 4628 (with value “flavor”, 0.5), the meaty node 4610 (with value “flavor”, 0.7), the evening node 4612 (with value “time of day”, 1.0). The pizza node 4618 is coupled to the following nodes by a bidirectional arrow: the Coke node 4602 (with value goes with, 1.0), the breadsticks node 4630 (with value “goes with”, 1.0). The Coke node 4602 is also coupled by an arrow pointing way from it with the following: the cold drink node 4606 (with value “is a”, 1.0), the meaty node 4610 (with value “goes with”, 1.0), the peppery node 4628 (with value “goes with”, 1.0), cheesy node 4626 (with value “goes with”, 1.0). The Coke node 4602 is also coupled with a bidirectional arrow to the breadsticks node 4630 (with value “goes with”, 1.0). The breadsticks node 4630 is coupled by an arrow pointing away from it to the evening node 4612 (with value “time of day”, 1.0). The special options node 4634 and the empty nodes are not coupled to any other nodes.

As a preferred embodiment, bidirectional links would not be used. Under this embodiment, therefore the bidirectional link between coke and breadsticks would be instead implemented as two unidirectional links.

Operationally, the arrows represent relationships and can have tags and weights. Tags describe the nature of the relationship and the weights indicate the strength of the relationship and usually have a predetermined range. In a preferred embodiment, weight values would vary within the range of 0 to 1.0 with 1.0 indicating the strongest relationship. Thus, the arrow between pizza node 4618 and hot food node 4616 has the tag “is a” (indicating pizza is a hot food) and the weight 1.0. Arrows can also be unidirectional or bidirectional, but in general they are unidirectional. Arrows can be bidirectional in order to save memory and be visually less complicated, but they are generally only applicable if the tag of the arrow applies both ways (e.g. an “is a” tag generally is accurate only in one direction) and if the weights are the same for both directions. For example, pizza and coke may be ordered together indicating that the pizza node and the Coke node 4602 should have links in both directions for “goes with”. If they initially are purchased together, the links in both directions would have a weight of 1.0, thus the link could be represented as bidirectional. But if coke is later purchased with Ethiopian food, then the link from Coke node 4602 to the pizza node 4618 would drop below 1.0 because coke had been ordered without pizza. However, until pizza was ordered without Coke, the link from the pizza node 4618 to the Coke node 4602 would still be weighted 1.0 as Coke had always been purchased when pizza was purchased. There are also several different kinds of links, Boolean relation is an example. A Boolean relation is a link with no “weight”.

There can also be Range relations, that have a predefined range of values.

The semantic network in FIG. 46 is a personal semantic network or semantic network profile (SNP) because it was created for an identifiable customer. It is to be noted that the semantic network profile depicted in FIG. 46 is the result of only one website interaction, thus the large number of 1.0 weights assigned within the semantic network (SN). As the customer returns to the same website on other occasions or to other sites which have a business exchange agreement with Yummy Yummy Pizza, the semantic network profile of the customer becomes more mature as the customer's actions in each subsequent visit is incorporated into the semantic network profile. For example, if the customer returns and orders pizza, Coke, and hot wings, this would result in new links of “goes with” being created for the pizza node 4618 and the Coke node 4602 to a new node for hot wings. The strength of the link between the breadsticks node 4630 and both the pizza node 4618 and the Coke node 4602 would then be reduced in strength from 1.0 to something lower because the customer does not always purchase breadsticks with either pizza or Coke.

As website browsing occurs, the component assembly engine 210 can update semantic network profiles, but often it should be better to collect the clickstream data and update the Semantic network profiles later by action of the daemon server.

There are many algorithms used in determining which links to create and how to engage in modifying them with subsequent data which are old in the art, and any such known algorithm can be used in implementation of the present invention. However, it is anticipated that various businesses would have proprietary rules, which would implement the addition of new nodes and links or the modification of existing nodes and links.

Genetic algorithms may be used to modify these links, and the networks as a whole because personalization is accomplished using the clickstream database, rules and most importantly the semantic network database, changing links and values in the semantic network database will have a direct effect on how pages are personalized. The semantic network database represents a neural network like data structure that can be used as such and which can also be modified using genetic algorithms. The software is designed to allow “experiments” to be performed by having an automated software-based “manager” change weights and then monitor the resulting behavior of a given set of users by monitoring their entries in the context/clickstream database. It is noted that this database represents what was displayed to a user and how they reacted. This allows the present invention to provide a much more powerful means of optimizing interaction between a web site and users that pre-existing technologies.

For illustrative purposes and as a preferred embodiment, an algorithm for combining a user's behavior with a group semantic network is to produce a multiplier to control the amount of the user's behavior, which affects the group semantic network. In operation, the user's behavior, logged in a clickstream database, is formed into a semantic network profile for that session. The links from that semantic network profile would then be added to the corresponding links in the group semantic network by the following formula:

W_{gsnl}=m×Wₛₙₚₗ

where:

m=multiplier

W_{gsnl}=weight of group semantic network link

Wₛₙₚₗ=weight of corresponding semantic network profile link

wherein the multiplier is within the range defined by 0 and 1 (generally, such multipliers are <<1).

Of course, if the group semantic network does not have a corresponding link to one in the semantic network profile, then one is created with a weight of 0, and this weight is used in the above formula.

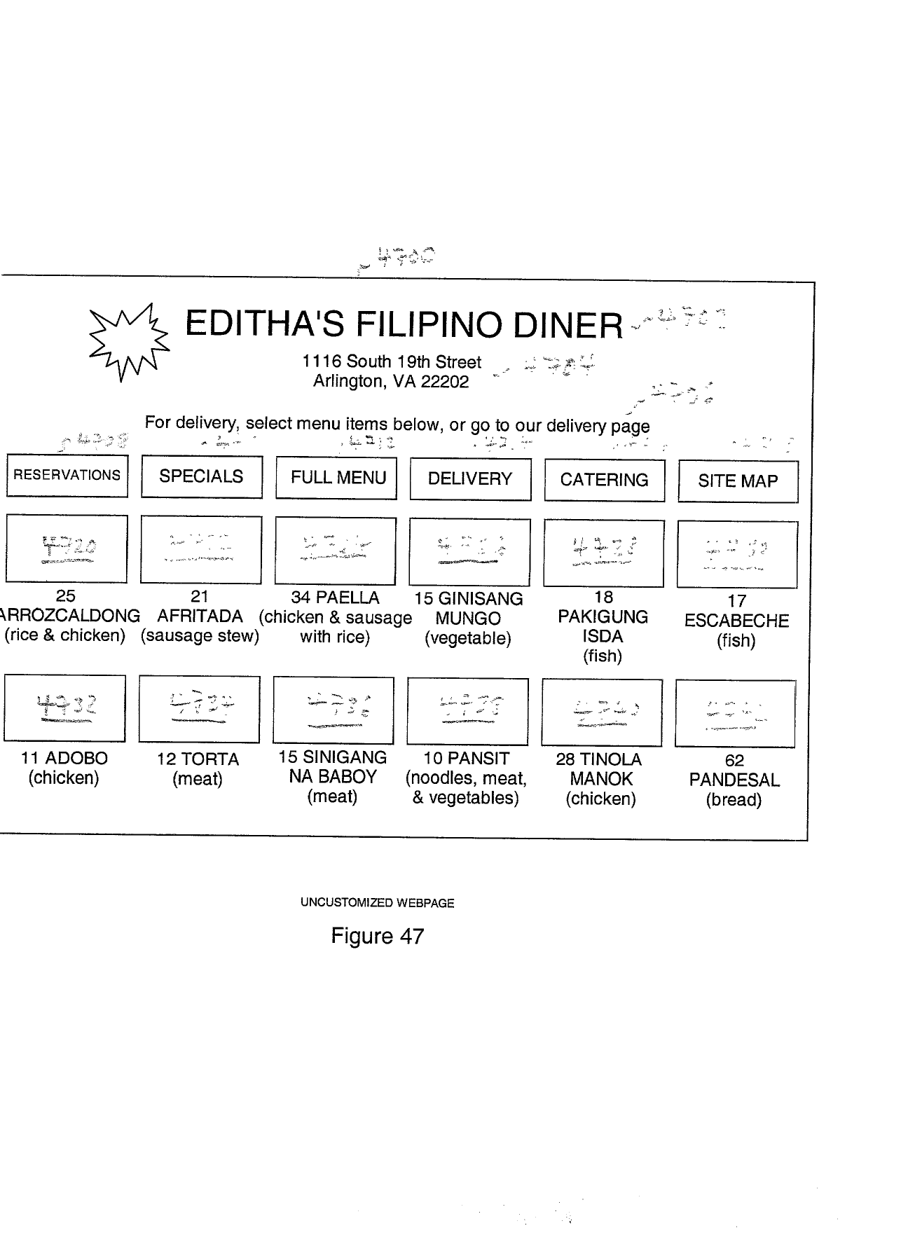

Referring to FIG. 47, shown is an exemplary webpage without customization.

Shown are a webpage 4700, a heading 4702 reading “Editha's Filipino Diner”, a text area 4704 reading “1116 South 19^{th} . . . ”, a text area 4706 reading “For delivery, . . . ”, a reservation button 4708, a specials button 4710, a full menu button 4712, a delivery button 4714, a catering button 4716, a site map button 4718, and 12 food item buttons, namely: Arrozcaldong 4720, Afritada 4722, Paella 4724, Ginisang Mungo 4726, Pakigung Isda 2728, Escabeche 2730, Adobo 4732, Torta 4734, Sinigang Na Baboy 4736, Pansit 4738, Tinola Manok 4740, and Pandesol 4742.

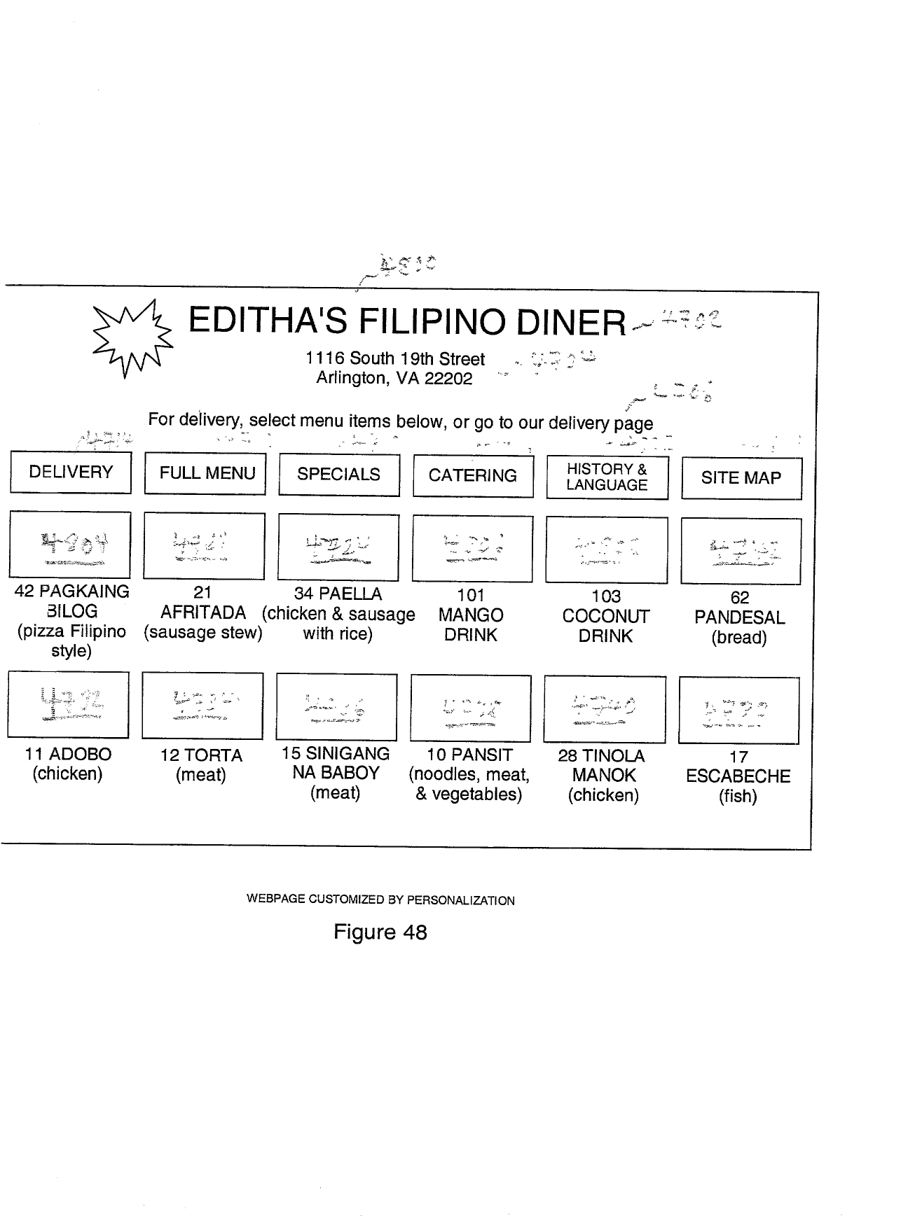

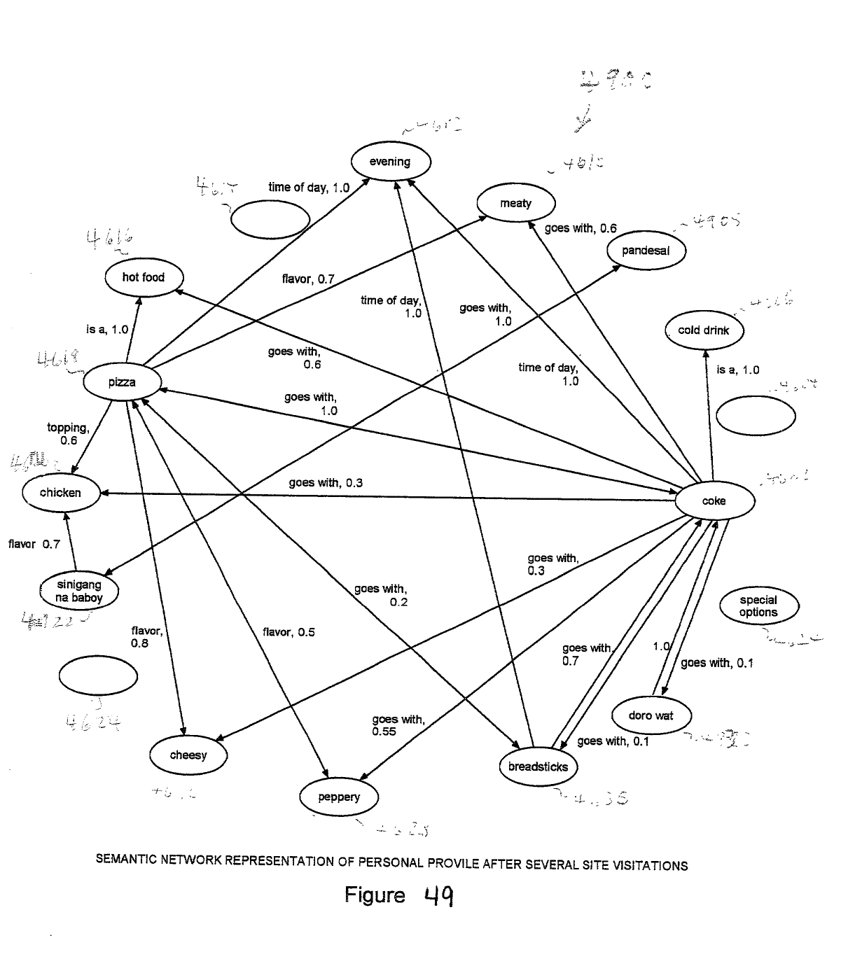

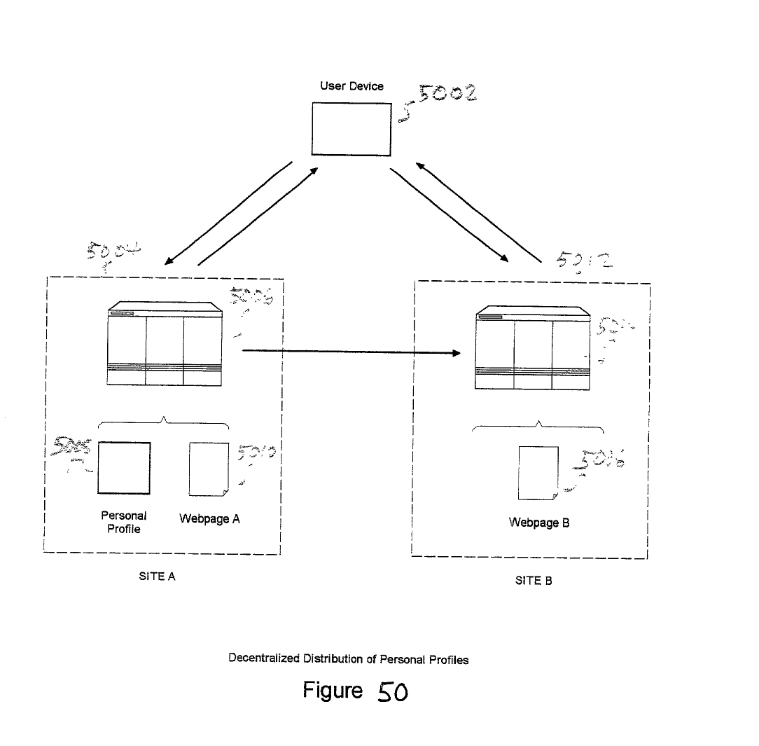

Referring to FIG. 48, shown is an exemplary webpage customized through personalization.

Shown is a webpage 4800 having a heading 4802 reading “Editha's Filipino Diner”, a text area 4804 reading “1116 South 19^{th} . . . ”, a text Area 4706 reading “For delivery, . . . ”, a delivery button, a full menu button 4712, a Specials button 4802, a catering button 4716, a history & language button 4804, a site map button 4718, and 12 food item buttons, namely: Pagkaing Bilog 4804, Afritada 4722, Paella 4724, mango drink 4806, coconut drink 4808, Pandesal 4742, Adobo 4732, Torta 4734, Sinigang Na Baboy 4736, Pansit 4738, Tinola Manok 4740, and Escabeche 4730.

Operationally, this webpage is identical in form to that of FIG. 47, however, the identities of many of the buttons have changed or been switched around. One of the advantages of the present invention is the ease and ability to implement personalization by customizing form, design, and content. In the present example, it so happens that Editha's Filipino Diner has a business exchange agreement with Yummy Yummy Pizza under which both businesses agree to share all customer behavior and demographic information. Thus, after the customer made an initial purchase at Yummy Yummy Pizza, this information, in the form of the semantic network profile for that customer, was made available to Editha's Filipino Diner. And so, Editha's Filipino Diner was in a position to proactively modify it's website in attempts at providing the customer with a website specifically designed to maximize the likelihood that the customer makes a purchase.

In the present example, since the customer had previously purchased pizza having chicken and pepper as toppings, breadsticks, and coke, the personalization which results during the component assembly engine 210's building of the webpage includes rearrangement of the 6 navigation buttons near the top of the page, and rearrangement, additions, and deletions to the 12 food item buttons presented to the customer. Specifically, because the customer had previously ordered delivery, the delivery button is moved from 4^{th} place from the left to the leftmost position so that the customer knows at first glance that delivery of food is an option. The full menu button 4712 is moved to 2^{nd} place from the left as it is inferred that the user may be unfamiliar with Philippine food and, is not known to ever have purchased from Editha's Filipino Diner before. The decision to remove the reservations button may have been in response to evidence mined from the general semantic network (GSN) maintained by Editha's Filipino Diner that customers arriving at the site for the first time who are known purchasers from Yummy Yummy Pizza just happen to never make reservations. A general semantic network or group semantic network (GSN) is a semantic network for a group of customers, not as individuals. It may be that Yummy Yummy Pizza and Editha's Filipino Diner also have an information exchange agreement with Mally's Carribean Cafe and it may be such that a percentage of customers who have eaten at Mally's or perhaps who have eaten certain entrees at Lee's have made reservations during the first visit to Editha's Filipino Diner's webpage. If so, these customers are presented with the reservations button. It is also possible that Editha's and Yummy Yummy have agreements with local hotels and thus if a customer comes to either of their sites who is known to live in another state, Editha's and Yummy Yummy's webpages could be customized to have coupons for the local hotels in the anticipation that the user was researching places to eat in anticipation of a visit. Note that in place of the reservations button 4708, a history & language button 4802 has been added. This is in response to the analysis carried out by the rules executed by the component assembly engine 210 which decides that it is likely that the customer is unfamiliar with the Philippines or Filipino food, and thus a direct link to various pages of history, language, and whatnot is provided by the history & language button 4802.

As the customer had previously ordered pizza, breadsticks (a bready tasting item), and coke, the webpage of Editha's Filipino Diner also makes several personalizations to the food items listed. The first item presented is Pagkaing Bilog (literally “round food”) 4804 which is a non-traditional food item Editha's has created in attempts to introduce Filipino food to Americans unfamiliar to the cuisine. Afritada 4722 and Paella 4724 are listed next as being meaty in response to the customer's having chosen chicken as a pizza topping. Next are presented mango drink 4806 and coconut drink 4808, two items which are normally not be presented on the initial menu page as the initial page is too valuable for presenting main entrees or specials (at least for repeat customers). But since it is likely that the new customer is not familiar with Filipino food, but is known to purchase cold drinks with orders, these two drinks have been added. Similarly, Pandesal 4742 has been moved to the top row, being a bread. Normally this is a food for early in the day and would probably be analogous to a side order, but Americans would have no such restrictions, so the website is personalized to present this item to the customer in hopes of getting a purchase.

There are several techniques used in making semantic network profile data available to other websites which are discussed in detail later herein. The techniques vary from the use of a centralized semantic network profile server which provides the information in real time to distributed storage of semantic network profiles where semantic network profiles are distributed, generally not in real time, to each of the website owners who have such information exchange agreements.

Note that FIG. 47 and 48 show a navigation bar that changes in response to interaction by the user. It is more likely that a site would have a static navigation bar that does not change, and then supplement it with a navigation bar that represents how the customer is interacting with the site. That way, there is a standard way that users always have for navigating through the site, and would avoid the problems with people “searching for that darn button that used to be there”.

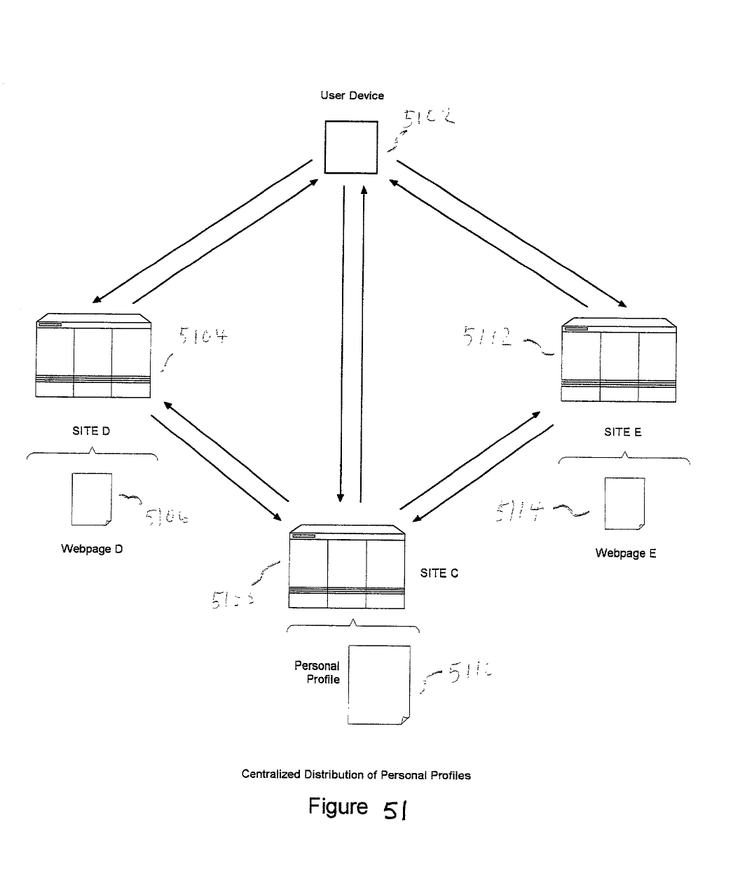

Referring to FIG. 49, shown is the semantic network of FIG. 46 after several site visitations.

Shown are a semantic network 4900, a coke node 4602, a cold drink node 4606, a Pandesal node 4908, a meaty node 4610, an evening node 4612, a hot food node 4616, a pizza node 4618, a chicken node 4620, a Sinigang Na Baboy node 4922, a cheesy node 4626, a peppery node 4628, a breadsticks node 4630, a Doro Wat node 4932, a special options node 4634, and 3 empty nodes 4604, 4614, 4624.

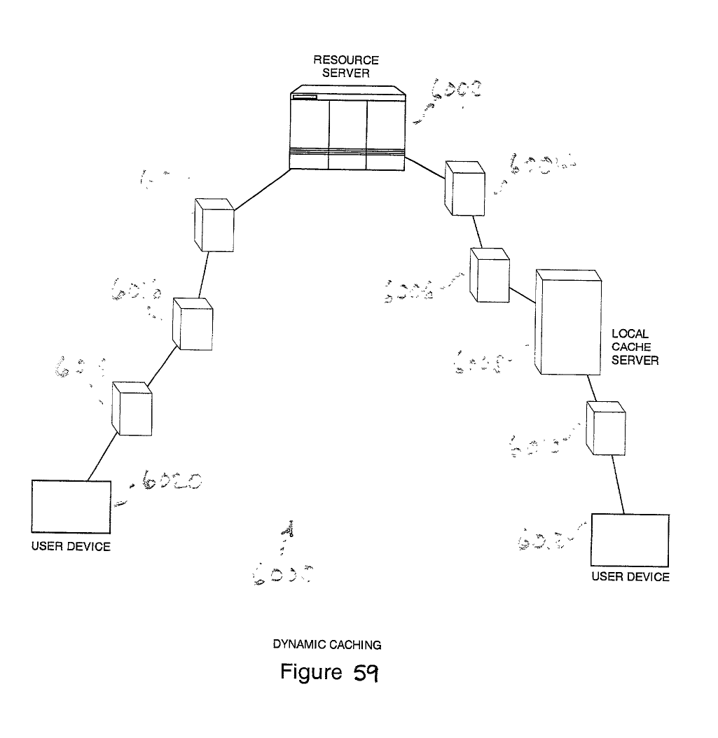

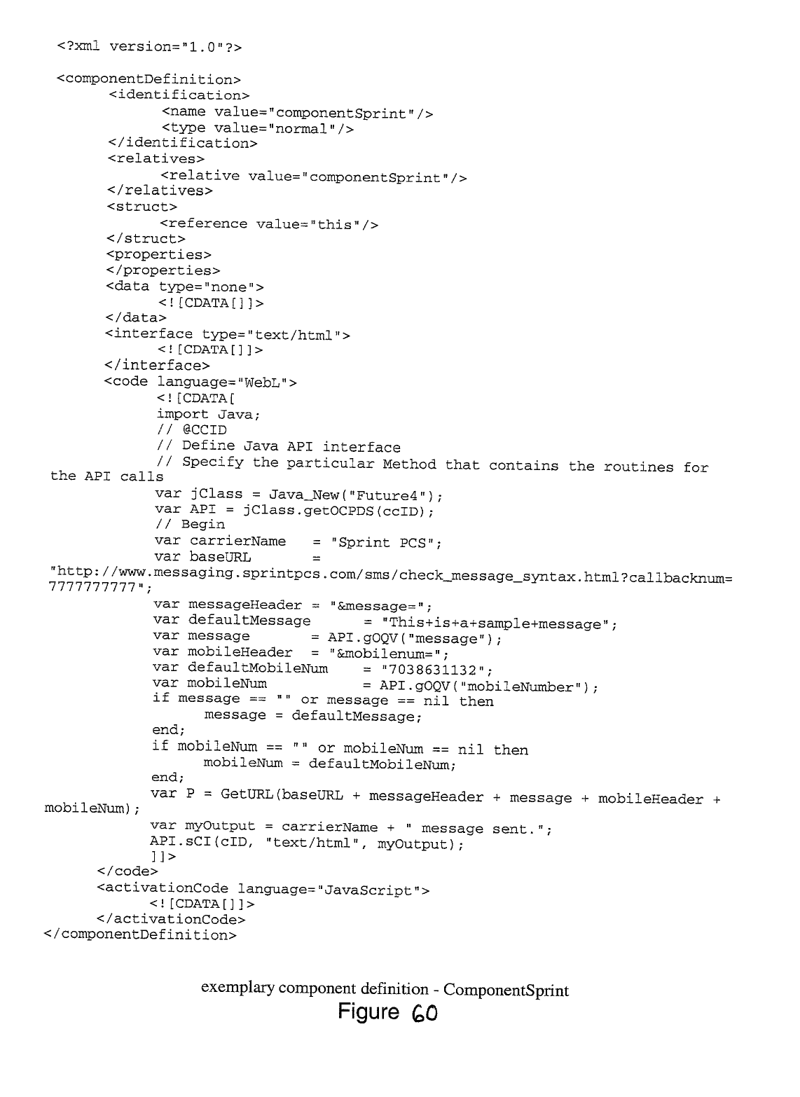

Operationally, this is a more mature version of the semantic network profile of FIG. 46. Shown is the semantic network profile after additional purchases at Editha's Filipino Diner and Meskerim (an Ethiopian restaurant). The Sinigang Na Baboy and Pandesal were ordered at Editha's and the Doro Wat was ordered at Meskerim. Also, several more purchases have been made at Yummy Yummy Pizza. Thus, since the customer did not order any more breadsticks, the weighting of the pizza and breadsticks “goes with” link has dropped to 0.2. Since the customer also ordered pizzas without chicken as a topping, the “topping” link to the chicken node has dropped to 0.6 (indicating however, that it is more likely than not that the customer will order chicken as a topping for pizza). The 1.0 “goes with” weighting between pizza and Coke indicate that the customer always has purchased coke with pizzas, and, interestingly enough, always purchased pizza when purchasing Coke. The 1.0 link of Doro Wat to Coke, shows that Doro Wat was always purchased with Coke, yet the link from Coke to Doro Wat is only 0.1 showing that the purchase of Coke does not indicate a high chance that Doro Wat will also purchased. A more detailed analysis may prove that Coke is always purchased with food having a high spiciness by this customer (since the customer often ordered pizza with extra pepper and since Doro Wat is very spicy hot). Which is something that the artificial intelligence engine does. The artificial intelligence engine is discussed herein in reference to FIG. 59. By this point in time, there is fertile data for analysis. With respect to the low connection of Coke to food items other than pizza and Doro Wat, if the other restaurants have coke but it wasn't purchased by the customer there, it may be inferred that the customer only likes coke with certain types of food—perhaps food having a certain spiciness—and personalization attempts could try to take advantage of this. On the other hand, if the other restaurants only have Pepsi, which the customer didn't purchase, it may be inferred that Pepsi is unappetizing to the customer and may prove an incentive for the restaurant to change beverage distributors (not likely on one customer's account, but if the group semantic network exhibits this trend it may be worthwhile).

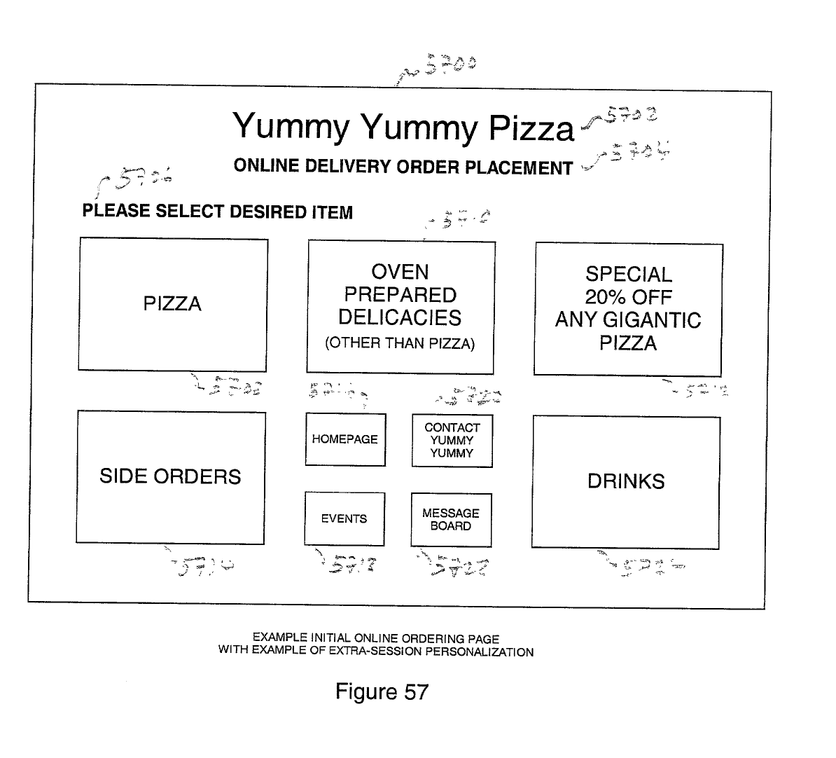

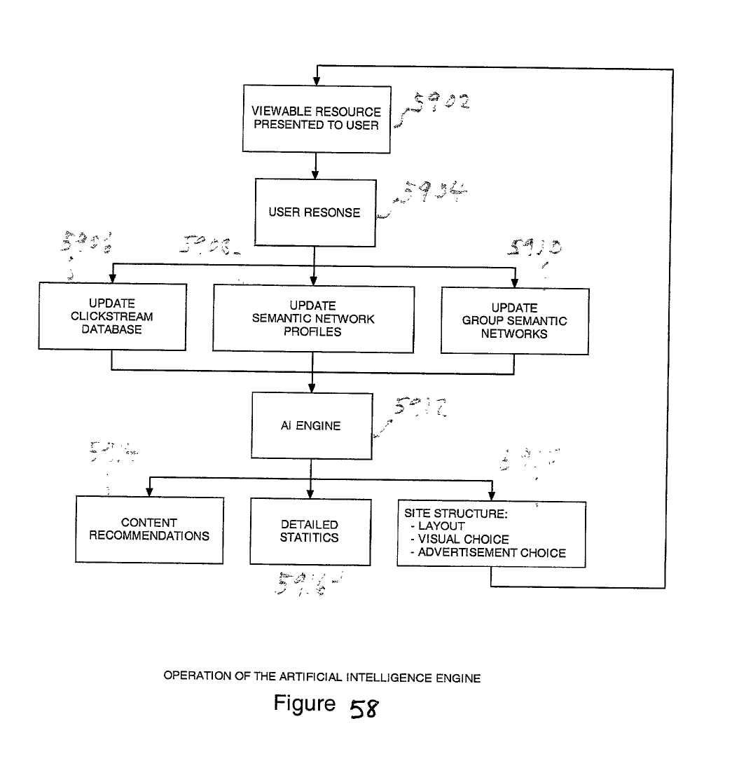

With respect to the special options node 4604, this is a node a website owner can use to indicate special options such as coupons, promotions, personalized messages, etc. The system of the present invention will, at the direction of the website owner, create links between the special options node 4604 and other nodes in the semantic network profile of specified customers, or in the group semantic network if required. What this does is, the next time the customer comes to the site, during the processing phase, rules or code executing may access links to the special options node 4604 and implement specific personalizations in response. An example is a link from pizza node to special options 4604 node which indicates that the customer is to be presented with a 20% off coupon for any gigantic pizza the next time the customer visits the website. An example of Yummy Yummy implementing such a coupon is shown in FIG. 57.

Referring to FIG. 50, shown is a way of sharing personalization information between servers by daemon server.

Shown are a user device 5002, a site A 5004, a server A 5006, a personal profile 5008, a website A 5010, a site B 5012, a server B 5012, and a website B 5016.

Structurally, arrows are shown communicatively connecting the user device to the server A 5006, the server A 5006 to the user device 5002, the server A 5006 to the server B 5016, the server B 5012 to the user device 5002, and the user device 5002 to the server B 5012. The website A 5010 and personal profile 5008 reside on the server A 5006 and the website B 5016 resides on the server B 5012.

Operationally, this figure shows a user and the communication effects generated when the user accesses the website A 5010 on the server A 5006 first, and then the website B 5016 on the server B 5012. There is no restriction that the server A 5006 and the server B 5012 be different servers, but is shown this way for clarity, the point here is that the user accesses two independent websites, the website A 5010 and the website B 5016, but that the businesses operating these two websites are exchanging business information including the semantic network profiles of their customers. It is noted that there is a distinction between server hardware and server software, which, if not discussed, may lead to some confusion here. There is no restriction that the to sites cannot be on the same server hardware, but they must be separate instances of the server software, otherwise they might be considered to be the same site. In operation, a user, utilizing the user device 5002, first requests a page from the website A 5010. In response, server A 5006 creates the personal profile 5008. Because the owner of the website A 5010 and the owner of the website B 5016 have an information exchange agreement, once the user had exited the website A 5010, the server A 5006 is caused to send a copy of the semantic network profile just generated of the user to the website B 5016 where the server B 5012 is caused to store it for later use should the user visit the website B 5016. This exchange does not have to be in real time (i.e. does not have to be intra-session), but it should not be delayed too long as the purpose is to inform the website B 5016 of the user's demographic and preferential characteristics before the user accesses the site B 5012. Normally, if a server is busy, this exchange may be delayed until such time as resources become available for carrying out the request. In the present example, the user does indeed later visit website B 5016 which, due to the availability of the user's semantic network profile delivered earlier by the server A 5006, is able to personalize it's webpages in attempts to better interest the user.

This process as described here would not work without either a graphic being sent to the user during this first contact which is from server B 5012, or by using the scheme B below. Sending a graphic from server B 5012 (in other words, having a graphic on the home page of server A that actually originates from server B 5012), would allow A to communicate the cookie based profile id, given to the user on their first visit, to server B 5012.

Referring to FIG. 51, shown is a centralized way of sharing personalized information between servers.

Shown are a user device 5102, a site D server 5104, a webpage D 5106, a site C server 5108, a personal profile 5110, a site E server 5112, and a webpage E 5114.

Structurally, arrows are shown which communicatively connect the user device 5102 to the site D server 5104, the site D server 5104 to the user device 5102, the site D server 5104 to the site C server 5108, the site C server 5108 to the site D server 5104, the site C server 5108 to the user device 5102, the user device 5102 to the site C server 5108, the user device 5102 to the site E server 5112, the site E server 5112 to the user device 5102, the site E server 5112 to the site C server 5108, and the site C server 5108 to the site E server 5112.

In operation, a user, utilizing the user device 5102, sends a request to the site D server 5104. The site D server 5104, not having a local copy of the user's semantic network profile, sends a redirect message to user device 5102 which redirects it to the site C server 5108. The site C server 5108 is referred to as a cookie server. The site C server 5108 does have semantic network profiles and checks the user device 5102 for any cookies which indicate the user has previously been to the site D server 5104 or any businesses affiliated with the site D server 5104, if it recognizes the user, the site C server 5108 retrieves a copy of the user's profile and sends it directly to the site D server 5104 while also updating the cookie on user device. The site C server 5108 also causes user device to redirect back to the site D server 5104, which can now handle the user's request by implementing personalization by use of the user's semantic network profile received from the site C server 5108. Upon the user exiting the site D server 5104, the site D server 5104 sends either the data that resulted from the interaction with the site server 5104 (the clickstream database) or the full semantic network profile for the user to site C server 5108 which takes the necessary action to update it's copy of the user's semantic network profile. Later, when the user accesses a webpage at the site E server 5112, a similar set of actions is put in motion, which result in the site E server 5112 serving a personalized webpage to the user, which incorporates personalization using all of the user's past activity including what was done at the site D server 5104.

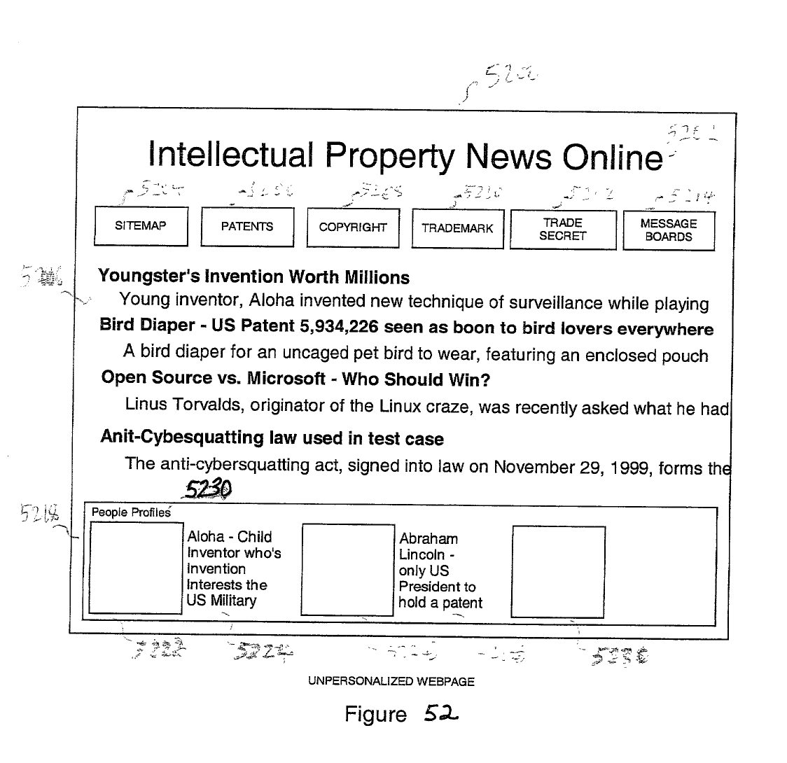

Referring to FIG. 52, shown is an exemplary webpage.

Shown are a webpage 5200, a header 5202 reading “Intellectual Property News Online”, a sitemap button 5204, a patents button 5206, a copyright button 5208, a trademark button 5210, a trade secret button 5212, a message boards button 5214, a text area 5216 reading “Youngster's Invention . . . ”, “Bird Diaper . . . ”, “Open Source . . . ”, and “Anti-Cybersquatting . . . ”, a box 5218, a minor heading 5220 reading “People Profiles”, an image 5222, a text area 5224 reading “Aloha—Child Inventor . . . ”, an image 5226, a text area 5228 reading “Abraham Lincoln . . . ” and an image 5230.

The header 5202 reading “Intellectual Property News Online” is at the top. Below that in a horizontal row are the buttons (in order from left to right): the sitemap button 5204, patents button 5206, the copyright button 5208, the trademark button 5210, the trade secret button 5212, and the message boards button 5214. Below that is text area having 4 news piece headings reading “Youngster's Invention . . . ”. Below that is box 5218 containing minor heading reading “People Profiles” and the following in a horizontal row: the image 5222, the text area 5224 reading “Aloha—Child Inventor . . . ”, the image 5226, the text area 5228 reading “Abraham Lincoln . . . ”, and the image 5230.

This is an example of a typical webpage targeted at a general Intellectual Property-biased person. The buttons in the top row are ordered for a general interest person, the news piece headings in text area 5216 are unordered and drawn from all areas of Intellectual Property (IP), and the biography snippets in the bottom box 5218 are likewise unfiltered with respect to any areas of IP.

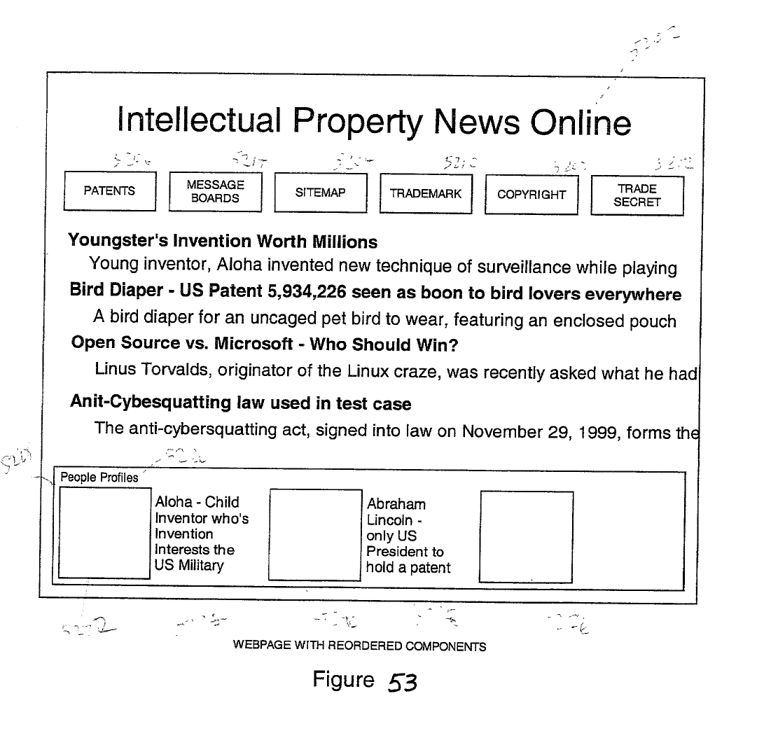

Referring to FIG. 53, shown is the webpage of FIG. 52 after reordering of elements.

Shown are a webpage 5300, a header 5202 reading “Intellectual Property News Online”, a sitemap button 5204, a patents button 5206, a copyright button 5208, a trademark button 5210, a trade secret button 5212, a message boards button 5214, a text area reading “Youngster's Invention . . . ”, a box, a minor heading 5220 reading “People Profiles”, an image 5222, a text area 5224 reading “Aloha—Child Inventor . . . ”, an image 5226, a text area 5228 reading “Abraham Lincoln . . . ”, and an image 5230.

The header 5202 reading “Intellectual Property News Online” is at the top. Below that in a horizontal row are the buttons (in order from left to right): the patents button 5206, the message boards button 5214, the sitemap button 5204, the trademark button 5210, the copyright button 5208, and the trade secret button 5212. Below that is the text area 5216 having 4 news piece introductions the headings of which begin “Youngster's Invention . . . ”, “Bird Diaper . . . ”, “Open Source . . . ”, and “Anti-Cybersquatting . . . ”. Below that is the box 5218 containing the minor heading 5220 reading “People Profiles” and the following in a horizontal row: the image 5222, the text area 5224 reading “Aloha—Child Inventor . . . ”, the Image 5226, the text area 5228 reading “Abraham Lincoln . . . ”, and the image 5230.

This is an example of the webpage of FIG. 52 but which has been altered by reordering of components, perhaps in customization of the site for targeting a patent-interested person. The change which has been effected with respect to FIG. 52 is the reordering of the buttons in the top row to place the patents button 5206 first, followed by the message boards button 5214 (perhaps due to the person's active use of the message boards), and so on.

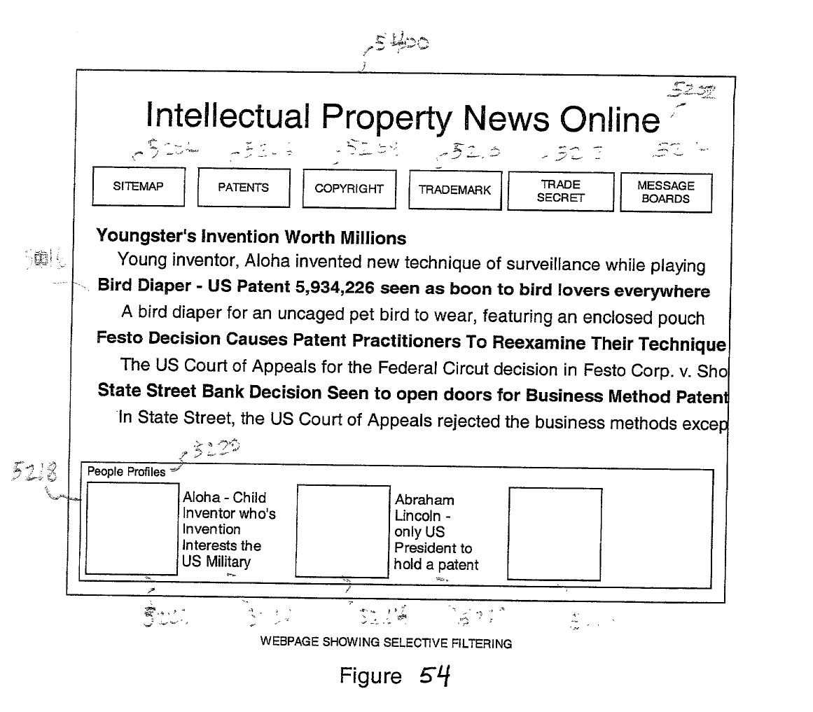

Referring to FIG. 54, shown is the webpage of FIG. 52 after selective filtering of elements.

Shown is an exemplary webpage 5400, a header 5202 reading “Intellectual Property News Online”, a sitemap button 5204, a patents button 5206, a copyright button 5208, a trademark button 5210, a trade secret button 5212, a message boards button 5214, a text area 5416 having 4 news piece introductions the headings of which begin “Youngster's Invention . . . ” “Bird Diaper . . . ”, “Festo Decision . . . ”, and “State Street Bank . . . ”, a box 5218, a minor heading 5220 reading “People Profiles”, an image 5222, a text area 5224 reading “Aloha—Child Inventor . . . ”, an image 5226, a text area 5228 reading “Abraham Lincoln . . . ”, and an image 5230.

The header 5202 reading “Intellectual Property News Online” is at the top. Below that in a horizontal row are the buttons (in order from left to right): the sitemap button 5204, the patents button 5206, the copyright button 5208, the trademark button 5210, the trade secret button 5212, and the message boards button 5214. Below that is text area 5416 having 4 news piece introductions the headings of which begin “Youngster's Invention . . . ”, “Bird Diaper . . . ”, “Festo Decision . . . . . ”, and “State Street Bank . . . ”. Below that is box 5218 containing minor 5220 heading reading “People Profiles” and the following in a horizontal row: the image 5222, the text area 5224 reading “Aloha—Child Inventor . . . ”, the image 5226, the text area 5228 reading “Abraham Lincoln . . . ”, and the image 5230.

Operationally, this webpage has been altered by use of “selective filtering”—a technique where a set number of components are filtered out from a pool of candidates. In FIG. 52, for example, the selective filtering filtered out 4 news piece introductions from the pool of candidates, which included news pieces from all sectors of IP. Thus, in FIG. 52, text area 5216 has the news pieces entitled: “Youngster's Invention . . .”, “Bird Diaper . . . ”, “Open Source . . . ”, and “Anti-Cybersquatting . . . ”. In FIG. 54, however, the page has been personalized for a patent-specific person and only patent related news pieces were filtered out and selected. Thus, the news pieces which were in FIG. 52 entitled “Open Source . . . ” and “Anti-Cybersquatting . . . ” were filtered out and replaced by the news pieces whose headings began “Festo Decision . . . ” and “State Street Bank . . . ”. The text area 5416 of the webpage of FIG. 54 thus has the news pieces: “Youngster's Invention . . . ”, “Bird Diaper . . . ”, “Festo Decision . . . ”, and “State Street Bank . . . ”.

There are three type of component based personalization events: placement, replacement, and shuffling. In placement, a fixed item or set of items either is put on the page or is not. In replacement, an item or set of items is selected as a subset of a group (possibly a component family) to be placed on the page. Typically some sore of ranking or scoring scheme determines what components out of the superset are chosen to be displayed. In shuffling, the same components are visible on the page (clearly more than one is required to shuffle), but the order is changed in response to a personalization event.

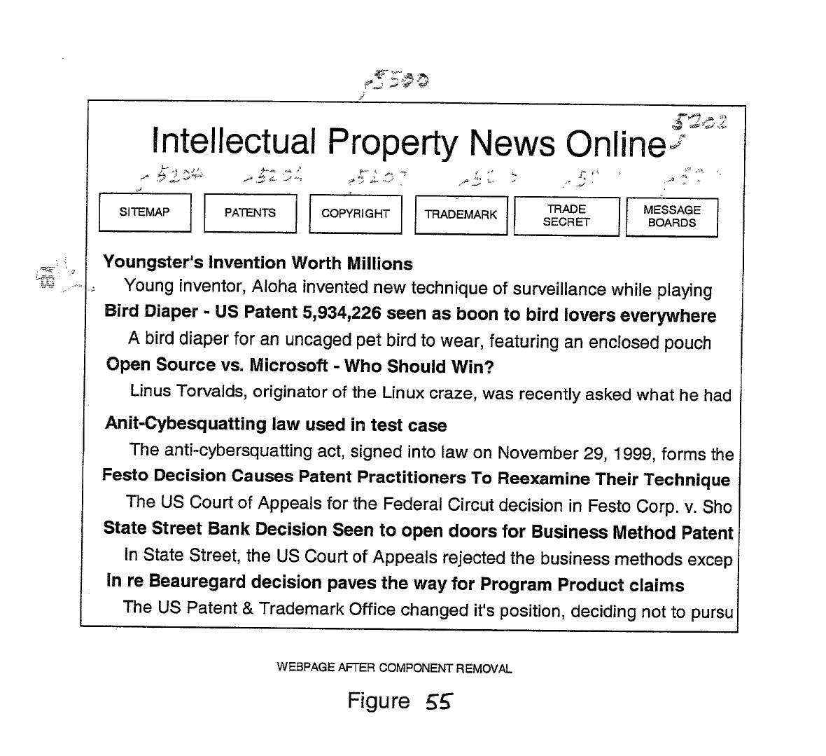

Referring to FIG. 55, shown is the webpage of FIG. 52 after component removal.

Shown is an exemplary webpage having a header 5202 reading “Intellectual Property News Online”, a sitemap button 5204, a patents button 5206, a copyright button 5208, a trademark button 5210, a trade secret button 5212, a message boards button 5214, and a text area having 7 news piece introductions having headings reading “Youngster's Invention . . . ”, “Bird Diaper . . . ”, “Open Source . . . ”, “Anti-Cybersquatting . . .”, “Festo Decision . . . ”, “State Street Bank . . . ”, and “In re Beauregard . . . ”.

The header 5202 reading “Intellectual Property News Online” is at the top. Below that in a horizontal row are the buttons (in order from left to right): the sitemap button 5204, the patents button 5206, the copyright button 5208, the trademark button 5210, the trade secret button 5212, and the message boards button 5214. Below that is the text area having 7 news piece introductions having headings reading “Youngster's Invention . . . ”, “Bird Diaper . . .”, “Open Source . . . ”, “Anti-Cybersquatting . . . ”, “Festo Decision . . . ”, “State Street Bank . . . ”, and “In re Beauregard . . . ”.

This is an example of the webpage of FIG. 52 customized for a person who dislikes biographical sketches. The site has adjusted to this change by removing the personal profiles box and adding 3 more news piece introductions.

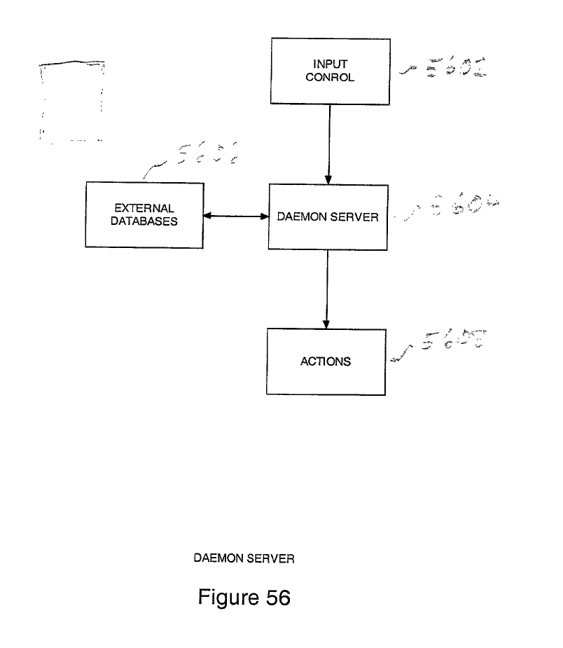

Referring to FIG. 56, shown is a block diagram of the present invention showing the interaction of the daemon server.

Shown are an input control 5602, a daemon server 5604, external databases 5606, and actions block 5608.

The input control 5602 is coupled to daemon server 5604, which is bidirectionally coupled to external databases 5606. Daemon server 5604 is coupled to actions block 5608.

In operation, daemon server 5604 is able to carryout tasks that take longer than what the I/O processor or component assembly engine can do in realtime or that require more resources than are available during peak hours. Input control 5602 is similar to a control program. Input control 5602 is coded using components with a technique similar to design of component-hierarchy-based resource coding. One powerful ability available with the daemon server 5604 is that, by use of the input control 5602, the actions of the daemon server can be controlled timewise in any number of ways such as every 5 minutes, once per hour, each month on the 5^{th}, contingent on an internal event, or even contingent on an external event, such as network traffic levels.

Instant personalization—is when a user's behavior or activity interacting with a viewable resource (such as viewing product information, making selections, etc.) is immediately incorporated into the user's semantic network profile and thus, the next viewable resource the user selects is personalized with the help of the information just incorporated into the semantic network profile.

This occurs from one click to the next page loaded.

Intra-session personalization—(personalization within a “session” or sitting) usually performed within 3-5 min but can stretch out to 30 min.

Extra-session personalization—is when a user's behavior or activity interacting with a viewable resource (such as viewing product information, making selections, etc.) is stored in the clickstream/context chain database and is incorporated into the user's semantic network profile in a “batch mode” kind of manner through the use of the daemon server. Thus, the user's behavior in one surfing session will not influence semantic network profile-based personalization until perhaps the next time the user goes online. Personalization which takes >30 minutes to perform. Typically the user will not see the results of this kind of personalization till the next time they return to the site, the next day, for example.

personalization by the daemon server is no different personalization performed by the CAE. The daemon server is usually selected not for instant personalization, but for intra-session and extra-session personalization tasks.

Components are not only used by the Component Assembly Engine (CAE), but are used in other parts of the architecture as well. There are many personalization and system maintenance operations that are too computationally expensive or are otherwise undesirable to have executed in the page construction process. These processes are handled by the Daemon Server.

The Daemon Server (DS) is designed to optionally run on a separate machine to reduce load. The DS actually executes components from the same repository as the CAE. Rather than executing on a per request basis, however, with the DS each component can be scheduled to run on at a certain time, or on a set basis such as every five minutes or once every six months.

During personalization events, code executed in the Component Assembly Engine (CAE) can trigger a component to be loaded (or removed) into the Daemon Server.

The Daemon Server need not have any true front-end interface (although one will be created for monitoring purposes). The components executed by the Daemon Server mostly will institute some change on the database side: updating information, performing archival storage functions, aggregating data, or monitoring operating conditions. These represent changes in the Semantic Network Database.

As with the CAE, the Daemon Server obtains its components from the Component Cache Repository (CCR). As mentioned before, the CCR provides quick access to the most recently and most frequently used components.

Note: the information in the corresponding figure may not really be useful.

Referring to FIG. 57, shown is the webpage of FIG. 41 after extra-session customization resulting from the use of the daemon server.

Shown is a header reading “Yummy Yummy Pizza”, a subheading reading “Online Delivery Order Placement”, an instructional text reading “Please select . . . ”, a pizza button, an oven prepared delicacies button, a coupon button, a side orders button, a homepage button, an events button, a contact Yummy Yummy button, a message board button, and a drinks button.

Operationally, FIG. 57 shows the webpage of FIG. 41 after implementation of a special options personalization for preferred customers. Specifically, a 20% coupon is offered towards the purchase of “gigantic pizzas” (in response to the customer's having purchased the same in the past).

Generally, such special options personalizations are set up by actions of the daemon server. Specifically, at the direction of a website owner, the daemon server is instructed to implement a given special option for specified web site patrons. The specification of which patrons are to be so treated can be done in any number of ways, but a typical way is for criteria to be set by the website owner and any patrons meeting that criteria are selected for the special option personalization. This example could have been implemented by the criteria that any customer who has purchased a gigantic pizza in the past gets a coupon. Alternatively, the coupon could be given only to those customers who haven't purchased a gigantic pizza, or only to customers who have an average purchase of over 50 dollars. The criteria used in selecting which website visitors get the special options personalization are whatever the website owner specifies the criteria to be.

Special option personalization is not restricted to alteration of a viewed website. The daemon server could just as easily be instructed to send special emails to the patrons who meet the preset criteria. Alternatively, special options can be used in ways, which do not visibly affect the patrons. One example is the storage of information somewhere when the patron revisits the site—this could be in the form of special logs to help the website owner to collect special statistics or keep track of certain behaviors in a special log. Another example is for a realtime message be generated somewhere—such as at the website owner's computer, perhaps to alert the website owner of a person who had physically left a personal belonging in the owner's establishment previously.

Referring to FIG. 58, shown is a block diagram of the operation of the artificial intelligence engine.

Shown are a viewable resource presentation block 5902, a user response block 5904, a clickstream database 5906, an individual user semantic network profiles block 5908, a group semantic networks block 5910, an AI engine 5912, a contents recommendations block 5914, a detailed statistics block 5916, and a site structure block 5918.

The viewable resource presentation block 5902 is coupled to the user response block 5904, which is coupled to the update clickstream database 5906, the update semantic network profiles block 5908, and the update group semantic networks block 5910. The update clickstream database 5906, the update semantic network profiles block 5908, and the update group semantic networks block 5910 all are coupled to the AI engine 5912, which is coupled to the contents recommendations block 5914, the detailed statistics block 5916, and the site structure block 5918. The site structure block 5918 is coupled back to the viewable resource presentation block 5902.

In practice, a user is presented with a viewable resource in the viewable resource presentation block. Response by the user is represented by user response block 5904. The system of the present invention, in response to the user response, stores some data in the clickstream database shown by the update clickstream database block 5906, updates the user's semantic network profile shown by the update semantic network profile block 5908, and updates the applicable group semantic networks shown as shown in the update group semantic networks block 5910. The AI engine takes the output created in the update clickstream database block 5906, the update semantic network profiles block 5908, and the update group semantic networks block 5910. The AI engine creates content recommendations in the content recommendations block 5914, detailed statistics in the detailed statistics block 5916, and site structure in the site structure block 5918.

Referring to FIG. 59, shown is an example of dynamic caching on a network.

Shown is a network 6000 including a webpage server 6002, six network nodes 6004, 6006, 6010, 6014, 6016, 6018, a local cache server 6008, a user device 6012, and a user device 6020.

The webpage server 6002 is coupled to the network node 6004, which is coupled to the network node 6006, which is coupled to the local cache server 6008, which is coupled to the network node 6010, which is coupled to the user device 6012. The webpage server 6002 is connected to the network node 6014, which is coupled to the network node 6016, which is coupled to the network node 6018, which is coupled to the user device 6020.

In operation, the user device 6012 initiates a request for a viewable resource, which is located on webpage server 6002. The webpage server 6002 responds by building the viewable resource and sending the viewable resource to the user device 6012. What was just described is typical network behavior. As example, however, user device 6012 has made repeated requests for webpages or other viewable resources from webpage server 6002, and webserver 6002 recognizes that some components were utilized in two or more of the requests from user device 6012. In this case, webpage server 6002 may pass copies of certain components to local cache server 6008. The certain components are those components determined to have the most likelihood of being required in future requests by user device 6012. Local cache server 6008 would then intercept future requests from user device 6012 and, if able, build any viewable resource requested and send the built viewable resource to user device 6012. Any components which are required to build requested resources for user device 6012 but which were not provided to local cache server 6008 are sent from webpage server 6002 to local cache server 6008 in response to a request from local cache server 6008.

As presented, this example treats only the situation of one user device 6012 interacting with one resource server 6002. The technique of dynamic caching can be applied to multiple user devices 6012, 6020 interacting with a network. Provided that there is one or more local cache servers 6008 which are closer to the user devices 6012, 6020 than the webpage server 6002 that originally holds website components that are under demand, application of dynamic caching may provide significant savings.

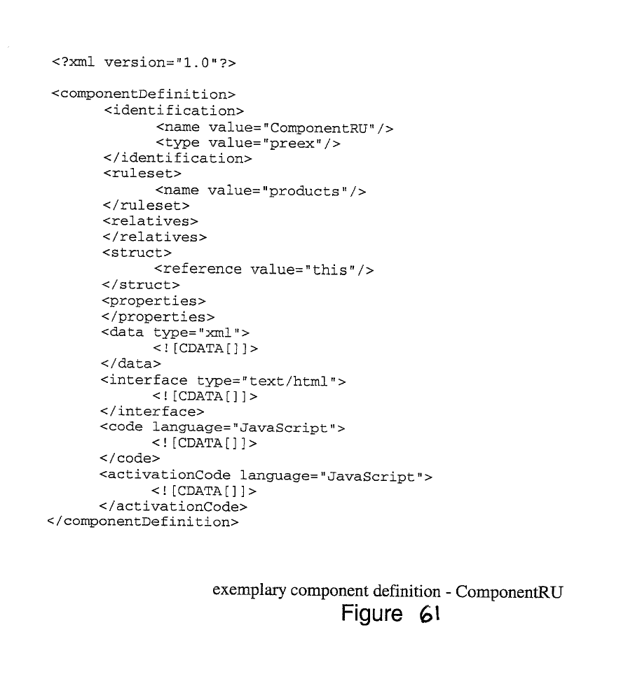

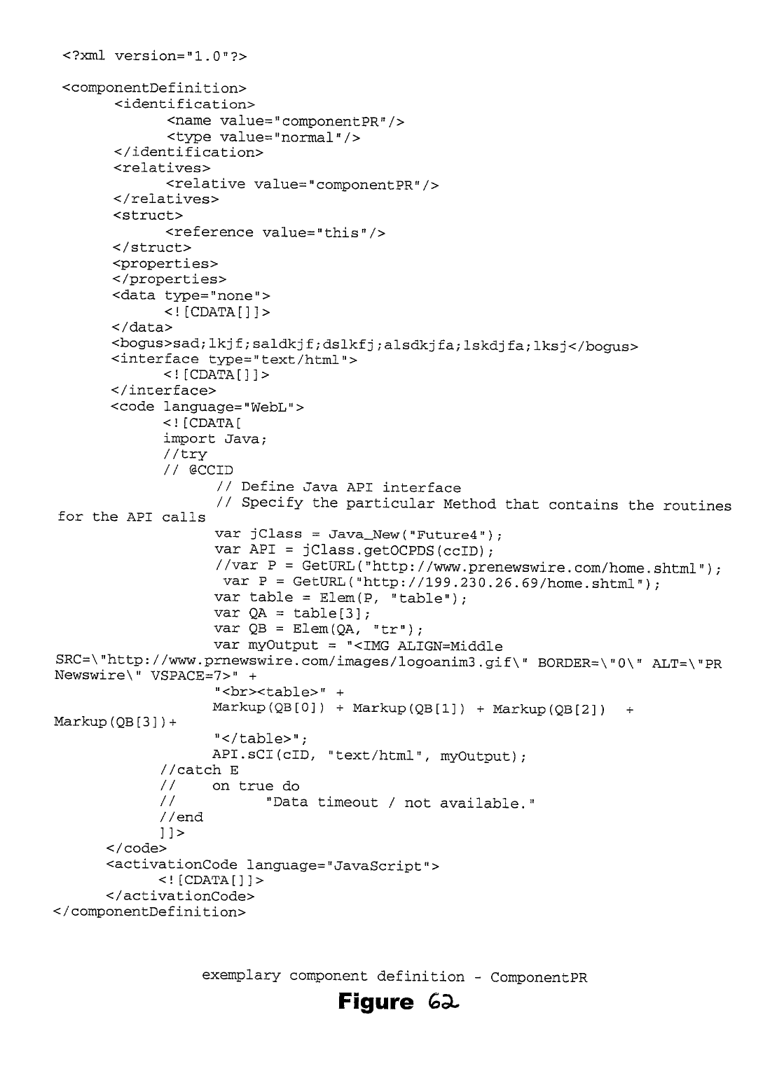

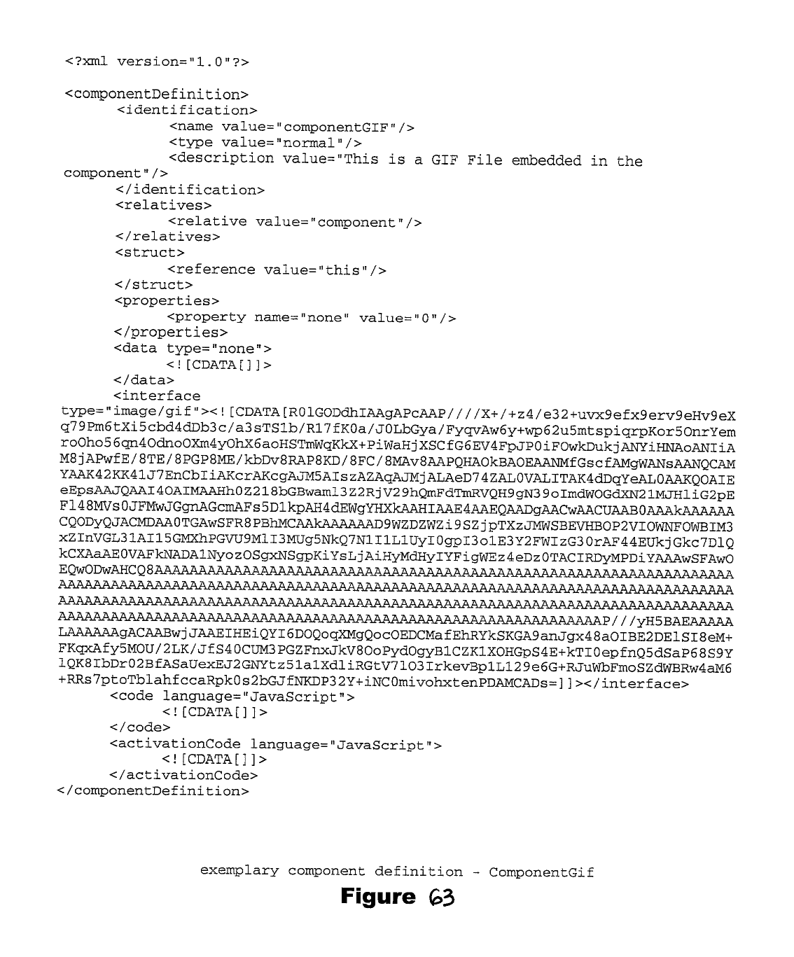

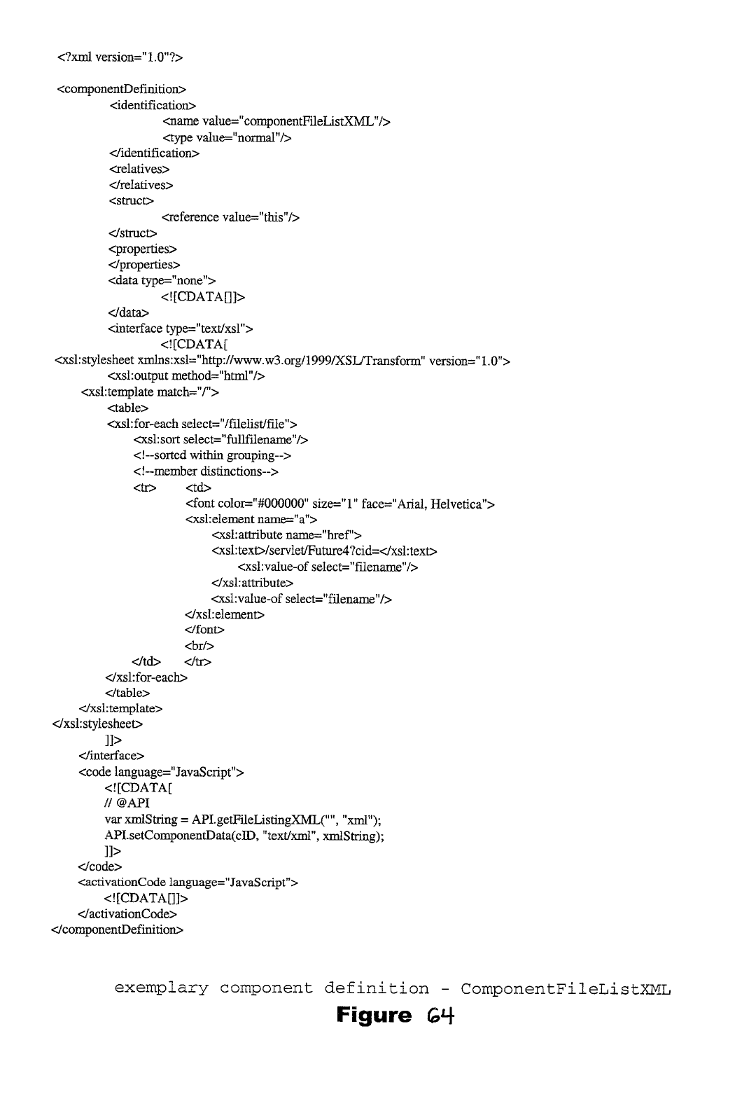

FIGS. 60-64 show listings of exemplary components ComponentSprint, ComponentRU, ComponentPR, ComponentGIF, and ComponentFileListXML, respectively.

The Daemon Server

The daemon server is generally used to implement operations which are not required to be intra-session, that is, do not need to be done in real time or need to be done so that a user sees the effects before the user exits a browsing session at the website.

Operations already discussed which can be implemented by daemon server include distribution of semantic network profiles from businesses or companies to their business affiliates, distribution of email or other electronically based activity, updating of group semantic networks, semantic network profiles in response to accumulated behavior (includes online behavior and in-store behavior such as activity at POS terminals or kiosks, etc.).

In operation, the daemon server is instructed to implement special options and other tasks by being given a special component hierarchy. This component hierarchy does not have the purpose of representing a webpage, but instead gives the daemon server the programming code necessary to implement the special options. The code contained in the hierarchy given to the daemon server would necessarily have some form of timing mechanism specified. Timing specifications can be absolute, such as 5:00 pm, Tuesday, 1^{st} of the month, etc. Timing specifications can also be relative, such as within the next hour, etc. Timing specifications can also be continuous, such as every hour, once a week, etc.

The daemon server carries out most updates to semantic networks including group semantic networks and semantic network profiles. The daemon server can thus carry out any computationally expensive tasks, which could not be performed in real time or during periods of elevated activity. Thus the daemon server is generally the best choice to implement whatever artificial intelligence (AI) routines are desired on a semantic network.

Personalization

The present embodiment is able to personalize webpages and websites in three basic time formats: intra-session or within the same browsing session (i.e. in realtime),

Request Director

It is the request director 206 which can implement some security precautions by determining the identity of requesters and denying access for those requesters without proper access rights.

While the invention herein disclosed has been described by means of specific embodiments and applications thereof, numerous modifications and variations could be made thereto by those skilled in the art without departing from the scope of the invention set forth in the claims.

What is claimed is:

1. A system comprising:
a plurality of components, each of the plurality of components comprising data; and
a component assembly engine, wherein the component assembly engine performs the following steps:
receiving one of the plurality of components, the one of the plurality of components comprising a root component;
determining, as a function of the root component, at least one child component of the root component;
receiving another of the plurality of components, the other of the plurality of components comprising the at least one child component;
rendering content as a function of at least one of said at least one child component and said root component.

2. The system of claim 1 wherein said content includes a hypertext document.

3. The system of claim 2 wherein said hypertext document is a webpage.

4. The system of claim 1 further comprising:
a server;
a network, said component assembly engine being communicatively coupled to the network via the server.

5. The system of claim 1 wherein the server performs the following steps:
receiving a request for a viewable resource, the receiving being via the network;
identifying said root component as a function of the request for the viewable resource;
communicating said root component having been identified to the component assembly engine.

6. The system of claim 5 further comprising:
a client, the client sending the request for a viewable resource.

7. The system of claim 6 wherein said client receives said content.

8. A method comprising:
receiving one of a plurality of components, the one of the plurality of components comprising a root component, each of the plurality of components comprising data;
determining, as a function of the root component, at least one child component of the root component;
receiving another of the plurality of components, the other of the plurality of components comprising the at least one child component;
rendering content as a function of at least one of said at least one child component and said root component.

9. The method of claim 8 further comprising:
receiving a request for a viewable resource;
identifying said root component as a function of the request for the viewable resource.

10. The method of claim 9 further comprising:
sending said content and said portion of said content.

11. A system for assembling a document capable of being electronically rendered, said document being assembled from a plurality of components, said system comprising:
a clickstream database for storing a user's interaction history;
a metadata database 504 for storing product affinity information;
a component database 508 for persistent storage of components;
a storage unit capable of storing a pointer to a component, a component hierarchy data structure, a processed queue data structure, and a feedback buffer data structure;
a request director 206 capable of determining the nature of an incoming request and directing the request responsive to said determination;
an i/o processor 208 connected to said clickstream database, said metadata database 504, and said request director 206, said i/o processor 208 processing requests to modify a metadata database 504 or to download information from said metadata database 504; and
a component assembly engine connected to said clickstream database, said metadata database 504, said component database 508, said storage unit, and said request director 206, and said i/o processor 208, said component assembly engine 210 receiving a request from said request director 206 and assembling said electronically rendered document responsive to said request director 206.

12. A component assembly engine 210 for assembling information, said component assembly engine 210 comprising:
a memory unit capable of storing a pointer to a component, a component hierarchy data structure, a processed queue data structure, and a feedback buffer data structure;
request receiving means for receiving a request for information, said request containing a reference to a root component;
extracting means for extracting said reference from said request, said extracting means connected to said request receiving means and receiving said request therefrom;
loading means for loading a set of components necessary for building a document, said loading means connected to said extracting means and receiving said reference therefrom, said loading means comprising:
index means for indexing components as they are loaded,
indicating means for indicating which component is active,
child component reference extracting means for extracting a child component reference from said active component,
shadow component processing means for processing a shadow component, and
component loading means for loading a component, said component loading means updating said component hierarchy data structure in response to each component loaded; and
processing means for processing a loaded component hierarchy, said processing means comprising:
process indexing means for indicating which component is active, said active component being next to be processed, said process indicating means indicating components to be processed in revere order from the order of loading, and
component processing means for processing said active component, adding an entry for said processed component in said processed queue, generating properties for said processed component, generating updated variables for said processed component, and generating feedback output for said processed component, said feedback output incorporating any feedback output resultant from the processing of any child components of said active component, said feedback output being placed in a feedback buffer, said feedback buffer, said updated variables, and said generated properties being available during processing of subsequent components; and
delivery means connected to said processing means for delivering the contents of said feedback buffer in fulfillment of said request.

13. A computer program product for causing a computer to customizably build a webpage, said computer program product comprising a computer usable medium having computer readable code thereon, said computer program product comprising:
computer readable code means for receiving a request for a webpage;
computer readable code means for extracting a reference to a root component from said request;
computer readable code means for loading a set of components necessary for building a document, said loading means comprising:
computer readable code means for extracting a reference to a child component from a component,
computer readable code means for processing a shadow component, and
computer readable code means for indexing components as they are loaded,
computer readable code means for indicating which component is active,
computer readable code means for extracting a child component reference from said active component,
computer readable code means for processing a shadow component, and computer readable code means for loading a component and updating said component hierarchy data structure in response to each component loaded; and
computer readable code means for processing a loaded component hierarchy, said processing means comprising:
computer readable code means for indicating which component is active, said active component being next to be processed, said process indicating means indicating components to be processed in revere order from the order of loading, and
component processing means for processing said active component, adding an entry for said processed component in said processed queue, generating properties for said processed component, generating updated variables for said processed component, and generating feedback output for said processed component, said feedback output incorporating any feedback output resultant from the processing of any child components of said active component, said feedback output being placed in a feedback buffer, said feedback buffer, said updated variables, and said generated properties being available during processing of subsequent components; and
computer readable code means for delivering the contents of said feedback buffer in fulfillment of said request.

14. A method for assembling a customized displayable document, said method comprising:
1) receiving a request from an entity for a displayable document to be displayed;
2) determining the identity of the entity who generated the request;
3) deciding whether to proceed in response to said determination;
4) continuing to step (1) if said determination indicates said request is not fillable;
5) determining the nature of said request (information upload, information download, or clickthrough);
6) uploading information and returning to step (1) if said determination indicates the nature of said request is information upload, else downloading information and returning to step (1) if said determination indicates the nature of said request is information download;
7) logging said request in a clickthrough database;
8) setting an Active Component Number i equal to 1;
9) setting a Component Total j equal to 1;
10) setting the jth entry of a Parent Array equal to 0;
11) loading a root component indicated in said request from said entity;
12) associating the component pointer at the jth position in a component pointer array with said root component;
13) determining if said root component is a shadow component;
14) executing at least a portion of at least one of the rules element and the code element of said root component if said step
13) of determining determines said root component to be a shadow component;
15) determining if the struct section of the component indicated by the ith component pointer contains any unloaded entries having a child component reference;
16) if said determination is negative and if said Active Component Number i equals 1, continuing to step (28), otherwise:
reading the ith entry of said Parent Array,
setting said Active Component Number i equal to said read ith entry of said Parent Array, and
continuing to step (15);
17) extracting a first unloaded component identifier from the struct section of the component indicated by the ith component pointer;
18) incrementing said Component Total j;
19) setting jth entry in the Parent Array equal to i;
20) loading said component indicated by said first unfilled component identifier;
21) associating the component pointer at the jth position in said component pointer array with said loaded component;
22) setting said Active Component Number i equal to j;
23) determining if said loaded component is a shadow component;
24) continuing to step (26) if said determination of said step (23) indicates said loaded component is a shadow component;
25) repeating steps (15) to (24) until no further references to secondary components are found;
26) executing at least a portion of at least one of the rules element and the code element of the component indicated by the jth position in said pointer array;
27) continuing to step (15);
28) setting said Active Component Number i equal to said component total j;
29) processing the component indicated by the ith component pointer, said processing producing at least one of the group comprising: combined feedback, combined properties, and combined variables, said combined feedback including the feedback of descendant components of said component indicated by said ith component pointer, said combined properties including the properties of descendant components of said component pointed to by said ith component pointer, said combined variables including variables named in the variables element of descendant components, said combined feedback, said combined properties, and said combined variables being made available for use in processing all parent components of said component pointed to by said ith component pointer;
30) decrementing said Active Component Number i;
31) if said Active Component Number i equals 0, continuing to step (32), otherwise continuing to step (29);
32) supplying the combined feedback produced by the processing of the component at the 1^{st} component pointer in response to said request.

15. A method for assembling a web page comprising:
a) loading a root component;
b) loading all descendant components of said root component;
c) processing all loaded components in reverse order from the order in which said root component and said descendant components were loaded.

16. A method as in claim 15 wherein at least one descendent component is a shadow component.

17. A method as in claim 15, said step (c) of processing including the step of adding said components to a processed queue, said processed queue providing an index of processed components for use during subsequent processing.

18. A data structure for use in electronically rendering a composite document comprising two or more component structures, each said component structure comprising:
a name element,
a data element,
an interface element,
a family element,
a structure element,
a properties element,
a code element,
an activation code element,
a rules element, and
a variables element.

19. A data structure as in claim 18 wherein at least one element of at least one component structure contains a pointer to a corresponding element of another component structure, whereby when said at least one element is processed, the information contained in said corresponding element is used in processing said at least one element.

20. A data structure as in claim 18 wherein at least one element of at least one component structure contains a pointer to the code element of said at least one component structure, whereby when said at least one component structure is processed, the contents of said at least one element is obtained by execution of code pointed to in said code element of said at least one component structure.

21. A data structure as in claim 18, wherein said components may reside on different internet accessible computer systems.

22. A data structure as in claim 18, wherein at least one of said two or more component structures comprises a shadow component structure, said shadow component structure containing code or rules respectively contained in the code element of said shadow component structure or the rules element of said shadow component structure, at least one of said shadow component code and said shadow component rules when executed causing said shadow component to be resolved into at least one component.
